(19) United States
(12) Patent Application Publication
(10) Pub. No.: US 2025/0229762 A1
(43) Pub. Date: Jul. 17, 2025

(54) Fuel-Saving Robot System For Ace Heavy Duty Trucks

(71) Applicants: Wangjie Gesang, Shanghai (CN); Wei Cha, Shanghai (CN); LCB International Inc., Tortola (VG)

(72) Inventors: Wangjie Gesang, Shanhai (CN); Wei Cha, Shanhai (CN)

(21) Appl. No.: 19/098,819

(22) Filed: Apr. 2, 2025

Related U.S. Application Data
(63) Continuation of application No. 17/919,985, filed on Oct. 19, 2022, now Pat. No. 12,291,188.

(30) Foreign Application Priority Data
Apr. 21, 2020 (CN) 202010315606.X

(51) Int. Cl. B60W 10/08; B60K 6/26; B60L 7/18; B60W 10/06; B60W 20/14; B60W 20/15; B60W 30/18; B60W 50/00

(52) U.S. Cl. CPC B60W 10/08; B60K 6/26; B60L 7/18; B60W 10/06; B60W 20/14; B60W 20/15; B60W 30/18; B60W 30/18127; B60W 2050/0031; B60W 2300/125

(57) ABSTRACT

A Level IV fuel-saving robot system for heavy-duty trucks (HDT) focuses on the minimization of actual fuel consumption (L/100 km) for long-haul freight based on an electrical power split device and a mixed hybrid powertrain architecture. The Level IV fuel-saving robot has an L4 autonomous driving function within the Operational Design Domain (ODD) of expressways, operates in a “shadow mode” or “Disengagement Mode,” automatically generates a discrepancy report or detachment report, completes the “3R” (Real Vehicle, Real Road, Real Payload) batch validation for an L4 system on a billion mile scale quickly with high performance to cost ratio under the condition of ensuring the traffic safety of existing road users and reduces the total validation expense by more than 65% compared with the modern HDT with internal combustion engine equipped with the L4 system, promoting the early commercialization of the fuel-saving robot.

### RELATED APPLICATIONS

This application is a continuation of U.S. application Ser. No. 17/919,985, filed Oct. 19, 2022, which is the U.S. National Stage of International Application No. PCT/CN2021/087661, filed Apr. 16, 2021, which designates the U.S., published in Chinese, and claims priority under 35 U.S.C. § 119 or 365(c) to Chinese Application No. 202010315606.X, filed Apr. 21, 2020. The entire teachings of the above applications are incorporated herein by reference.

### FIELD

The fuel-saving robot system for the ACE heavy-duty truck (HDT) of the present disclosure realizes a software-defined full digital powertrain based on a duo-motor mixed hybrid powertrain architecture; it is possible to dynamically regulate and control the transmission pathway, direction, and amplitude of the hundred-kilowatt level mechanical power flow or electric power flow among various vehicle-mounted electromechanical power subsystems through a vehicle-cloud collaborative machine learning (ML) algorithm or software over-the-air (OTA) update to meet the vehicle dynamics equation in real time, to continuously improve the existing functions of the vehicle or add new functions, and to achieve simultaneous optimization of multiple beneficial effects, such as vehicle driving performance, RDE fuel consumption (L/100 km) and exhaust emissions under the condition of meeting the vehicle emission standards stably and enhancing active safety. The base function of the L1 fuel-saving robot of the ACE HDT is the SAE L1 longitudinal autonomous driving function within the Operational Design Domain (ODD) of controlled-access expressways, and the technical problem of energy management strategy of the ACE HDT can be transformed into an equivalent narrow AI problem of computer playing Go based on the predictive adaptive cruise control (PACC) technical solution; the actual energy-saving and emission-reducing effects of the HDT are basically decoupled from the performance of the ACE HDT engine or the driver's skill level and are much better than that of human drivers, and the actual fuel consumption of the ACE HDT can be reduced by more than 25% compared with that of the modern HDT with an internal combustion engine; an advanced function of the Level IV fuel-saving robot includes operation in an L2 “shadow mode” or L3 “disengagement mode”, the Level IV fuel-saving robot can automatically generate a “discrepancy report” or a “disengagement report” through a real-time comparison between vehicle drive-by-wire signals from the human driver and the Level IV fuel-saving robot respectively, completes the “3R” batch validation on a ten-billion-mile level within the ODD of expressways with high performance-to-cost ratio and without negative impacts on the traffic safety of current road users, and the actual total validation expense can be reduced by more than 80% compared with that for the modern HDT with an internal combustion engine equipped with the L4 system; such batch validation can statistically prove with high confidence that the Level IV fuel-saving robot is safer and more reliable than driving by human drivers and enable the timely commercialization of the Level IV fuel-saving robot.

### BACKGROUND

Road freight is crucial to all major economies in the world. Long-haul freight (with average daily driving of more than 500 km; more than 80% of the driving mileage on controlled-access expressways) heavy-duty trucks (HDTs) are both the backbone of the road freight industry and the major fuel users and polluters in the transportation field. They are one of the focuses of energy-saving and emission-reduction supervision and rectification for governments around the world throughout the year. At present, the mandatory regulations of Europe and US on emissions from large commercial vehicles (with a gross weight of more than 15 tons) including long-haul HDTs (“HDTs” for short) have turned from the Euro VI standard (fully implemented in Europe from 2014) focusing on reducing exhaust pollutant emissions and EPA-2010 (fully implemented in USA from 2010) to a series of new emission regulations focusing on reducing various carbon emissions of greenhouse gas (GHG) dominated by carbon dioxide (CO₂) in the vehicle exhaust. The carbon emission (CO₂ g/km) of the vehicle is proportional to its fuel consumption (L/100 km), and reducing vehicle fuel consumption (or improving fuel economy MPG; in mile/gallon) is equivalent to reducing its carbon emissions.

The regulations on greenhouse gas from medium duty/heavy duty engines and commercial vehicles (GHG Phase II) issued by the US Federal Government in 2016 explicitly specify the detailed mandatory standards for vehicle fuel economy (FE, mile/gallon) of all new medium duty/heavy duty engines and commercial vehicles sold in USA to be improved year by year and the fuel consumption (FC, L/100 km) and carbon emissions (g/km) to be reduced from 2021 to 2027 under the condition of leaving the emission limits for exhaust pollutants unchanged as that in the EPA-2010 regulation. In early 2019, the European Union approved the first mandatory regulations on carbon emissions from HDTs (i.e., Euro VII) in its history. The regulations require that the carbon emissions (g CO₂/km) from new HDTs in Europe will be reduced by 15% by 2025 and the carbon emissions from new HDTs will be reduced by 30% by 2030 with diesel HDTs in 2019 as a benchmark under the condition of maintaining the emission limits for exhaust pollutants in Euro VI unchanged. China began to implement the China V mandatory regulations on emissions from large commercial vehicles nationwide from 2017, and implemented the China BG-6 mandatory regulations on emissions nationwide from July 2021. The China BG-6 vehicle emission standards are basically the same as Euro VI and EPA-2010 in the aspect of limits for emissions of exhaust pollutants, and some limits are even more strict.

Emission regulations are the main driving force of vehicle powertrain technology development all over the world. The powertrain of HDTs that meet the China BG-6 vehicle emission standards will be at the same technical platform level as that of North America and Europe for the first time in history. Based on the historical experience in the past 20 years that all the regulations China I to VI are formulated and promulgated by reference to regulations Euro I to VI, it is expected that China will follow the EU and quickly introduce the China BG-6I regulations focusing on carbon emission intensity and fuel consumption of HDTs. Obviously, after 2020, the mandatory emission regulations and industry focus of China, America and European Union as the three major HDT markets in the world will be turned to reduction of fuel consumption and carbon emissions from HDTs year by year from continued reduction of exhaust pollutant emissions from HDTs. The average fuel cost of a HDT for long-haul freight is approximately USD 60K per year in Europe and US, and up to RMB 400K per year in China. The total fuel cost of over 2 million HDTs in USA is more than USD 100 billion per year, and the total fuel cost of over 4 million HDTs in China is more than RMB 1 trillion per year. The fuel consumption and pollutant emissions of the HDTs can be reduced through technical innovations, which are of great significance to OEMs (truck manufacturers), drivers, fleets, shippers, governments, societies and other stake-holders.

USA has always been in the forefront of the world in terms of the formulation of regulations on pollutant emissions and fuel consumption of HDTs as well as the relevant technology research and development. The USA Department of Energy (DOE) led and funded the SuperTruck I (2011-2016) project totaling USD 100 million, and all the four super HDT prototypes created by the four technical teams led by top four major HDT OEMs in USA through five years of research and development overfulfilled the goals of improving the fuel economy (gallon/ton-mile) by 50% for freight HDTs compared with a 2009 vintage HDT and the brake thermal efficiency (BTE) of 50% for diesel engines by the end of 2016. From 2017 to 2022, The USA Department of Energy funded five technical teams with another USD 80 million to implement the SuperTruck II project, and the five prototypes are expected to achieve the goals of brake thermal efficiency (BTE) of 55% for diesel engines and improvement in fuel economy (gallon/ton-mile) by 100% for freight HDTs in 2022. For each technical team led by the HDT OEMs, the total resource inputs of the enterprises are higher than the funded capital they receive from the US Government. The SuperTruck I&II in the USA took a total of a decade (2011˜2022), with a total cost of more than USD 400 million, and the technical pathway and R&D achievements of nine prototypes represent the top technical level of the HDT industry in the world today.

The SuperTruck project in the USA integrates various HDT energy-saving and emission-reducing technologies that the HDT industry in North US believes may be mass-produced and put into commercial use by 2025. The main challenge in the future is how to improve the performance-to-cost ratio of the producibility of various energy-saving technologies and accelerate the pace of commercialization. At present, the medium and long-term challenges in the U.S. HDT industry are how to achieve the mandatory requirements for 2027 HDT fuel consumption of GHG PhaseII under the condition of controlling the price rise of new HDTs effectively. It is worth noting that none of the above nine technical teams adopts the technical pathway of full hybrid HDTs. All the stake-holders of the HDT industry in China need to face the severe test that the retail prices of new HDTs meeting the requirements of the Limits and Measurement Methods for Emissions from Light-duty Vehicles (China BG-6) mass-produced and sold from 2020 are estimated to rise greatly compared with the selling price of current HDTs meeting the requirements of the Limits and Measurement Methods for Emissions from Light-duty Vehicles (China V).

In last decade, in the world's major automobile markets, especially the world's largest Chinese automobile market, there are successful cases of mass commercial use of electric or hybrid passenger vehicles and large buses heavily subsidized by the government. However, on the Chinese/US/European Union's markets of the largest, most technologically advanced HDT for long-haul freight, domestic and foreign industry experts agreed that the mass commercial use of electric HDTs or Full Hybrid Trucks for long-haul freight cannot be achieved without subsidies before 2030 due to limitations of industrializable power battery technologies and performance limits. For details, refer to the following European and US unclassified industry research reports: 1) Ricardo (2017), “Heavy Duty Vehicle Technology Potential and Cost Study”, Final Report for ICCT; 2) “European Heavy-Duty Vehicles: a white paper “European Heavy-Duty Vehicles: Cost Effectiveness of Fuel-Efficiency Technologies for Long-Haul Tractor-Trailers in the 2025-2030 Timeframe” published by Oscar Delgado and other experts of the International Council on Clean Transportation (ICCT) in January 2018; 3) an academic report “HDV Fuel Efficiency Technologies” published by Dr. Felipe Rodriguez from ICCT on Jun. 28, 2018; 4) a report “Adoption of New Fuel Efficient Technologies from SuperTruck” presented by the USA Department of Energy to the USA Congress in June 2016. 5) an investigation report “Viable Class 7/8 Electric, Hybrid and Alternative Fuel Tractors”, North US Council for Freight Efficiency, December 2019.

The actual fuel consumption (L/100 km) of a hybrid vehicle is highly related to its driving conditions. Vehicles under urban conditions have low average speed and frequent active acceleration, deceleration or braking; vehicles under expressway conditions have high average speed and infrequent active acceleration, deceleration or braking. Hybrid vehicles recover energy mainly through regenerative braking of the driving motors to achieve the beneficial effects of energy saving and emission reduction. The global automotive industrial and academic circles have the following “consensus” on the fuel saving potential of hybrid vehicles (light vehicles and large commercial vehicles) for a long time: hybrid vehicles have a more obvious fuel saving effect than traditional fuel vehicles under urban conditions, and the overall fuel consumption can be reduced by more than 30%; however, the engine can work steadily in its high efficiency zone under full high speed conditions (average speed is above 60 km/h; active acceleration or braking deceleration is infrequent), hybrid vehicles have a less obvious fuel saving effect than traditional fuel vehicles, and it is impossible to reduce the overall fuel consumption by more than 10%; especially, series hybrid vehicles have a fuel saving effect not as good as that of parallel hybrid vehicles under expressway conditions and may even consume more fuel than traditional fuel vehicles because multiple energy conversion runs are required for the power generation drive of the engine.

Diesel engines account for more than 95% of the engines of commercial HDTs that have been mass-produced in the world; the diesel engines of HDTs can stably work in their high efficiency combustion area under expressway conditions; after decades of continuous improvements, the fuel saving benefits decrease progressively, the technical challenge of further reducing the fuel consumption and emissions of traditional diesel engines is growing, and the increase in cost also reaches a higher level; in the past 25 years, the annual decline in average fuel consumption (L/100 km) was less than 1.5% for the industry of HDTs for long-haul freight in America, Europe and China; for HDT manufacturers in Europe and US or China, year-by-year obvious reduction of actual combined fuel consumption (L/100 km) of HDTs for long-haul freight with market-recognized high cost effectiveness poses great technical and commercial challenges. Refer to the position paper “The European Commission Proposal on CO₂ Standards for New Heavy-Duty Vehicles” of Association des Constructeurs Européens d'Automobiles (ACEA) on EU Euro VII emission standard legislation for HDTs in August 2018. ACEA believes that the EU's Euro VII carbon emission standard to be approved, which aims to reduce fuel consumption by 15% in 2025 and 30% in 2030, is too radical, the development of the new HDT powertrain takes a long time, there is no available cost-effective technical pathway that enables timely mass production to achieve the objectives of the EU fuel-saving regulation in 2025, which shows that further reduction in the fuel consumption of modern HDTs by double-digit percentage points is extremely challenging technically and commercially. Obviously, any fuel-saving technology has the dual benefits of reducing vehicle exhaust pollutant emissions and greenhouse gas (or carbon) emissions.

In addition to the two constant challenges of energy saving and emission reduction, active driving safety is also the most important for HDTs for long-haul freight. The vast majority (90%+) of traffic accidents on roads are originated from distraction to drivers, fatigue driving, operation errors and other human factors. In recent years, the popular automatic driving technology worldwide, especially SAE L3/L4 automatic driving technology, aims to replace human drivers with artificial intelligence (AI) drivers, eliminate human factors, and greatly improve the active safety of vehicles. Experts in the scientific and technological circles and the automotive industry believe that the HDT for long-haul freight equipped with the L3/L4 autonomous driving system is one of the key points for the implementation and commercialization of automatic driving technology as soon as possible within an Operational Design Domain (ODD) for expressways; L3/L4 automatic driving commercial vehicles must be configured with redundant power systems, braking systems, steering systems, power supplies and the like in order to meet the functional safety level requirements of vehicles as specified in ISO 26262.

A highly automated vehicle (HAV) refers to a vehicle equipped with SAE L3/L4/L5 autonomous driving system. Over the past five years, players from traditional OEMs/component suppliers, technology giants, start-ups, transportation operators and the like have invested tens of billions of dollars to develop and test the HAV worldwide. The commercialization of the HAV in volume will have a huge and far-reaching impact on the global passenger vehicle industry and road freight industry at a trillion-dollar level. The greatest selling point of the HAV is to significantly reduce the road traffic accident rate and improve the active driving safety by partially or completely replacing human drivers with AI drivers. Industry experts universally acknowledge that the HDT for long-haul freight is one of the core scenarios for commercialization of the HAV; the HAV has completed the batch validation “3R” tests (Real Vehicle, Real Road, Real Payload) on a billion mile scale on national expressways, which proves with high confidence in a statistical sense that AI drivers are safer than human drivers, which is the only route which must be passed before the commercialization of the HAV. the HAV on open roads could bring additional traffic risks to other road users, and such a risk can be defined as the product of traffic accident severity and accident incidence; both subjective and objective risks of testing on HAV HDTs within an Operational Design Domain (ODD) for expressways are greater than those of testing on HAV passenger vehicles since the shape and weight of HDTs are one order of magnitude greater than those of passenger vehicles; more than 95% of the vehicles (light or medium-sized vehicles) running on the expressways are Vulnerable Road Users compared with HAV HDTs. Currently, governments around the world, represented by the USA and China, have vigorously promoted the research and development of HAVs and have revised the current traffic laws and regulations in succession, allowing 3R Tests (Real Vehicle, Real Road, Real Payload) to be performed on HAV passenger vehicles configured with a Safety Driver on public roads, and commercial trial operation of HAV taxis is even allowed within a specific Operational Design Domain (ODD) in California, Nevada, Arizona and the like; however, with regard to the 3R Tests of HAV HDTs on expressways, governments of various countries are very cautious about approving the 3R Tests of HAV HDTs on public roads because both subjective and objective traffic risks of HAV HDTs running at high speed are much greater than those of HAV passenger vehicles for existing road users; as of March, 2020, all countries in the world have expressly prohibited the L3 or L4 3R Tests on HAV HDTs for long-haul freight on expressways across the country, which has made the commercialization of HAV HDTs fall into the paradoxical dilemma of “chicken or egg first”. How to complete the 3R road tests of HAV HDTs within the ODD of expressways without increasing the traffic risk for the existing road users, accumulate the 3R batch validation data at the level of one billion miles to ten billion miles and prove with high statistical confidence that AI drivers are safer and more reliable than human drivers is a worldwide technical and commercial difficult problem that must be solved before the commercialization of HAV HDTs. However, no effective technical solution to the above problem has been found in the world. The global HAV leader Waymo completed nearly 20 million miles of 3R Tests of HAV passenger vehicles (with a total weight of less than 3.5 tons) on suburban roads (including expressways) and 10 billion mile-level computer simulation “3V Tests” (Virtual Vehicle, Virtual Road, Virtual Payload) in America from 2010 to the end of 2019. However, the accumulated mileage of 3R Tests of HAV HDTs for long-haul freight from Waymo up to now is far less than one million miles, one of the main reasons is the legal barrier (i.e., AI drivers have no “right of way”) for the 3R Tests of HAV HDTs, and the other is the extremely high expense for the 3R Tests of HAV HDTs; HDT drivers must hold a Commercial Driver's License (CDL), accounting for less than 3% of all drivers, and the labor cost of HDT drivers is significantly higher than that of ordinary drivers; the fuel consumption of HDTs is more than 30 L/100 km, while the fuel consumption of passenger vehicles with internal-combustion engines, especially hybrid passenger vehicles, is less than 10 L/100 km; thus, the variable cost per unit (mainly refers to the costs for the driver and fuel) for the 3R Tests of HAV HDTs exceeds USD 1/mile, which is nearly 200% higher than that of HAV passenger vehicles; moreover, data of the 3R Tests of HDTs and that of passenger vehicles are not interchangeable for their L4 AI drivers as compared with the vast majority of passenger vehicle drivers who are incapable of driving HDTs. In other words, a lot of 3R Tests data or commercial operation data of HAV passenger vehicles have little reference value for the batch validation and commercialization of HAV HDTs.

Optimization of vehicle energy saving, emission reduction, and active safety, under the premise of ensuring the full vehicle propulsion performance, are the three ultimate goals that the global automotive industry has been pursuing over the past two decades, mainstream HDT OEMs and related research institutions in Europe and US have invested huge amount of human and material resources to actively explore and develop a variety of fuel-saving technologies for HDTs; and by the end of 2019, none of the mainstream HDT OEMs and tier I suppliers in Europe and US had disclosed a new technical pathway or solution for a HDT with a full hybrid powertrain that could meet the 2025 carbon emission target value of the Euro VII regulation or the 2027 carbon emission target value of the USA GHG-II regulation and could be industrialized timely.

The information in this Background section is only intended to increase the understanding of the general technical background of the present disclosure, and should not be deemed to recognize or imply in any form that the information has become the prior art well known to those of ordinary skill in the art.

### SUMMARY

The present disclosure provides a new class of HDT fuel-saving robot system for long-haul freight, which is a non-humanoid intelligent industrial robot capable of autonomous learning and evolution intended to solve the worldwide problem that it is very difficult to find a technical pathway with high performance to cost ratio HDT powertrain ready for mass production and commercialization, which meets the 2025 carbon emission target of the new Euro VII regulations and the 2027 carbon emission target of the US greenhouse gas Phase II (GHG-II) regulations due to slow annual improvement in fuel consumption (annual reduction is less than 1.5% on average) of the new diesel HDT in the prior art. In the application of long-haul freight, the overall fuel consumption (L/100 km) of an Autonomous-Connected-Electrified (ACE) HDT with fuel-saving robot under the real-world driving environment (RDE) can be reduced by more than 25% under the condition of ensuring the driving performance and rate of attendance of the vehicle compared with the modern HDT with diesel engine. In addition, the active safety of vehicle driving can also be improved, and it can ensure that the RDE exhaust emission meets the standard steadily within the useful life range of 700,000 km. All the main subsystems of the fuel saving robot of the ACE HDT in this disclosure have been industrialized, which can realize mass production and commercial application by 2023 and meet the 2025 carbon emission target of the Euro VII regulations or the 2027 carbon emission target of the US greenhouse gas Phase II (GHG-II) regulations ahead of schedule without relying on any products or technologies that are not mature or cannot be mass-produced in the near future. This will be described in detail later.

The fuel-saving robot of ACE HDT of the present disclosure can be divided into five levels: an ACE1 HDT refers to an ACE HDT equipped with SAE L1 autonomous driving system (hereinafter referred to as L1 system), which has the function of one-dimensional longitudinal control—predictive adaptive cruise control (PACC) and focuses on optimization of the actual fuel consumption and emission of a HDT for long-haul freight, and this fuel-saving robot is a basic type fuel-saving robot, i.e., Level I fuel-saving robot; all the following four types are upgraded versions of the Level I fuel-saving robot, and each advanced fuel-saving robot is downward compatible in terms of all functions and properties related to energy saving, emission reduction, or active driving safety of ACE HDTs; an ACE2 HDT refers to a HDT equipped with L2 system, i.e., Level II fuel-saving robot; an ACE3 HDT refers to a HDT equipped with L3 system, i.e., Level III fuel-saving robot; an ACE4 HDT refers to a HDT equipped with L4 system, i.e., Level IV fuel-saving robot; an ACE5 HDT refers to a HDT equipped with L5 system, i.e., Level V fuel-saving robot. The L5 system must rely on a general artificial intelligence (GAI) technology that will appear in the distant future and it is extremely difficult to industrialize before 2030. Firstly, the present disclosure focuses on the technical solution to achieve the simultaneous optimization of energy saving and emission reduction of ACE HDTs in the application of long-haul freight under the condition of ensuring the driving performance of full vehicles; secondly, the present disclosure focuses on the technical solution of completing the 3R batch validation of Level IV fuel-saving robot (i.e., L4 system) of the ACE HDT with high performance to cost ratio within the ODD of expressways nationwide under the condition of ensuring the traffic safety of existing road users. Unless explicitly marked, the ACE HDT can represent any of the five types of HDTs from ACE1 to ACE5; the fuel-saving robot of a HDT can refer to anyone of the Level I to Level V fuel-saving robots; the advanced driver assistance system (ADAS) refers to a L1 or L2 system. When the technical solution of the present disclosure is described, it focuses on the Level II fuel-saving robot or Level IV fuel-saving robot, and the Level I fuel-saving robot or Level III fuel-saving robot can be regarded as a separate simplified special case of the above two robots.

To solve the above technical problems and achieve the above beneficial technical effects, the present disclosure is realized through the following technical solutions.

The energy of current various hybrid passenger vehicles or large commercial vehicles is effectively recovered by restricting the engine to operate at the high efficiency zone and regenerative braking of a driving motor to charge the battery pack under the urban or suburban conditions where the vehicles need to actively accelerate and apply brakes frequently at the average speed less than 40 km/h, which greatly reduces the overall fuel consumption (L/100 km) (with a fuel saving ratio up to 30%˜60%) compared with traditional engine vehicles, with obvious energy saving and emission reduction effects and high cost effectiveness, thus having achieved the mass commercial use of the hybrid vehicles in the world's major automotive markets. However, with regard to HDTs for long-haul freight, most of the run time and mileage (over 85%) within their product life cycles are under highway conditions, with few active acceleration or braking; the highway networks in economically developed regions in China are congested throughout the year, the average speed of HDTs for long-haul freight is about 60 km/h, while the average speed of HDTs for long-haul freight in America is about 95 km/h. The engines of traditional diesel HDTs with few active acceleration or braking stably work at the high efficiency zone under the expressway conditions, with optimized overall fuel consumption and limited further improvement space; while the regenerative braking energy recovery function of the hybrid vehicles is useless due to infrequent active braking of the vehicles; in addition, the hybrid vehicles, especially range-extended series hybrid vehicles, have additional loss due to multiple energy conversions among chemical energy, mechanical energy, electric energy and mechanical energy, so there has been a “consensus” among experts and ordinary technicians in the global automobile and road transportation industry for a long time that the drop of the overall fuel consumption of hybrid HDTs for long-haul freight (hereinafter referred to as “hybrid HDTs”) is limited compared with the traditional diesel HDTs, it is unlikely that the largest fuel saving rate exceeds 10%, especially series hybrid vehicles which may even have slightly increased overall fuel consumption when running under expressway conditions. According to the technical level and industrial development status of the current three major powers (battery, motor and electronic control) in the world, compared with traditional diesel HDTs, the vehicle purchasing cost growth of hybrid HDTs is obvious. If the fuel saving ratio cannot exceed 20%, the cost effectiveness of the hybrid HDTs will be low (for example, the return on investment (ROI) of making up the comprehensive cost difference between hybrid HDTs and traditional fuel HDTs by saving fuel cost is longer than three years) without government subsidies, and the sustainable market competitiveness is insufficient.

As described above, experts and ordinary technicians in the global HDT industry agree that it is difficult to achieve the mass commercial use of the hybrid HDTs for long-haul freight without government subsidies in the three major HDT markets, including China, America and Europe, before 2030. In addition, subject to the technical limits of today's automotive power lithium batteries and the limitations of industrial development, electric HDTs for long-haul freight need to be equipped with a battery pack with an effective capacity of at least 1000 kWh, and the battery pack is too large, too heavy, too expensive and cannot be quickly charged (sub-hour level); it is difficult to be commercialized in volume before 2030 without high government subsidies. Hydrogen-electric hybrid HDTs with hydrogen fuel cells as low carbon clean range extenders cannot be commercially available until 2030 due to the restrictions of technology, industrial chain, immaturity and high cost of hydrogen production/hydrogenation infrastructures and other factors. In other words, significantly different from the rapid growth of the market share of pure electric passenger vehicles, the HDTs for long-haul freight will continue to use internal combustion engines, especially diesel engines, as the core power source assisted by hybrid in the next 20 years.

The highway freight industry in Europe and US faces another major challenge that the vacancy rate of HDT drivers and turnover rates are high throughout the year. For the same HDTs, loads and road sections, drivers with different levels can result in the actual overall fuel consumption (L/100 km) difference up to 20%; the actual fuel consumption of HDTs for long-haul freight varies from person to person, the daily management and training of drivers occupy fleet management resources and are inefficient, which is another major shortcoming of the highway logistics industry. Lots of freight transport companies reduce the difference between the actual fuel consumption and the optimal fuel consumption caused by human factors of drivers though various methods, such as driver training, fuel-efficient rewards and punishments, installation of onboard sensors, big data analysis of driver's driving behavior and fuel saving guidance; however, the above methods can solve the symptoms but not the root causes. For most fleets of long-haul freight, the actual fuel consumption of HDTs varies from person to person with high dispersion is always a major shortcoming in the industry.

The cost effectiveness of ACE HDTs for long-haul freight must be greatly improved in order to compete and win with the traditional fuel HDTs in a sustainable manner without government subsidies and realize large-scale commercial use as soon as possible. The average selling price (retail price USD 150,000/vehicle or RMB 400,000/vehicle) of a complete HDT for long-haul freight is five to eight times the price of a common passenger vehicle in the market of America or China, but the annual fuel cost of the HDT for long-haul freight is more than 30 times the annual fuel cost of a family passenger vehicle. The retail price of gasoline or diesel in America and China is obviously lower than the retail price of the gasoline or diesel in Europe, and the proportion of the price of passenger vehicles to HDTs and the annual fuel expense in Europe is similar to that in China and America. Two effective methods for improving the cost effectiveness of the hybrid diesel HDTs for long-haul freight are provided, one is to increase the fuel saving ratio compared with that of traditional diesel vehicles, and the other is to reduce the price difference between the sum of the one-time purchase cost and the accumulated vehicle operation and maintenance cost of the hybrid diesel HDTs and that of the traditional diesel vehicles (i.e., Total Ownership Cost, TOC), i.e., to broaden sources of income and reduce expenditure. The saved fuel cost can be directly converted into the profit of the fleet under the condition of ensuring the power, safety and rate of attendance of the ACE HDT.

Based on the objective fact that the actual fuel saving effect of most hybrid passenger vehicles (with gross weight of less than 3.5 tons; series, parallel, or mixed hybrid system architecture) is not significant under expressway conditions, global automobile industry experts (especially HDT industry experts) make their subjective extensional speculation and conclude that the actual overall fuel saving ratio of hybrid HDTs for long-haul freight, in particular the series hybrid HDTs, cannot be higher than 10%, and there may even be a slight increase in fuel consumption. So far (end of 2019), no public report or academic paper on comparative analysis of the fuel consumption of Full Hybrid Truck (especially dual-motor range-extended series or mixed hybrid HDTs) vs. traditional diesel HDTs after large-scale road tests of “3R” (Real Vehicle, Real Road, Real Payload) in the application of long-haul freight has been found worldwide, not to mention any precedent for commercial applications in volume. However, the above industry consensus, like the so-called “White Swan consensus”, has its historical limitations and can be falsified through scientific experiments; the industry experts ignore the secret source for possibly reducing the actual fuel consumption of the hybrid HDTs for long-haul freight greatly, that is the time-varying function P_{g}(t) of grade power with amplitude of hundreds of kilowatts caused by small changes (1.0 degree) of the road longitudinal slope tilt (“longitudinal slope” for short) and many opportunities to recover kilowatt hour (kWh) electric energy through regenerative braking of 100 kW driving motor generated when the HDT is going downhill at high speed.

One of the cores of the present disclosure is an “electrical Power Split Device” (ePSD; also known as “electrical power diverter”) based on a 100-kilowatt-class power electronic three-port network. By effectively integrating the vehicle engine plus duo-motor Mixed Hybrid powertrain technology, Global Navigation Satellite System (GNSS), 3D e-map (3D map), Internet of Things, Big Data, artificial intelligence and other emerging technologies, a new class of HDT for long-haul freight, i.e., Automated, Connected, Electrified (ACE) HDT, is created. This vehicle is equipped with a Level I “fuel-saving robot” which enables automatic optimization and continuous improvement of the fuel saving strategy and commands the ACE HDT to implement the technical solution of predictive adaptive cruise control (PACC) to realize the SAE L1 longitudinal autonomous driving function, free up the driver's feet, and achieve multiple beneficial effects of optimization of fuel consumption and emissions, improvement of power, promotion of active safety, reduction of the labor intensity of drivers during long-distance driving and the like. The actual overall fuel consumption drop of ACE HDTs is up to 30% compared with that of the traditional diesel HDTs in the application of long-haul freight, and it can also eliminate the long-term industrial pain point of high discreteness of overall fuel consumption value of the HDT due to “human factors” of drivers; moreover, ACE HDTs can also continuously improve the existing functions of the vehicle or add new functions through software definition and over-the-air (OTA), greatly improve the cost effectiveness of ACE HDTs in the whole life cycle (up to 20 years in Europe and US), broaden sources of income and reduce expenditure, reduce cost and increase efficiency for the fleets. The Level I fuel-saving robot can also be upgraded to the Level IV fuel-saving robot; the “3R” batch validation of the Level IV fuel-saving robot on a one billion mile to ten billion mile scale accumulatively within the ODD of expressways with high performance to cost ratio is completed in two years through operation in a “shadow mode” for L2 or “Disengagement Mode” for L3 under the condition of ensuring the traffic safety of existing road users to statistically prove with high confidence that the Level IV fuel-saving robots are safer and more reliable than human drivers; the total validation cost is 80% lower than that of the traditional diesel HDT configured with L4 system; the government and the public will be persuaded to revise relevant laws and regulations, and promote the Level IV fuel-saving robots (i.e., ACE4 HDTs) to enter the phase of commercial applications in volume as soon as possible; the ACE4 HDT with a single driver will be enabled to run continuously and safely for 24 hours day and night, so that the labor productivity of human drivers can be improved by more than 50%, the consumed time and cost per unit (USD/ton-mile) of ultra-long freight events for long-haul freight on a thousand mile scale can be significantly reduced, which has a revolutionary impact on the long-haul freight industry on a trillion dollar scale for expressways in the whole world. For the transport fleet, efficiency and safety are two eternal themes. Various electromechanical hardware and software on ACE HDTs plus the dynamically collaborative cloud-end AI training chip and vehicle-end AI inference chip combined with structured big data (i.e., fuel saving data set) about the operation of ACE HDTs on the cloud end and vehicle end and various fuel saving machine learning algorithms form a system device of “fuel saving robot” for ACE HDTs; this fuel-saving robot is a non-humanoid intelligent industrial robot which can assist human drivers to automatically optimize the energy and power management of HDTs for long-haul freight in real time, reducing the overall fuel consumption by more than 25% compared with the traditional diesel HDTs, and has the capability of autonomous learning and evolution; it is estimated that the mass commercial use of the fuel saving robot of ACE HDTs for long haul road freight can be realized in the three major HDT markets of America, China and the European Union in five years.

The first principle of the fuel-saving robot technology of the ACE HDT is the vehicle dynamics equation (1-1) of its longitudinal driving well-known in the global automotive industry:

$${P}_{v} = \frac{V}{1000 η} ( {Mgf}_{r} cos α + \frac{1}{2} {ρ}_{a} {C}_{D} {A}_{f} {V}^{2} + Mg sin α + M δ \frac{dV}{dt} ) \qquad ( 1 - 1 )$$

Where, Pᵥ is the vehicle power or the road-load power, and the unit of all power items is kilowatt (kW).

The rolling power Pᵣ refers to the required power for overcoming the tire rolling friction resistance when the vehicle runs, which is a non-negative number, and the rolling power can be shown in the following formula (1-2):

$${P}_{r} = \frac{V}{1000 η} ( {Mgf}_{r} cos α ) \qquad ( 1 - 2 )$$

The air drag power P_{d} refers to the required power for overcoming air resistance (in calm weather) when the vehicle runs, which is a non-negative number, and the air drag power can be shown in the following formula (1-3):

$${P}_{d} = \frac{V}{1000 η} ( \frac{1}{2} {ρ}_{a} {C}_{D} {A}_{f} {V}^{2} ) \qquad ( 1 - 3 )$$

The longitudinal slope (or grade) power P_{g} refers to the required driving power, which is a positive number for overcoming gravitational potential energy when the vehicle runs uphill, and is a negative number for a vehicle running downhill, representing the driving power generated by the conversions between the potential energy and the kinetic energy of the vehicle; and the grade power P_{g} can be shown in the following formula (1-4):

$${P}_{g} = \frac{V}{1000 η} ( Mg sin α ) \qquad ( 1 - 4 )$$

The acceleration power Pₐ refers to the required additional power for the vehicle reaching the predetermined acceleration when running on a flat road. When the acceleration is a negative value, it represents deceleration braking, that is either friction mechanical braking, which converts the kinetic energy of the vehicle into thermal energy for consumption, or non-friction regenerative braking, which converts part of the kinetic energy of the vehicle into electric energy and charges the battery pack to recover energy. The acceleration power Pₐ can be shown in the following formula (1-5):

$${P}_{a} = \frac{V}{1000 η} ( M δ \frac{dV}{dt} ) \qquad ( 1 - 5 )$$

In the above five formulas (1-1) to (1-5): V is the longitudinal linear speed of the vehicle (m/s); η is the vehicle drive-train efficiency; M is the gross vehicle mass (kg); g is the acceleration of gravity, and g=9.8 (m/s²); fᵣ is the tire rolling friction coefficient; α is the highway longitudinal slope angle (grade), a positive value represents upslope, a negative value represents downslope, and a zero represents the absolute level ground; ρₐ is air density (kg/m³); C_{D} is the vehicle wind resistance (drag) coefficient; A_{f} is the vehicle front vertical plane projection area (m²) of the vehicle; δ is the rolling mass conversion coefficient; dV/dt is the vehicle longitudinal acceleration (m/s²), a positive value represents acceleration, and a negative value represents deceleration or braking. The longitudinal slope of each highway is only a spatial function; unless the road is under repair or modification, the longitudinal slope function does not vary with time; because the longitudinal speed of the vehicle during driving is a time-varying function, the grade power is also a time-varying function according to equation (1-4), and is only one substantially and rapidly changing time-varying function in the dynamic equation (1-1) when the vehicle runs at a basically constant speed.

Active braking (deceleration) or acceleration is seldomly performed by the vehicle under the expressway running condition. When the vehicle runs at a basically constant speed, according to the dynamic equation (1-1), the acceleration power is approximately zero, the rolling power is basically unchanged on a highway section with a small longitudinal slope (i.e., grade within±several degrees), the air drag power can also be approximated to a constant, only the grade power is a time variable, and the change amplitude of the grade power is proportional to the sine of longitudinal slope angle of the expressway section, vehicle speed and gross vehicle weight. The “longitudinal slope” is short for the road longitudinal slope (or grade) and there are two unit of measurement; one is the included angle between the road surface and the horizontal plane in degrees, and the other is the ratio of the road surface elevation height to the road horizontal projection distance, shown in %. Most countries limit the longitudinal slope within the range of −7.0%˜+7.0% in expressway design and construction, which is mainly based on consideration of ensuring that a full-load HDT can run downslope an expressway section safely. The gross weight of a HDT for long-haul freight in China is mostly below 41 tons, the maximum statutory speed limit is 90 km/h, major expressways in China are often congested, and the average speed of the HDTs in the China road freight industry is about 60 km/h; the gross weight limit of the HDT for long-haul freight in US is 36 tons, while the maximum statutory speed limit can be up to 125 km/h, and the average running speed of the HDTs in the US road freight industry is about 95 km/h. Most US transport companies generally limit the maximum speed of the HDTs to 105 km/h in view of fuel saving and safety.

For example, for a fully loaded HDT with the gross weight of 40 tons and the speed of 60 km/h, the required grade power is up to 228 kW when the vehicle encounters a highway with a longitudinal slope of 2.0 degrees and goes upslope at a constant speed, and at the moment, the sum of the rolling resistance power and the air drag power of the vehicle is only 71 kW; if the power reserve of the powertrain is insufficient at the moment, the HDT must downshift and decelerate before continuing to go upslope. Compared with a passenger vehicle with the gross weight of 2 tons, when the passenger vehicle runs on a longitudinal slope at 2.0 degrees at the same constant speed, the grade power for the vehicle at the moment is 11.4 kW (5.0% of the grade power of the HDT), while the sum of the rolling friction power and the air drag power is only 3.6 kW; for passenger vehicles with the peak power of 100 kW, there is no need to worry about this slope, and the vehicle runs as easily as walking on firm earth. In other words, for each fully loaded HDT running at high speed, every 1.0 degree change, which is hard to see by naked eyes, of the road longitudinal slope means that the road-load power of the HDT (mainly originated from grade power changes) will have a great change of more than 100 kW. Going uphill must be followed by going downhill. When going downhill, the 100-kW level grade power of the HDT is negative, a constant vehicle speed can be maintained through the regenerative braking of the driving motor (equivalent to negative acceleration power during active braking), part of mechanical energy generated when the vehicle goes downhill can be converted into electrical energy to charge the battery pack and recover energy. Although there are few active brakes for ACE HDTs under expressway conditions, there are still many “passive braking” opportunities to recover kWh level electrical energy by regenerative braking while going downhill for ACE HDTs running at basically uniform speed because slight changes of 1.0 degree level along the longitudinal slope of the highway can bring 100-kW level grade power changes. A small stream flows far, and many a little makes a mickle. This is the secret that ACE HDTs for long-haul freight have a more obvious fuel saving effect than that of the traditional diesel HDTs.

When the vehicle is running at the speed of 60 km/h, the required braking power is 67 kW for passenger vehicles with the gross weight of 2.0 tons to realize moderate-intensity braking with the deceleration of 2 m/s² (i.e., 0.2 g); however, for a HDT with the gross weight of 40 tons, the braking power required is as high as 1333 kW; the total mass of an urban electric bus is 20 tons, the average speed is about 30 km/h, and the braking power required for the urban bus to achieve the deceleration of 0.2 g is 333 kW. Limited by the peak power of the industrializable onboard driving motor and/or the motor control unit (power electronics), the peak power upper limit of hybrid vehicles to recover energy by regenerative braking is below 500 kW at present; however, the part of instantaneous vehicle braking power higher than 500 kW cannot be converted into electric energy by regenerative braking of the motors for charging the battery pack to recover energy, so this part of vehicle kinetic energy can only be converted into heat energy by the mechanical braking system of the vehicle and totally wasted; at present, the commercialized DC fast charging pile with the maximum power in the world is the 375 kW charging pile. Under the mixed running conditions of a city or a suburb where the acceleration/deceleration is frequent, the fuel saving of the hybrid vehicles (light-duty vehicles or large buses) is more obvious than that of traditional vehicles powered by engines, and the fuel saving ratio is 30%˜60%. In other words, there are few active brakes for HDTs for long-haul freight under expressway conditions, but there are still many opportunities for 100-kW level passive braking (downhill); at the same time, during emergency braking of the HDT under the expressway working condition, it mainly depends on the mechanical braking system, and on the contrary, most of the kinetic energy of the HDT cannot be effectively recovered through regenerative braking.

Under the normal road conditions of expressways with infrequent active acceleration and deceleration with an average vehicle speed of higher than 60 km/h, the traditional engine can work steadily in its high efficiency zone, compared with the fuel saving effect of the traditional vehicles powered by engines, the fuel saving effect of the hybrid vehicle is not significant (the fuel saving ratio is less than 10%), especially for a series hybrid vehicle, its overall fuel consumption may be even surging rather than falling because of the additional energy loss caused by multiple energy conversions; the above-mentioned “consensus” of the global automobile industry is applicable for all hybrid passenger vehicles (with gross weight less than 3.5 tons) and parallel hybrid (an engine with the peak power of greater than 250 kW is mechanically connected in parallel with a medium-sized electric motor with the peak power of less than 200 kW) large commercial vehicles. However, inventors believe that the “consensus” of the industry is not applicable for the ACE HDT with a 100-kW level rated power duo-motor range-extended series hybrid or mixed hybrid (series-parallel) system architecture in the application of long-haul freight. Although there are few active acceleration or brakes for ACE HDTs under expressway conditions, there are many passive braking opportunities to recover kWh level electrical energy through regenerative braking of the driving motor leveraging the 100-kW level grade power with the vehicle going downhill due to the slight grade change of 1.0 degree level fully distributed along the highway. A small stream flows for a long time, and many a little make a mickle. In other words, when a loaded HDT runs along a section of expressway at a constant high speed, every small 1.0-degree-level change of the longitudinal slope function can lead to the 100-kW level grade power changes, and the impact on road-load power is equivalent to frequent active acceleration or braking of a passenger vehicle or bus on an urban flat road.

All the duo-motor mixed hybrid ACE HDTs of the present disclosure contain an engine (diesel or natural gas) of HDT with the peak power of greater than 250 kW and two large motors with the peak power of greater than 200 kW. One motor (MG1) is mainly used as the generator, and the other motor (MG2) is mainly used as the driving motor. The driving motor is one of the decisive factors for the driving performance of hybrid HDTs, and its peak power shall be greater than 250 kW; the larger the driving motor, the better the vehicle driving performance, and the better the effect of regenerative braking energy recovery. To solve the problem that the cost of the conventional large driving motor stays in a high position without going down, a three-motor hybrid system with a standard primary driving motor (MG2) and an optional secondary driving motor (MG3) may also be considered.

In the recent decade, for some medium and high-end HDTs with internal combustion engines in Europe and US, fuel has been saved through the predictive cruise control (PCC) by using the vehicle-mounted 3D map comprising the road longitudinal slope information. However, the predictive cruise fuel saving of traditional HDTs has its limitations: firstly, a pure mechanical powertrain is not applicable for substantially and suddenly changing the output power of the engine instantaneously (sub-second level) at high frequency, or the automatic transmission shifts gears frequently; the predictive cruise control (PCC) is mainly applicable for long slopes with the longitudinal slope angle of greater than 2.0 degrees and the slope length of above several kilometers; secondly, the traditional HDT with internal combustion engine has no regenerative braking function, energy cannot be recycled when the vehicle is going down a long slope, and the actual overall fuel consumption decreases by less than 3.0%.

It is emphasized that there is no large-scale absolute flat expressway in the world; even in vast plain areas, there are road sections with a 100-meter-level granularity connected in series along the highway, and the absolute value of the longitudinal slope function of these road sections fluctuates in the range of 0.2˜3.0 degrees. For loaded HDTs running at basically constant speed under the expressway conditions, the sum of the rolling resistance power Pᵣ and the air drag power P_{d} can be approximated as a constant, the factor with the biggest impact on the time variable of the vehicle road-load power Pᵥ is the grade power P_{g}, which is proportional to the longitudinal slope angle; for every small upslope and downslope (with a grade change of 1.0 degree) along the road, the change amplitude of grade power is more than 100 kW, providing many opportunities to recover kWh level electric energy by the 100-kW level regenerative braking power for ACE HDTs. A small stream flows for a long time, and many a little make a mickle. If there is a vehicle-mounted 3D map on which the highway longitudinal meter-level interval density, the road positioning meter-level precision (longitude and latitude) and the longitudinal slope measurement accuracy up to 0.1 degree, by the aid of the collaborative real time positioning (longitude and latitude) and orientation measurement (longitudinal slope) of Internet of Vehicles or the meter-level high-precision satellite navigation (GNSS) and Inertial Measurement Unit (IMU) and according to the vehicle dynamics equation (1-1), the vehicle control unit (VCU) can in real-time and accurately predict the road-load power time-varying function ahead of the ego vehicle within hundreds of kilometers along the highway, especially the kilowatt-level granularity time-varying function of the grade power P_{g}(t) and the road-load power Pᵥ(t) within the range of hundreds of kilometers of the electronic horizon in front of the vehicle; the predictive refreshing frequency of the VCU can be up to 10.0 hertz (Hz); that is to say, the VCU can refresh the road-load power function prediction within its electronic horizon every 2-3 meters that the vehicle runs.

Various ADAS e-maps or HD maps commercially available in volume in countries around the world supporting the commercial use of the HAV can be used as the 3D map of the present disclosure to provide priori information on the “Electronic Horizon” for vehicles; the Electronic Horizon refers to the road information, especially the 3D information of longitude, latitude and longitudinal slope of the expressways contained in the 3D e-map within the specific range in front of the vehicle. The predictive cruise control (PCC) is implemented for the traditional diesel HDTs, and only the electronic horizon information within about 10 kms can be used effectively because it is limited by the fact that the traditional diesel HDTs are not suitable for frequent and quick switches of the working conditions of the engine or frequent gear shifting of the transmission and have no regenerative braking energy recovery function; however, the ACE HDT of the present disclosure can effectively utilize various ranges of electronic horizon information ranging from 10 km to 1000 km; details to follow.

For the ACE HDT running normally on expressways with active braking or acceleration seldomly performed, its speed is basically constant, and the time variation of the vehicle road-load power is mainly originated from the grade power change brought about by the grade change of the expressways. However, since both the vehicle travel route and the grade distribution function along the highway are fixed and known in advance, the VCU of the ACE HDT can quickly calculate the time-varying function of vehicle road-load power within the electronic horizon within one second according to the vehicle dynamics equation (1-1), vehicle configuration parameters, dynamic working condition data, priori road information on the electronic horizon, and real-time road traffic information, and continuously predict the time-varying function of vehicle road-load power in the future (at the hour level or 100 km level) with a kW-level granularity, so that the fuel-saving robot can have forethought, make full use of the ten kilowatt-hour level electric energy storage and 100-kW level electric power peak load shifting function of the power-type battery pack, and perform predictive energy management strategy on the mixed hybrid ACE HDT in real-time according to the fuel-saving machine learning (ML) algorithm to realize the simultaneous optimization of vehicle energy saving and emission reduction. The fuel-saving robot system of an ACE HDT in the present disclosure can transform the global problem of minimization of the fuel consumption of a HDT for long-haul freight into the equivalent narrow AI problem of computer playing Go (e.g. AlphaGo). The AI brain at the cloud-end fuel-saving robot can be trained and a deep neural network (DNN) model of the fuel saving algorithm can be established by using the fuel-saving data set generated by the operations of many ACE HDTs combined with the machine learning algorithm and cloud-end computing power; then, the AI chip at the vehicle-end fuel-saving robot performs reasoning and inference calculation according to the above DNN model, regulates and controls the pathway, amplitude, and direction of the engine mechanical power flow or battery pack electric power flow of the ACE HDT in real time to achieve the simultaneous optimization of RDE vehicle energy saving and emission reduction under the condition of ensuring the driving performance and active safety of the full vehicle; in terms of minimization of the actual fuel consumption, the fuel-saving robots win over the human drivers, and the actual fuel saving effect is basically decoupled from the driver's skill level and the configuration parameters of the ACE HDT engine. In other words, the traditional HDT with an internal combustion engine of the prior art using predictive cruise control (PCC) can only achieve actual fuel saving ratio of less than 3% with limited effects because it has no regenerative braking and energy recovery function; however, the duo-motor mixed hybrid ACE HDT of the present disclosure can achieve the beneficial effect of 30% fuel-saving than the traditional HDT with internal combustion engine due to its regenerative braking and energy recovery function with peak electric power of 500 kW, 10 kWh-level power-type battery pack plus the HDT fuel-saving robot having superior computing power and autonomous learning and evolution function; the details will be described later.

The ACE HDT fuel-saving robot system proposed by the present disclosure can accurately and continuously allocate the pathway, amplitude or direction of 100-kW level electric power flows among the three electric power sources, i.e., engine-generator set, battery pack, and driving motor, within ten-millisecond-level system response time by controlling the electrical Power Split Device (ePSD) through the vehicle control unit (VCU); through pulse modulation (PM), especially pulse width modulation (PWM) or pulse amplitude modulation (PAM), of the instantaneous output power of the engine or battery pack respectively, the engine is allowed to work steadily in its high efficiency zone for a long time, and the battery pack is allowed to work steadily in one of the three working modes of Charge Sustaining (CS), Charge Depleting (CD) and Charge-Increasing (CI) or switch smoothly among the three modes according to the dynamic prediction of the vehicle road-load power function in the electronic horizon; and the 100-kW level instantaneous change of the grade power item in the second-level time granularity is offset through 100-kW level high-rate charging and discharging of the battery pack in real time as well as peak-load shifting of the instantaneous road-load power, and the vehicle dynamics equation (1-1) is satisfied in real time continuously. Compared with traditional heavy duty diesel vehicles, the RDE fuel consumption of long-haul freight of the ACE HDT can be reduced by 30% under the condition of ensuring the driving performance, freight timeliness, and active safety of the vehicle.

The ACE HDT of the invention is of a duo-motor and single-clutch mixed hybrid system architecture, as shown in subsequent FIGS. 1 and 2. The ACE HDT can command the clutch to be disengaged or engaged through the vehicle control unit (VCU) to realize the series-hybrid mode and parallel-hybrid mode separately. Vehicles under urban conditions have low average speed (less than 45 km/h) and frequent active acceleration or deceleration, the working conditions of the engine and the working conditions of the vehicle road load can be decoupled completely by using the series-hybrid mode, so that the engine is enabled to stably work at its high-efficiency point, there are also many opportunities for the driving motor to recover energy through regenerative braking, and series hybrid vehicles have a more obvious fuel saving effect (more than 30%) than that of the traditional fuel vehicles; vehicles under high speed conditions have high average speed (more than 50 km/h) and few active acceleration or deceleration, the engine can stably work at its high-efficiency point even if it is directly and mechanically coupled with the driving wheel, and the parallel-hybrid mode is preferred at this time. From the perspectives of fuel saving and driving performance, the parallel-hybrid mode of vehicles directly driven by engines is better than the series-hybrid mode under high speed conditions. The power-split hybrid system represented by Toyota Prius has both series hybrid and parallel hybrid functions and gives consideration to optimization of both power and fuel saving of the vehicle. It has been the international benchmark of hybrid power for passenger vehicles for twenty years. However, it is difficult for the mechanical power-split hybrid system based on planetary gear to expand to large commercial vehicles with high performance to cost ratio subject to the current metal materials and production processes because the planetary gear, the core component of the power-split hybrid system, must withstand the force exerted simultaneously by the three ends, i.e., the engine, the generator and the driving motor, with a peak power of greater than 150 kW, there is no such large automotive-grade planetary gear commodity in the world, the design and mass production of new products will take several years, and the unit cost will remain high for a long time; even Toyota has not applied its unique power-split hybrid powertrain technology with single planetary gear unit to large commercial vehicles.

The present disclosure provides a duo-motor mixed hybrid powertrain architecture capable of time division switching of series or parallel-hybrid mode, see subsequent FIG. 1 and FIG. 2; the mixed hybrid powertrain architecture comprises: a generator (MG1) directly driven by the engine, used for converting chemical energy of vehicle fuel into electric energy (in the series-hybrid mode) or directly driven vehicles (in the parallel-hybrid mode); an electrical power split device (ePSD), configured as a power electronic network with three ports, wherein the first port of the ePSD is in bidirectional AC electric connection with the output end of the generator set; the second port of ePSD is in bidirectional AC electric connection with at least one driving motor (MG2); the third port of ePSD is DC-connected with at least one power-type battery pack bidirectionally and electrically and DC-connected with a brake resistor unidirectionally and electrically; an automatic transmission, with an output shaft connected with a driving axle of the vehicle bidirectionally and mechanically; a map unit, storing a 3D map in advance, containing the 3D information of longitude, latitude, longitudinal slope and the like of the road where the vehicle is running; at least one standard primary driving motor (MG2) in the hybrid P2 position, AC-connected with the second port of ePSD bidirectionally and electrically, with the output shaft of the driving motor connected with the input shaft of the automatic transmission bidirectionally and mechanically through a flexible coupling, wherein the primary driving motor (MG2) can be operated for converting the electric energy into the mechanical energy for driving the vehicle (driving mode), or converting the mechanical energy of the vehicle into the electric energy (regenerative braking mode), and charging the battery pack through the inverter in the second port of ePSD to recover energy, wherein the output shaft at the flywheel end of the engine is bidirectionally and mechanically connected with the mechanical shaft of the generator (MG1) in the hybrid P1 position, and the mechanical connection is either a single shaft with the same speed (coaxial connection) or parallel double shaft plus gear reducer coupling (parallel axis connection); the output shaft of the engine is also bidirectionally and mechanically connected with the primary driving motor (MG2) through a heavy duty clutch, and the mechanical connection is either a single shaft in a coaxial mode or parallel double shaft plus gear reducer coupling; the primary driving motor (MG2) is also bidirectionally and mechanically connected with the input shaft of the automatic transmission through a flexible coupling, and the output shaft of the transmission is mechanically connected with the driving axle of the vehicle; the vehicle further comprises: a vehicle control unit (VCU), working together with the AI Unit (AIU), and the vehicle control unit is used for dynamically controlling at least one of the engine, the generator, the clutch, the ePSD, the driving motor, the automatic transmission and the battery pack based on 3D map data in a vehicle-mounted Global Navigation Satellite System (GNSS) and/or the map unit (MU) independently.

This mixed hybrid system controls the pathway, amplitude and direction of two distinct power flow closed loops (mechanical or electric) at a 100-kW level among the engine, generator, battery pack and driving motor in the vehicle powertrain system dynamically through the coordination of the 100-kW level heavy duty clutch and the electrical power split device (ePSD), and switches between series-hybrid mode and parallel-hybrid mode of the vehicle by disengaging and engaging the clutch; the mixed hybrid architecture can effectively integrate the respective original advantages of series hybrid and parallel hybrid systems, overcome their respective original disadvantages, and optimize both the driving and fuel saving performance of the vehicle, and the performance-to-cost ratio of the mixed hybrid system is obviously higher than that of a duo-motor range-extended series hybrid system or a single-motor pure parallel hybrid system. The generator (MG1) is configured in the hybrid position P1 (behind the flywheel of the engine and in front of the clutch), the primary driving motor (MG2) is configured in the hybrid position P2 (behind the clutch and in front of the transmission), and the optional secondary driving motor (MG3) can be configured in either position P3 (behind the transmission, in front of the driving axle) or P4 (behind the driving axle, at the wheel side).

The ACE HDT of a duo-motor mixed hybrid architecture realizes the all-digital software defined powertrain with ePSD as the core. During the hardware design of ePSD three-port power electronic network, a margin shall be reserved for the function and performance, the plasticity of the product in a later stage is increased, and the product is continuously upgraded and evolved through the software remote update iteration (OTA) of each ACE HDT throughout its full operation life cycle. Relying on continuous software remote update (OTA), the actual performance of the powertrain of each ACE HDT is corrected continuously in a tailored manner based on big data plus artificial intelligence of cloud-vehicle interaction, that is, ensure that each ACE HDT can not only meet the emission regulation limits (RDE) at all times and places, but also realize the optimization of the fuel saving effect of the HDT and intelligent operation and maintenance (M&R) within the 700,000 km warranty period required by the emission regulations.

The ePSD can be configured as a three-port power electronic network which contains at least three unique power electronic functional modules with 100-kW level nominal power: the first port is internally connected with a bidirectional AC-DC converting module (also known as an inverter), the second port is internally connected with at least one bidirectional AC-DC converting module (also known as an inverter), and the third port is internally connected with at least one bidirectional Boost-Buck DC-DC converting module (also known as a chopper) or an unidirectional DC voltage-controlled switch module. The disclosure focuses on the main peripheral input/output characteristics of the ACE HDT ePSD and the core functions of the three power electronic (PE) functional modules (i.e., inverter, chopper and voltage-controlled switch) contained in the ePSD. The collection of various topological structures of circuits realizing the above three PE functional modules belongs to the scope of the present disclosure. The physical packaging and arrangement form of ePSD is that the above three PE functional modules are either packaged and arranged in a metal box in a centralized way, or separately packaged and arranged with the generator (MG1), the primary driving motor (MG2), the battery pack and the like in a decentralized way.

The above hybrid powertrain of the ACE HDT realizes two unique system architectures or working modes: series hybrid (clutch disengaged) or parallel hybrid (clutch engaged) respectively by controlling the on-off state of the clutch; many different operation modes can also be further divided under each system architecture. The vehicle control unit (VCU) commands the electromechanical Clutch-by-wire by electric control (rather than mechanically) to switch between series and parallel-hybrid modes accurately and smoothly. These are separately described below. To optimize both fuel saving and power of the vehicle, the parallel-hybrid mode is preferred under high speed conditions (smooth highway, at the average speed of above 50 km/h, infrequent active acceleration or braking) or any conditions (at any speed, slowdown function is required for safety) with long-distance downslope (the absolute value of longitudinal slope on the way is greater than 2.0 degrees, the slope length is greater than 5 km); and the series-hybrid mode is preferred under urban conditions (at the average speed of below 40 km/h, with frequent active acceleration or braking).

Firstly, in the series-hybrid mode, there is only an electric power flow loop and no mechanical power flow loop from the engine to the driving wheel, all the DC ports of the three functional modules inside the ePSD are connected to the DC bus junction point X bidirectionally and electrically, the product of the DC voltage and current time-varying functions at this junction point equals to the time-varying function of the electric power of the corresponding energy conversion device, and these power items satisfy the following three equations in real time:

$${P}_{V} = {η}_{dt} {P}_{MG 2} \qquad ( 2 - 1 )$$

$${P}_{MG 1} + {P}_{MG 2} - {P}_{BAT} = 0 \qquad ( 2 - 2 )$$

$${P}_{ICE} = - {P}_{MG 1} / {η}_{g} \qquad ( 2 - 3 )$$

All the above power items are 100-kW level time-varying functions, and it is assumed that the energy conversion factor for a round trip of the generator (MG1), battery pack and driving motor (MG2) can be approximated to be 100%; those of ordinary skills in the art can easily derive the corresponding formula when the actual conversion coefficient is less than 100%.

Whereas,
P_{MG1}>0, the driving power of the generator (MG1) (the load is the non-combustion idle speed of the engine or the non-combustion engine brake, electric energy is converted into mechanical energy); P_{MG1}<0, the gen-set power (electric power generation directly driven by the engine, mechanical energy is converted into electrical energy);
P_{MG2}>0, the driving power (electric energy is converted into mechanical energy) of the primary driving motor (MG2); P_{MG2}<0, the regenerative braking power (mechanical energy is converted into electric energy), the battery pack is charged and energy is recovered;
P_{BAT}>0, the total discharging power of all battery packs (chemical energy is converted into electric energy); P_{BAT}<0, the total charging power of all battery packs (electric energy is converted into chemical energy);
P_{ICE}>0, the effective output power of engine combustion (chemical energy is converted into mechanical energy); P_{ICE}<0, the equivalent mechanical load power (conversion between various mechanical energies) of engine non-combustion (fuel cut-off) drag or engine braking;

Preferred power parameter configuration principle of the above four energy conversion devices is as follows: P_{ICE-p}>=P_{MG2-m}>=P_{MG1-m}; P_{BAT-m}>P_{MG2-m}. Where P_{ICE-p} is the peak power (maximum continuous mechanical power) of the engine, P_{MG1-m}, P_{MG2-m} and P_{BAT-m} are the nominal (or rated) power (i.e., maximum continuous electric power) of the generator, driving motor and battery pack, respectively. The difference between the electric motor and the engine is that the motor can withstand short time overload, and its pulse peak power (10-second) can be more than 50% higher than the nominal power; the pulse peak power (10-second) of the power-type battery pack can be more than 100% higher than its nominal power. The system peak power (i.e., maximum continuous driving power of the vehicle) of the powertrain under the series-hybrid mode is completely determined by the P_{MG2-m} of the primary driving motor. An optional secondary driving motor (MG3) may be considered in order to improve the driving performance, fuel saving, and active safety of the vehicle; MG3 can be arranged in the hybrid position P3 (between the transmission output shaft and the first driving axle or the input shaft of the second driving axle); of course, the addition of a third motor will not only improve the vehicle driving performance, but also increase the system cost.

Under the series-hybrid mode, P_{MG2} is a dependent variable, which is directly proportional to the vehicle road-load power Pᵥ; the road-load power is an independent variable, which reflects the driving intention of the driver, and η_{dt} is the efficiency (a positive number less than 1.0) of the drivetrain system. P_{MG1} is another dependent variable, which is directly proportional to the net output power P_{ICE} of the engine, and η_{g} is the generator set efficiency (a positive number less than 1.0). The internal combustion engine (ICE) and the generator (MG1) can be actively set to operate at their high-efficiency operation points of specific speed and torque to ensure the highest combustion thermal efficiency (i.e., minimum specific fuel consumption, g/kWh) and minimized exhaust emission of the engine at this moment; under the unified command of the vehicle control unit (VCU), the three power electronics function modules inside the ePSD and related subsystems such as engine, generator, driving motor, automatic transmission and battery pack dynamically adjust the dependent variable P_{BAT} and perform peak load shifting on the road-load instantaneous power function according to the power management control strategy of the whole vehicle to satisfy the vehicle dynamics equation (1-1) in real time and achieve the optimal fuel saving effect under the condition of ensuring the driving performance and freight timeliness of the vehicle.

The equations (2-1), (2-2) and (2-3) can be recombined to obtain the following power balance equation (hereinafter referred to as the series-hybrid power balance equation or series-hybrid power equation) in the series-hybrid mode of the ACE HDT:

$${P}_{V} ( t ) = {η}_{dt} ( {η}_{g} {P}_{ICE} ( t ) + {P}_{BAT} ( t ) ) \qquad ( 2 - 4 )$$

The restrictive boundary conditions of the series-hybrid power balance equation (2-4) are as follows:
a) When the charge level of the battery pack is basically sufficient (i.e., high-efficiency zone; BLL<SoC<BUL),

P_{MG1-m}<max(|P_{V}(t)|)<P_{MG2-m} (2-4c1)
b) When the charge level of the battery pack is basically exhausted (i.e., SoC=<LRL),

max(|P_{V}(t)|)<P_{MG1-m}<P_{MG2-m} (2-4c2)

Where max(|P_{V}(t)|) is the maximum value that can be achieved by the absolute value |P_{V}(t)| of the road-load power time-varying function of the ACE HDT in the series-hybrid mode.

The preferred range of nominal voltage V_{bus0} of ePSD internal DC bus is between 600V and 800V. The third port of the ePSD can be externally DC-connected to at least one power-type battery pack bidirectionally and electrically, the nominal voltage of each battery pack V_{bat}<V_{bus0}, and the third port can also be externally DC-connected with a 100-kW level brake resistor R_{bk} equipped with a radiator unidirectionally and electrically as the effective electrical load for the driving motor to continue to maintain the non-friction retarder function of the vehicle through regenerative braking power generation when the ACE HDT runs on a long-downhill path and the battery pack is basically fully charged (SOC=URL). The above equation (2-2) assumes that the voltage-controlled switch module inside the ePSD is disconnected and the brake resistor does not work; if the module is on, the brake resistor is used as an electric load connected in parallel with the battery pack, and at this time, a brake resistor power item P_{BR} (a positive number) should also be added to the left side of equation (2-2); the series-hybrid power balance equation (2-4) should also be modified accordingly.

In some embodiments, the port III of ePSD can be connected with at least two battery pack combinations with different nominal voltages or consisting of cells with different electrochemical components bidirectionally and electrically, so they will have complementary advantages, which can not only improve the overall performance of the battery pack and increase the redundancy of the battery pack system, but also reduce the comprehensive cost of the battery pack, bringing multiple benefits to optimize the cost effectiveness of the complete ACE HDT. The battery pack of the ACE HDT is a Peak Power Source with ultra long cycle life, wide ambient temperature range and continuous high-rate partial state of charge (HRPSoC) operation. Its main function is to provide 100-kW level “peak load shifting” instantaneous electric power, combined with the electric power supplied by the generator set to jointly supply power to the driving motor and ensure that the driving motor can provide the required vehicle road-load power and satisfy the vehicle dynamics equation (1-1) in real time. The capacity of this power-type battery pack is generally within 100 kWh. This will be described in detail later. A HDT diesel engine with a large fuel tank has average explosive power but full endurance, while the power battery pack is more like a high-powered engine with a small fuel tank, with strong explosive power but severely insufficient endurance; when the engine is combined with the battery pack, they learn each other's good points for common progress, and both the total explosive power and endurance of the mixed hybrid powertrain are outstanding; the motor neither produces energy by itself nor stores energy, it is a high-efficiency energy converter without memory and hysteresis effect, and it allows electric energy and mechanical energy to be converted bidirectionally and mutually.

The capacity of the power-type battery pack of the ACE HDT is generally only dozens of kWh. Note that the dimension of the battery pack capacity involved in the present disclosure is kilowatt hour (kWh), rather than the ampere-hour (Ah) commonly used in the battery industry due to the different nominal voltages of various battery packs. If the ACE HDT under the series-hybrid mode encounters the special road condition of climbing a mountain (with the longitudinal slope of greater than 2.0 degrees) continuously for more than ten kilometers, it is likely that the battery pack charge is basically exhausted (SoC reaches LRL) before the vehicle reaches the summit of the mountain, and the climbing Gradeability of the series hybrid vehicle will depend entirely on the maximum continuous power P_{MG1-m} of the generator set at this moment. To maintain the same driving performance as the traditional HDT with engine under the extreme road condition of climbing a mountain, the series hybrid HDT must be equipped with the generator (MG1), driving motor (MG2) and corresponding inverter as options with the same power ratings as the peak power of the engine. At present, the peak powers (the maximum continuous power of the engine) of engines (displacement 11 L˜16 L) of all mainstream HDTs for long-haul freight in the world exceed 300 kW, and the peak power of a top-level 16 L engine even exceeds 450 kW. However, although the automotive-grade large motor and inverter with the nominal power (refers to the maximum continuous power of the motor) of more than 250 kW have been industrialized, they cannot be used with new energy passenger vehicles with a greater annual output by one order of magnitude due to higher voltage platform and power upper limit requirements and less annual consumption. As a result, the high-power motors and inverter products are expensive, and the cost will be high for a long time and difficult to fall. For example, the cost of an automotive-grade large motor (with inverter) with the nominal power of 300 kW is significantly higher than the total cost of two medium motors (with inverter) with the nominal power of 150 kW; as a result, the comprehensive cost of an range-extended series hybrid system with the high configuration of a high-power motor will be high for a long time and difficult to fall, resulting in poor cost effectiveness of the full vehicle. When the ACE HDT is going uphill or climbing a large upslope, from the perspective of driving performance and safety of the vehicle, the parallel-hybrid mode can be preferred, while the series-hybrid mode is the second-best choice.

Secondly, under the parallel-hybrid mode, the clutch is closed and locked, now the engine is directly coupled with the driving wheels, both the mechanical power flow loop and the electric power flow loop are closed, and the engine, generator (MG1) and driving motor (MG2) can drive separately or in a collaborative manner to satisfy the vehicle dynamics equation (1-1) in real time. All the DC ports of the three functional modules inside the ePSD are connected to the DC bus junction point X bidirectionally and electrically, the product of the DC voltage at this junction point and the current at each circuit branche is the time-varying function of the electric power of the corresponding energy conversion device, and these power items satisfy the following two power balance equations at all times:

$${P}_{V} = {η}_{dt} ( {P}_{ICE} + {P}_{MG 1} + {P}_{MG 2} ) \qquad ( 3 - 1 )$$

$${P}_{MG 1} + {P}_{MG 2} - {P}_{BAT} = 0 \qquad ( 3 - 2 )$$

The above equation (3-2) assumes that the voltage-controlled switch module inside the ePSD is disconnected and the brake resistor does not work; however, if the module is on, the brake resistor is used as an electric load connected in parallel with the battery pack, and at this time, a brake resistor power item P_{BR} (a positive number) should also be added to the left side of equation (3-2). The circuit between the brake resistor and the ePSD junction point X is disconnected most of the time unless the brake resistor is turned on when the ACE HDT runs on a long-downhill path and the battery pack is basically fully charged (SoC=URL) to sustain the non-friction retarder function.

The equations (3-1) and (3-2) can be recombined to obtain the following parallel-hybrid power balance equation:

$${P}_{V} ( t ) = {η}_{dt} ( {P}_{ICE} ( t ) + {P}_{BAT} ( t ) ) \qquad ( 3 - 3 )$$

The restrictive boundary conditions of the equation (3-3) are as follows:
1) When the charge level of the battery pack is basically sufficient (i.e., high-efficiency zone; BLL<SoC<BUL),

P_{ICE-p}<max(|P_{V}(t)|)<P_{ICE-p}+P_{MG2-m}+P_{MG1-m} (3-3c1)
2) When the charge level of the battery pack is basically exhausted (i.e., SoC=<LRL),

P_{MG2-m}<max(|P_{V}(t)|)<P_{ICE-p} (3-3c2)

The series-hybrid power balance equation (2-4) and the parallel-hybrid power balance equation (3-3) are compared with their corresponding two sets of restrictive boundary conditions. Apparently, the maximum road-load power that can be achieved in the parallel-hybrid mode is far greater than the maximum road-load power that can be achieved in the series-hybrid mode, and the driving performance in the parallel-hybrid mode is obviously superior to that in the series-hybrid mode provided that the battery pack is kept working in its high-efficiency zone; the parallel-hybrid mode of the ACE HDT is more fuel-efficient than the series-hybrid mode under the expressway working condition because the engine can drive the wheels directly in the parallel-hybrid mode to avoid multiple energy conversions between mechanical energy and electric energy; of course, it is also possible to make full use of the priori 3D data of the road within the electronic horizon in combination with the static configuration parameters and dynamic operational data of the ACE HDT to switch between series-hybrid mode and parallel-hybrid mode (i.e., intelligent Mode Switch; iMS) dynamically in a predictive and intelligent manner, and make full use of the characteristics and advantages of the two modes to further minimize the fuel consumption of the entire transportation event; similar to playing the Go game, we should not strive for the local gains and losses of each piece of the Go stone, but take a panoramic view of the situation on the game and strive for an overall victory in stone counts in the end. The ACE HDT has two mutually independent power sources, i.e., engine mechanical power source and battery pack electric power source; the generator (MG1) and the driving motor (MG2) can be regarded as high-efficiency passive energy converters for converting mechanical energy and electric energy bidirectionally with an efficiency of about 90%; according to the vehicle dynamics equation (1-1) and power balance equations (2-4) or (3-3), the core of the energy management strategy of the ACE HDT is to dynamically control the instantaneous mechanical power function of the engine and the instantaneous electric power function of the battery pack, especially through the novel and unique rectangular or non-rectangular pulse width modulation (PWM) or non-rectangular pulse amplitude modulation (PAM) digital control, in order to achieve the simultaneous optimization of the RDE energy saving and emission reduction of the vehicle under the condition of ensuring the driving performance and active safety of the vehicle.

There is a direct mechanical connection between the engine and the driving axle under the parallel-hybrid mode; the road-load power P_{V} is an independent variable, reflecting the driver's intention to control the vehicle (such as speed or acceleration), and its value is proportional to the product of the rotational speed of the vehicle driving wheel and the total driving torque at these driving wheels; when the vehicle is running normally (that is, when the vehicle driving wheels do not slip), the engine rotational speed is directly proportional to the driving wheel speed, therefore the engine speed is a dependent variable and cannot be set independently; however the engine torque is still an independent variable within the effective peak torque range at this speed, which can be set independently according to the vehicle energy management strategy; in other words, in the parallel-hybrid mode, the instantaneous power function of the engine is still an independent variable that can be controlled independently. From the perspective of fuel saving, the series-hybrid mode is preferred under urban working conditions (the average vehicle speed is less than 40 km/h, with frequent active acceleration or braking); while the parallel-hybrid mode is preferred under expressway working conditions (the average vehicle speed is greater than 50 km/h, with infrequent active acceleration or braking).

More than 90% of modern HDTs are equipped with diesel engines. The high efficiency zone (i.e., the zone with the minimum brake specific fuel consumption (BSFC)) of a diesel engine of a HDT is generally in the speed range of 1,000˜1,800 revolutions per minute (RPM), and the torque is within the maximum torque range of 50%˜95% (i.e., load rate of 50%˜95%); the brake specific fuel consumption (BSFC; g/kWh) of the engine outside its high-efficiency zone will rise significantly. Fuel consumption reduction through engine down-speed or down-size is a trend of the HDT industry in Europe and US in recent ten years, but these two fuel saving measures will negatively impact the vehicle driving performance under certain conditions. The two 100-kW level generator and driving motor can apply force together with the engine under the parallel-hybrid mode of the ACE HDT, and at this time, the driving performance of the vehicle is significantly better than that of all of the traditional HDTs with ICEs or the range-extended series hybrid HDTs (with peak power of less than 450 kW). A total peak driving power (i.e., maximum vehicle road-load power) of more than 500 kW can be maintained at the minute level and such ACE HDT has outstanding accelerating, overtaking and grading capacities.

When the mixed hybrid ACE HDT for long-haul freight encounters an extreme road condition of climbing a long slope or a high mountain for more than ten kilometers, the clutch may be engaged in advance by the fuel-saving robot to switch to the parallel-hybrid mode according to the onboard 3D map and vehicle positioning, then when the vehicle gets to the bottom of the mountain and is directly driven by the engine, thus eliminating multiple energy conversions from the engine to the driving wheel and improving the driving efficiency. If the battery pack charge is exhausted (SoC<LRL) before the ACE HDT reaches the summit, both the generator and the driving motor can be configured as no-load idling, and at this time, the driving performance of the vehicle depends entirely on the peak power (generally greater than 300 kW) of the engine when the vehicle continues to climb the mountain. Under the mixed hybrid architecture of the present disclosure, the configuration condition for the peak power parameter is: P_{ICE-p}>P_{MG2-m}>P_{MG1-m}, with P_{ICE-p}>300 kW, P_{MG2-m}<250 kW, P_{MG1-m}<200 kW as options. The cost of the motor and inverter can be significantly reduced if the motor nominal power is less than 200 kW. In addition to the extreme road condition of climbing a mountain, the ACE HDT enables the batter pack to operate in a Charge-Sustaining (CS) mode for a long time on flat and hilly lands. The state of charge (SOC) of the battery pack is maintained in an optimal working area (e.g., 30%˜70%) through the intelligent power switching (iPS) of the instantaneous output power of the engine combined with electronic horizon prior 3D road information. At this time, the engine and dual motors (MG1, MG2) can jointly apply force and drive the vehicle, and the maximum total driving power of the parallel-hybrid powertrain for a minute-level duration can be up to more than 500 kW. The driving performance, safety, fuel-saving and other aspects of the mixed hybrid HDT are significantly better than those of both the traditional HDT with ICE and the range-extended series hybrid HDT with high-end configuration parameters.

All the accumulated effective work applied by the ACE HDT to complete the entire freight event directly or indirectly comes from the time integration of the instantaneous engine output power function, i.e., the accumulated effective mechanical energy. One of the key elements to the fuel-saving strategy of the ACE HDT is to keep the engine running stably for a long time in the high-efficiency zone of its universal characteristic curve to the greatest extent possible and to minimize the engine running outside its high-efficiency zone, especially long-time operation in the low-load operation zone or idle operation point. SS (Stop Start) and Cylinder Deactivation (CDA) are the prior art energy saving and emission reduction technologies currently well known to people in the global automotive industry, both have been widely applied in the passenger vehicle industry; however, the disadvantages and limitations of SS and CDA are also common knowledge in the industry.

The HDTs for long-haul freight run under expressway working conditions most of the time and seldomly encounter traffic lights, the vehicle stop start frequency is very low, and the frequency of active acceleration or braking is also very low; the problem of noise, vibration and harshness (NVH) caused by the engine of HDT during the startup and shutdown switching is more prominent than that of passenger vehicles; when the HDT engine stops running, various mechanical auxiliary subsystems (such as cooling fan, water pump, fuel pump, air pump, power steering pump, A/C compressor and the like) on the HDT cannot obtain mechanical energy directly from the engine to maintain their normal operations; frequent stop-start of the engine can shorten the life of the engine, starting motor, clutch, lead-acid battery and other subsystems; little actual fuel-saving effect (less than 2%) of the start-stop technology for the HDT engine for long-haul freight application has been achieved; therefore, the engine SS technology in the prior art of energy saving and emission reduction for passenger vehicles is not applicable to the HDTs for long-haul freight, and so far the HDT engine SS technology has not been commercialized anywhere in the world. When the HDT for long-haul freight runs normally, the engine stably works in its high-efficiency zone for most of the time and works under its low-speed and low-load conditions for little time. Although the engine still operates at idle speed or low speed under low load when the road is congested or the HDT is waiting for trailer handling, the percentage of the total working time is small. If the engine of the HDT for long-haul freight uses the cylinder deactivation (CDA) technology, a set of complex variable valve actuation (VVA) devices must be added to the engine. By dynamically cutting off the fuel injection of some cylinders of the engine (for example, 6 cylinders changed to 3 cylinders) and constantly closing all inlet/exhaust valves of these non-combustion cylinders during a full engine cycle of four strokes, the actual load factor of the remaining combustion working cylinders is doubled. The primary purpose of CDA is to raise the diesel engine exhaust temperature under low load conditions, so that various catalysts inside the After-treatment System (ATS) operate in their respective high-efficiency zones (250° C. to 500° C.), and vehicle pollutant emissions are reduced greatly; the secondary purpose is actually to save fuel by adjusting the actual operating point of the working cylinder to the high-efficiency zone. The engine cylinder deactivation (CDA) technology significantly increases the structural complexity and cost of the engine, and reduces the reliability and life of the engine. For HDTs in long-haul freight application however, the CDA effect on overall energy saving and emission reduction is rather limited and its performance-to-cost ratio is not high. At the present time, the engine SS or CDA technology for HDTs has not been in volume commercial applications for long-haul freight worldwide.

The mechanical driving power loop and electric driving power loop of the ACE HDT can work independently or cooperatively to satisfy the vehicle dynamics equation (1-1), series-hybrid equation (2-4), or parallel-hybrid equation (3-3) in real time. The vehicle can run at full load and high speed for at least several minutes even if the engine of ACE HDT is in a non-combustion state and does not do positive work and the battery pack independently supplies electric power to the driving motor. The running process of the ACE HDT can be considered a time-varying system with high inertia. Several pulse modulation (PM) digital control strategies (for example, pulse-width modulation (PWM) or pulse-amplitude modulation (PAM)) can be used on the instantaneous output power of the engine of the ACE HDT based on the Impulse Equivalence Principle of a system with inertia. These strategies guarantee that the engine operates in the high-efficiency zone stably for a long time, and peak load shifting on the road-load power is performed through the power-type battery pack to satisfy the vehicle dynamics equation (1-1) and series-hybrid power equation (2-4) or parallel-hybrid power equation (3-3) in real time; in addition, these strategies can pave the way for optimizing the energy management of ACE HDTs by making full use of all kinds of digital signal processing technology, digital control technology, big-data technology and machine learning (ML) technology. The change speed or precision of the instantaneous power of the battery pack or the motor is more than one order of magnitude higher than that of the road-load instantaneous power or the engine instantaneous power; the instantaneous power function of the battery pack can absolutely follow the difference between the road-load instantaneous power function and the engine instantaneous power function quickly and accurately (ten-millisecond level delay or kilowatt level granularity) according to the series-hybrid power equation (2-4) or the parallel-hybrid power equation (3-3) to satisfy the vehicle dynamics equation (1-1) in real time; moreover, the NVH performance of the full ACE HDT during its operation is significantly better than that of the traditional diesel HDT. Analogous to the upgrading of the telephone or television industry from an analog communication system to a digital communication system, the present disclosure upgrades the control strategy of the engine instantaneous output power of the ACE HDT from the analog Amplitude Modulation (AM) electronic control (AEC for short) in the prior art to the digital control technology based on pulse-width modulation (PWM) or pulse-amplitude modulation (PAM), and provides cost-effective technical foundation, devices and methods for simultaneously optimizing the energy-saving and emission-reduction of the HDTs for long-haul freight by making full use of various emerging artificial intelligence, big-data and cloud computing (ABC) technologies. Two novel engine digital control technologies (intelligent Stop Start (iSS) and intelligent Power Switch (iPS)) that can not only overcome the original disadvantages of the existing engine Stop Start (SS) technology and Cylinder Deactivation (CDA) technology described above but also retain their respective original advantages for simultaneous optimization of the energy-saving and emission-reduction of the ACE HDT will be described below in detail.

The intelligent Stop Start (iSS) for the ACE HDT engine is firstly described. When the ACE HDT is running in the series-hybrid mode, the engine and the driving wheels of the vehicle are completely and mechanically decoupled, and the operating points (i.e., speed and torque) of the engine can be arbitrarily set regardless of the operating points of the vehicle. According to the configuration parameters of the engine, the maximum power point inside the “optimal operation zone” defined by the contours of the minimum specific fuel consumption in the universal characteristic curves (Fuel Map) of the engine can be selected as the “optimal operating point”; this operating point is generally near the maximum speed (i.e., base speed) corresponding to the peak torque of the engine, the torque load rate is between 80% and 90% (the ratio of actual torque to peak torque), and the output power value of the engine at the optimal operating point (defined as the “optimal output power”) is generally between 60% and 75% of its peak power value; the brake specific fuel consumption (BSFC; g/kWh) of the engine at this operating point is the smallest (i.e., the brake thermal efficiency (BTE) is the highest), and the temperature of exhaust gas at the engine exhaust port is also higher than 250° C. (light-off temperature), which is good for the efficient operation of the vehicle exhaust gas After-treatment System (ATS), minimizing the pollutant emissions and extending the effective life of the after-treatment system in the real driving environment (RDE). The optimal output power of the engine can be less than the nominal power of the generator (MG1); the peak power of the engine is obviously greater than its optimal output power, but the specific fuel consumption of the engine is not the minimum at this time. In addition, the engine can also stably operate at a special operating point with zero fuel consumption and zero emission, i.e. “Non-Combustion Idle” (NCI) point. The speed value of this point can be set between 450 RPM and 750 RPM to ensure that all auxiliary subsystems on the ACE HDT that must obtain mechanical energy directly from the engine can operate normally; at this time, the engine performs fuel cut-off in all its cylinders, the engine torque becomes negative, the engine needs to be dragged by the generator in the driving mode, and the engine power at this operating point is defined as “Non-Combustion Idle Power”, which is negative; the absolute value of this engine power is less than 10% of the peak power of the engine; at this time, the engine acts as a one-input multiple-output reverse transmission, transmits the 10 kW-level mechanical power by the generator in the driving mode to every auxiliary subsystem of the vehicle that requires continuous mechanical energy supply, and enables these auxiliary subsystems to operate normally. Obviously, the engine has zero fuel consumption and zero pollutant emissions at the non-combustion idle operating point, but electric power (0.1-kWh level) will be consumed. The optimal output power of the engine in the iSS mode is also called the high-state equivalent power (high state power for short); the Non-Combustion Idle Power is also called the low-state equivalent power (low state power for short).

For a basic engine without the variable valve actuation (VVA) function, the intake stroke and exhaust stroke will generate Pumping Loss respectively within a full engine cycle of four strokes at the non-combustion idle point, the compression stroke and power stroke get benefits from one contraction and one extension of the in-cylinder compressed air spring, and there is basically no Pumping Loss; the mechanical losses (including friction loss and pumping loss) of the engine itself are positively related to its rotational speed. The engine at the non-combustion idle point acts as a mechanical load, the non-combustion idle power is basically less than 20 kW, the generator with a 100-kW level nominal power can easily drag of engine in low state, and the electricity consumption within a minute-level time is very limited (100 watt-hour level). For an advanced engine with the variable valve actuation (VVA) function, the inlet/exhaust valves of all the cylinders can be controlled to be constantly closed or constantly opened within a full engine cycle of four strokes when all the cylinders are deactivated (i.e., fuel cut-off in non-combustion mode), so that the pumping loss is substantially reduced, thus further reducing the electric power consumption during non-combustion idling.

The intelligent Stop Start (iSS) technology means that the vehicle control unit (VCU) commands the engine to stably operate at either the “non-combustion idle point” or the “optimal operating point” or repeatedly and smoothly switch between these two operating points according to the system configuration parameters, dynamic driving data of the vehicle, electronic horizon 3D road information and machine learning (AI) algorithm focusing on simultaneous optimization of energy saving and emission reduction to apply asymmetric bipolar rectangular pulse-width modulation (PWM) on the time-varying function of the engine's instantaneous output power; the generator set (engine+generator) and the battery pack jointly supply electric power to the driving motor to continuously satisfy the vehicle dynamics equation (1-1) and the series-hybrid power balance equation (2-4) in real time, and optimize the energy saving and emission reduction of the vehicle under the condition of ensuring the driving performance and active safety of vehicle driving. The cycle of the PWM pulse sequence is at sub-minute level, the duty cycle (kₛ) is defined as the ratio (%) of the operating time at the optimal operating point to the PWM pulse cycle, the duty cycle is continuously adjustable between 0 and 1, and the proportion of the operating time at the non-combustion idle point is equal to 1−kₛ; the minute-level time rolling average power (i.e., the impulse of PWM; referred to as the “average power” for short) of the engine can be continuously adjustable between the non-combustion idle power and the optimal output power by dynamically adjusting the duty cycle kₛ. The preferred implementation mode of dynamic switching control of engine working conditions is as follows: when the engine is switched from the non-combustion idle point to the optimal operating point, the non-combustion engine is driven by the generator (MG1) at first, the engine speed is increased from that of the idle point to that of the optimal operating point, then the engine starts fuel injection and combustion to do work; the engine torque is increased rapidly (for a sub-second level transition duration) on a fixed speed vertical line in the universal characteristic curves (Fuel Map), and the engine operates stably after reaching the optimal operating point; during reverse switching, the engine cuts off the fuel injection at the optimal operating point at first and enters into a non-combustion driven state (applying negative work), the torque is rapidly reduced to a negative number at first at a constant speed at the optimal operating point (for a sub-second level transition duration), then the engine is driven to slow down by the generator to the non-combustion idle point and work steadily; obviously, in the iSS control mode, the instantaneous power function of the engine is converted from the analog time-varying function of the prior art into an asymmetrical bipolar rectangular PWM pulse time sequence; the mode of instantaneous control over the engine is converted from the traditional analog control of the global surface working condition to the novel and unique digital control of the working condition at two points. The series hybrid ACE HDT is electrically driven, and the 10 kWh-level power-type battery pack can support the running of the driving motor (MG2) under full load (i.e., nominal power) independently for a short time (at a minute level); the response speed of the instantaneous charge-discharge power of the battery pack is one order of magnitude higher than that of the instantaneous power of the engine, its instantaneous power amplitude is continuously adjustable between the negative nominal power and the positive nominal power of the battery pack, the instantaneous power function is fully capable to follow the algebraic difference between the road-load instantaneous power function and the engine instantaneous power function quickly and accurately (in ten-millisecond level delay and kilowatt level granularity) to satisfy the series-hybrid power balance equation (2-4) in real time; the series hybrid ACE HDT can not only ensure that the instantaneous dynamic performance of the full vehicle is not affected by the dynamic switching of engine operating points to satisfy the vehicle dynamics equation (1-1) in real time, but also ensure that the Noise, Vibration and Harshness (NVH) performance of the full vehicle during hybrid powertrain operation is superior to that of the traditional HDT with an internal combustion engine; to optimize the NVH performance of the full vehicle, the transition time of engine operating point switching cannot be too short, and the transition time at the second level is preferred. For the ACE HDT, the engine operating in a non-combustion mode (applying negative work) is the mechanical load of the generator in the driving mode, while the generator in the power generation mode is the mechanical load of the engine operating normally (during combustion to do work). When the engine works at the optimal operating point, the output power of the generator (MG1) is called the “optimal gen-set power” (a positive number), this value is usually higher than 85% of the nominal power of the generator, and the upper limit is the nominal power of the generator; when the engine is working at the non-combustion idle point, the power consumption of the generator (MG1) is called “non-combustion consumption power” (a negative number), and its absolute value is less than 20% of the nominal power of the generator; in other words, in the series-hybrid iSS control mode, by dynamically adjusting the PWM duty cycle kₛ, the minute-level rolling time average value (referred to as the average genset power) of the PWM pulse time sequence of the electric power of the gen-set (referring to engine+generator) can be achieved, and it is continuously adjustable between the non-combustion consumption power and the optimal gen-set power.

Essentially, the Intelligent Stop Start (iSS) technology extremely simplifies the actual operation area of the engine of the ACE HDT in the series-hybrid mode into a single optimal operating point (fixed speed and torque; minimum specific fuel consumption). The minute-level average output mechanical power of the engine and the average gen-set power of the corresponding generator set are dynamically and continuously regulated by performing the asymmetric bipolar rectangular pulse-width modulation (PWM) control on the constant output mechanical power generated by engine operation at the optimal operating point. The battery pack is controlled to work steadily in one of the three working modes of Charge Sustaining (CS), Charge Depleting (CD) and Charge-Increasing (CI) or switch smoothly among the three working modes according to the three different cases that the difference value between the minute level road-load average power and the average gen-set power is basically zero, significantly greater than zero, and significantly less than zero; by predicting the time-varying function of road-load average power within the electronic horizon (at a hour level or 100 km level) of the vehicle dynamically and accurately (with sub-second level delay and kW-level granularity), the battery pack is assured to work in its high-efficiency zone (BLL<SoC<BUL) to the greatest extent possible to avoid the adverse situation that the driving performance of the ACE HDT is degraded because the charge level of the battery pack is basically exhausted (SoC=<LRL), or the adverse situation that it is impossible to recover the regenerative braking charge level effectively because the battery pack is basically fully charged (SoC>=URL); the generator set (engine+generator) and the battery pack can jointly supply electric power to ensure that the driving motor can meet the vehicle road-load power requirement in real time; the vehicle energy management is optimized to realize energy saving and emission reduction under the condition of ensuring the driving performance of the ACE HDT. The most concise and effective PWM control strategy is as follows: the non-combustion idle point and the optimal operating point of the engine are predetermined and fixed, and a continuously adjustable minute-level average gen-set power of the generator set is realized by dynamically adjusting the duty cycle kₛ of the instantaneous power bipolar constant amplitude pulse sequence (PWM) of the engine. Of course, the intelligent Stop Start (iSS) function can also be expanded to other technical solutions for dynamic switching between the adjustable non-combustion idle point of the engine and multiple high-efficiency operating points (i.e., different optimal condition powers), but these adjustable multi-operating point iSS technical solutions are more complex, and their performance-to-cost ratio is not as good as that of the above-mentioned iSS technical solution with two fixed operating points. Since the regulating speed and accuracy of the speed and torque of the driving motor are one order of magnitude faster than that of the transmission, if the vehicle needs to shift gears in the series-hybrid iSS mode, the driving motor (MG2) can complete the instantaneous torque interruption and fast speed synchronization easily to make the transmission shift gears smoothly even if the flexible coupling is not a clutch, and the gear shifting operation of the entire transmission is independent of the working condition of the engine.

Turbochargers are widely used with modern HDT diesel engines; the intelligent Stop Start (iSS) technology is applicable not only to the basic engine without the variable valve actuation (VVA) function and with a fixed geometry turbocharger (FGT), but also to the advanced engine with the variable valve actuation (VVA) function or a variable geometry turbocharger (VGT). Although there are obvious differences between a basic engine and an advanced engine in the high-efficiency zone (size or shape) of the universal characteristic curve, dynamic characteristics (e.g., Turbo Lag and the like), price and other aspects, the minimum brake specific fuel consumption (BSFC) or optimal output power of these two engines are basically the same; the ACE HDT equipped with the basic engine can achieve the same energy saving and emission reduction effect compared with vehicles equipped with advanced engines under various operating conditions and applications with the help of the series hybrid intelligent Stop Start (iSS) technology for the ACE HDT; in other words, the ACE HDT greatly reduces the requirements for the technical sophistication and global performance of the engine compared with the traditional diesel HDT, so that the engine is no longer the bottleneck in the driving performance or fuel consumption of the ACE HDT. The new China BG-6 ACE HDT can still optimize both the vehicle driving performance and fuel economy in the future under the condition of ensuring that the real driving environment (RDE) emission meets the standard stably within the extremely challenging 700,000 km useful life for the HDT even though the new China BG-6 ACE HDT is configured with a low-cost domestic basic engine. The optimal output power of most engines is between 55% and 85% of its peak power, and the brake specific fuel consumption (BSFC in g/kWh) of the engine at full load (100%) or light load (under 30%) is significantly higher than this minimum value. In the universal characteristic curves of engines, the contours of constant brake specific fuel consumption (g/kWh) are a plurality of mutually non-intersecting irregular curves or loops. The area contained in the global minimum contour of BSFC is called the optimal operation zone, commonly known as the “Sweet Spot” of the engine, in which every point is an optimal operating point (specific speed and torque); the area contained in the contour with a specific fuel consumption equal to 105% of the minimum value can be called the high efficiency operating condition range (referred to as the “high efficiency zone”). Of course, the area of the high-efficiency zone is larger than and completely includes the Sweet Spot. The speed corresponding to the Sweet Spot of most HDT engines is in the range of 95% to 125% of its base speed (referring to the speed at the peak torque point), and the corresponding torque is between 65% and 90% of its peak torque. The area of the high-efficiency zone of the modern HDT engine (diesel or natural gas) base model is relatively small, while the area of the high efficiency zone of an advanced model is comparatively larger. The minimum specific fuel consumption of both engines at the Sweet Spot is equal to 186 g/kWh. In order to continuously reduce the RDE fuel consumption (L/100 km), the general trend of HDT engine research and development in Europe and US in recent decade is Down-Size or Down-Speeding. The base speed of the engine (i.e., speed at the peak torque point) decreases from 1,200 RPM to below 1,100 RPM year by year, and even approaches 1,000 RPM. The ACE HDT can effectively decouple the full vehicle operating condition from the engine operating condition in the series-hybrid mode regardless of the specific vehicle application. Under the condition of ensuring the driving performance of the full vehicle, the ACE HDT allows the engine to be within its high-efficiency zone for more than 95% of the time to avoid the engine running at full power load or low power load to the greatest extent and achieve the beneficial effect of optimized energy saving and emission reduction.

The intelligent Power Switching (iPS) control technology is described below. When the ACE HDT operates in the parallel-hybrid mode, the vehicle is driven by the engine directly, the engine speed is completely determined by the transmission gear position and vehicle speed and varies with time, therefore the engine speed is a dependent variable, but the engine torque is still an independent variable that can be adjusted independently and dynamically; at this time, the intelligent Stop Start (iSS) control technology cannot be applied to the engine, and the intelligent power switching (iPS) control technology must be used. Operation in a parallel-hybrid mode is preferred when the ACE HDT is running normally on an expressway (the average vehicle running speed is higher than 50 km/h). The average road-load power of the ACE HDT is basically greater than 35% of the engine peak power in road sections without long slopes, and its operating (working) condition is the medium-to-high load condition for most of the time; the instantaneous speed of the vehicle changes slowly with time in a narrow speed band, the speed change generally fluctuates within the range of plus or minus 10% of the average vehicle speed, therefore the change rate of the engine speed of the vehicle is also less than 10%; the absolute value of the vehicle acceleration is basically less than 5% of the gravitational acceleration g (i.e., 0.5 m/s²), and the instantaneous output torque of the engine is still adjustable independently in a wide range at this time. The automatic gear shifting control strategy of the ACE HDT transmission enables the engine to always run stably in a narrow range (high-efficiency zone) near the base speed (i.e., the speed at the peak torque point) under the expressway working condition, for example, between 1,100 RPM and 1,600 RPM. At this time, both the speed of the generator (MG1) and the speed of the driving motor (MG2) are proportional to the speed of the engine, and the instantaneous torques of the two motors are still separately and independently adjustable in a wide range. Bipolar non-rectangular pulse-width modulation (PWM) or non-constant amplitude (i.e., non-rectangular) pulse-amplitude modulation (PAM) can be performed on the instantaneous mechanical power of the engine or the instantaneous electric power of the power-type battery pack (during charging or discharging) respectively to satisfy the vehicle dynamics equation (1-1) and the parallel-hybrid power balance equation (3-3) in real time. Moreover, the average power function value (i.e., the rolling average value at the minute level) of the engine can also be regulated dynamically and continuously by adjusting the duty cycle of the PWM pulse sequence, so that the battery pack operates stably in one of the three working modes of Charge-Sustaining (CS), Charge Depleting (CD) and Charge-Increasing (CI) or smoothly switches among the three modes.

In the parallel-hybrid mode, the pulse modulation (PM; containing PWM or PAM) is performed on the instantaneous output power of the ACE HDT engine to realize the “intelligent Power Switching” (iPS) control function. The specific technical measures are as follows: bipolar non-rectangular pulse-width modulation (PWM) is performed on the instantaneous output power function of the engine, the cycle of the pulse sequence is at sub-minute level, the bipolar non-rectangular (i.e., non-constant amplitude) PWM pulse sequence can be divided into a high-state operating condition and a low-state operating condition in the same cycle, the low-state condition can be pre-determined as a specific operating condition line (the power is a negative number that fluctuates in a small range) when the engine is dragged without combustion, the torque range of this operating condition line is determined by a set of all subsystems on the vehicle that must obtain mechanical energy continuously from the engine in order to work normally, and the speed range is determined by the speed time function of ACE HDT and the transmission gear position; the high-state condition can be pre-determined as another specific operating condition line (the power is a positive number with small fluctuation) formed by connecting multiple operating points with greater power values in the minimum value range (i.e., in the Sweet Spot of the engine) of the brake specific fuel consumption (BSFC) within the fluctuation range of engine speed in the pulse cycle, the duty cycle kₚ is defined as the ratio of the high-state operating time to the PWM pulse sequence cycle, which is arbitrarily adjustable between 0 and 1, while the proportion of low-state operating time is equal to 1−kₚ; since the engine speed is subject to the vehicle speed, there is a small range of amplitude fluctuations in each PWM pulse cycle (at a sub-minute level), and therefore both the high-state pulse and low-state pulse are non-constant amplitude (i.e., non-rectangular) pulses. In the series hybrid intelligent Stop Start (iSS) control mode, the time function of the instantaneous output power of the engine is a bipolar rectangular PWM pulse sequence, the non-combustion consumed power and the optimal gen-set power can be set as constants directly regardless of the dynamic conditions of the vehicle; however, in the parallel hybrid intelligent Power Switching (iPS) control mode, the time function of the instantaneous output power of the engine is a bipolar non-rectangular PWM pulse sequence. The specific shapes of the high-state pulse and low-state pulse are highly related to the dynamic conditions of the vehicle, and the top amplitude curve of PWM pulse will fluctuate slowly in a small range over time. In the parallel-hybrid iPS mode, a power value with the same integral area (i.e., equal impulse) as the full high-state pulse sequence (i.e., with a duty cycle of 1.0) in one cycle is defined as “high-state equivalent power”, which is a positive number greater than 50% of the engine peak power; a power value with the same integral area (i.e., equal impulse) as the full low-state pulse sequence (i.e., with a duty cycle of 0) in one cycle is defined as “low-state equivalent power”, which is a negative number whose absolute value is less than 20% of the engine peak power; in the iPS mode, the minute-level average output power of the engine is arbitrarily adjustable between the low-state equivalent power and the high-state equivalent power and changes slowly in time. According to the above-mentioned PWM control solution, the engine is allowed to switch between the high-state operating condition line and low-state power consumption curve in the high-efficiency zone of the universal characteristic curve of the engine in the vertical direction (i.e., constant speed, variable torque) smoothly back and forth through dynamic control of the fuel injection quantity (fuel cutoff or fuel injection) of the engine, and the battery pack is allowed to work steadily in one of the three operating modes of Charge Sustaining (CS), Charge Depleting (CD) and Charge-Increasing (CI) or switch smoothly among the three operating modes through dynamic adjustment of the minute level average value of the engine output power in order to avoid the adverse situation that the driving performance of ACE HDT is degraded because the charge level of the battery pack is basically exhausted (SoC=<LRL), or the adverse situation that it is impossible to recover energy from the battery pack because the battery pack is basically fully charged (SoC>=URL); then the engine, generator (MG1) and driving motor (MG2) provide collaborative driving to satisfy the vehicle dynamics equation (1-1) and the parallel-hybrid power balance equation (3-3) in real time.

In the parallel-hybrid mode of the ACE HDT, the engine, generator (MG1), and driving motor (MG2) are coupled with the driving wheels directly and mechanically. When the transmission gear is fixed, the speeds of the engine, generator (MG1), and driving motor (MG2) are completely controlled by the independent variable of vehicle speed time varying function, and these time-varying speed functions are dependent variables with second-level slow slight changes; the torques of the engine, generator (MG1), and driving motor (MG2) are independent variables of the time-varying functions with 100-millisecond level rapid substantial changes; the instantaneous torques of the engine, generator (MG1), and driving motor (MG2) can be combined directly; the peak value of the total driving torque at the transmission input shaft of the full vehicle can exceed 4,000 NM, which is significantly higher than the peak torque of the largest 16 L diesel engine of HDT for long-haul freight (less than 2,800 NM) in the world; so the parallel hybrid ACE HDT can work at the highest gear position of the transmission stably for a long time under the expressway working condition and rarely shift down due to insufficient propulsion peak torque when speeding up to overtake or running uphill. If sudden gear shifting, especially shift-down, is required during operation of the parallel hybrid ACE HDT, because the adjustment of the torque or speed of the duo motors (MG1 and MG2) is nearly ten times faster than that of the engine, the engine fuel injection can be cut off at first at the moment of shifting, the engine enters the non-combustion low-state operating condition line, both motors (MG1 and MG2) work in the driving mode (or traction mode) to drive both the non-combustion engine and the vehicle, shifting to a new gear can be completed after variable speed synchronization within a second-level period of time without disengaging the clutch, and then the engine can restart fuel injection and combustion to do work and enters the high-state operating condition line; no obvious driving torque interruption will occur to the ACE HDT during shifting in the parallel-hybrid mode, the noticeable sense of power interruption during transmission shifting (especially during shift-down) of the traditional HDT with an internal combustion engine is eliminated, and the NVH performance of the full vehicle is improved. In other words, in the parallel-hybrid iPS mode, if shifting is required for the ACE HDT, the whole shifting operation must be completed in the low-state part of the engine PWM pulse sequence (at a second level). Unlike the shifting operation (especially the shift-down operation) of the traditional HDT with an internal combustion engine, the duo-motors (MG1 and MG2) provide collaborative driving at this moment without disengaging the clutch to realize instantaneous driving torque interruption and variable speed synchronization of the transmission input shaft and complete the shifting operation; it can not only reduce clutch wear and prolong its life, but also improve the driving performance and NVH performance of the full vehicle during shifting. The parallel-hybrid mode is preferred when the ACE HDT is running normally on the expressway at the average speed of higher than 50 km/h with seldom active acceleration or braking. The output power of the engine in the parallel-hybrid mode is mainly used to directly drive the vehicle. The generator and the driving motor can work in the same mode while being equivalent to a composition motor with higher peak torque and power, or they can obtain electric energy from the battery pack to drive the vehicle, or charge the battery pack and recover energy through regenerative braking. When the traditional HDT with internal combustion engine runs normally on a expressway, the actual shifting frequency of the transmission mainly depends on the actual road longitudinal slope function, full vehicle configuration parameters, vehicle driving conditions, and peak power or torque of vehicle driving. The larger the engine displacement is, the more sufficient the torque or power reserve is, and the lower the gear shifting frequency is; in the parallel-hybrid mode of the ACE HDT, the vehicle driving torques or powers of the engine, generator, and driving motor can be combined, and the total driving torque (greater than 3,500 NM) or power (greater than 450 kW) of the engine, generator, and driving motor is significantly greater than the driving torque or power of the HDT with a 16 L diesel engine and high-end configuration parameters currently on the market. Therefore, the gear shifting frequency of the ACE HDT during parallel hybrid operation is significantly lower than that of all traditional HDTs with an internal combustion engine. It can not only improve the driving performance and NVH performance of the vehicle, but also prolong the life of the automatic shifting mechanism of the transmission; under some special road conditions, the generator and driving motor can also work in the opposite modes, one is the power generation mode, and the other is the driving mode. Of course, the intelligent Power Switching (iPS) function can also be realized through other technical measures, such as non-rectangular pulse-amplitude modulation (PAM) control over the instantaneous output power of the engine; ordinary technicians in the industry can draw inferences from one instance without creativity and think of a variety of equivalent technical solutions or measures of pulse modulation (PM) of instantaneous output power of the engine with the help of mature modern digital communication technology or digital signal processing technology; however, the system simplicity, overall cost effectiveness and other aspects of these technical solutions or measures are not as good as those of the above technical solution of PWM. The fuel-saving robot of ACE HDT can also measure and calculate (with sub-second level delay and kW-level granularity) the road-load instantaneous power time-varying function (i.e., road-load instantaneous power) or road-load minute-level rolling average power time-varying function (i.e., road-load average power) of the vehicle on the expressway during non-congested hours in a hour-level period of time in the future in real time according to the 3D information (including longitude/latitude/longitudinal slope) of the road within the range of hundreds of kilometers of the electronic horizon, vehicle configuration parameters and dynamic operating data, and the predictive adaptive cruise control (PACC) sub-mode selected by the driver, and implement parallel hybrid intelligent Power Switching (iPS) on the engine. The engine average power function value (i.e., minute-level rolling average function value) can be adjusted continuously through dynamic control of the duty cycle kₚ of the PWM sequence, so that the power-type battery pack works stably in one of the three working modes of Charge-Sustaining (CS) (the average power of the engine is basically equal to the average power of the road-load), Charge Depleting (CD) (the average power of the engine is significantly less than the average power of the road-load) and Charge-Increasing (CI) (the average power of the engine is significantly greater than the average power of the road-load) or switches smoothly among these three modes; the battery pack is charged and discharged just in time (JIT) to ensure that the battery pack works in the high-efficiency zone (BLL<SoC<BUL) to the greatest extent possible and strive to avoid the battery pack entering the extreme conditions of basically empty (SoC=<LRL) or fully charged (SoC>=URL); the engine, generator (MG1), and driving motor (MG2) provide collaborative driving to satisfy the vehicle dynamics equation (1-1) and the parallel-hybrid power balance equation (3-3) in real time in order to achieve the simultaneous optimization of vehicle energy saving and emission reduction.

With the ACE HDT operating in the parallel-hybrid mode, the total driving torques of the motor, generator, and driving motor can be combined linearly at the transmission input shaft, and the total vehicle propulsion peak torque can easily surpass 4,000 NM. At present, the peak torque of a 16 L HDT engine with the best configuration parameters of a mass-produced HDT for long-haul freight in the world is most likely less than 2,600 NM, therefore the maximum input torque of the transmission of the HDT is also less than 2,600 NM, and the maximum torque at the transmission input shaft is mainly subject to the original design mechanical strength and life of the transmission, driving shaft, or driving axle. In other words, the parallel hybrid ACE HDT can produce more than 450 kW total driving power (the sum of mechanical power and electric power) in an explosive manner within a minute-level short period of time even if it is only configured with an affordable and attractive basic engine (for example, with a displacement of 11 L to 13 L, a peak power of greater than 280 kW, and a peak torque of less than 2,500 NM), a mainstream cost effective 100-kW level nominal power generator (MG1) and driving motor (MG2). With vehicle total peak torque exceeding 3,500 NM, the driving performance of the parallel hybrid ACE HDT is significantly superior to that of the traditional HDT equipped with a 16 L engine (which have been mass-produced in the global market) and the best configuration parameters. At present, the maximum input torques of most of the mass-produced transmissions of commercial HDTs for long-haul freight are less than 2,500 NM; the design of the existing HDT transmissions or other transmission subsystems should be redesigned in mechanical strength and durability life in order to adapt to the ACE HDT; the input peak torque of the transmission shall be increased to more than 3,000 NM, and its gear number can also be reduced from the range of 12 to 16 down to 6 to 8.

Generally, the existing control technology of hybrid vehicles includes the following seven operational sub-modes (also known as control sub-modes); a certain mode is applicable to either series hybrid or parallel hybrid unless otherwise specified; the switching among these control sub-modes is infrequent, and the average switching interval is generally in the range of the minute level to the 10-minute level.

1) Pure battery driving mode: At this moment, the engine does not operate, and the battery pack works in the Charge Depleting (CD) mode and supplies electric power to the driving motor to meet the vehicle road-load power requirements. At this time, the average engine power is significantly lower than the average road-load power.

2) Pure engine driving mode: At this moment, the vehicle is driven by the engine entirely and directly (parallel-hybrid mode) or driven by the generator indirectly (series-hybrid mode), and the battery pack is basically not involved in the vehicle propulsion (i.e., without discharging; with regenerative braking charging), which belongs to a Charge-Sustaining (CS) mode. The engine power is essentially equal to the road-load power (instantaneous power or average power).

3) Hybrid driving mode: The engine, generator, driving motor, and battery pack drive the vehicle collaboratively. At this moment, the average engine power is basically the same as that of the average road-load power; the battery pack performs peak load shifting on the instantaneous road-load power through high-rate charging and discharging and works in the Charge-Sustaining (CS) mode.

4) Engine driving plus charging mode: In addition to fully meeting the road-load power requirement, the surplus power of the engine charges the battery pack through the generator, and the battery pack works in the Charge-Sustaining (CS) or Charge-Increasing (CI) mode. At this time, the average engine power is significantly higher than the average road-load power.

5) Regenerative braking mode: At this time, the road-load power is a negative number (for going downhill or braking), the engine does not operate, and the driving motor charges the battery pack through regenerative braking power generation to recover the kinetic energy or potential energy of the vehicle and decelerate the vehicle. At this time, the battery pack works in the Charge-Sustaining (CS) or Charge-Increasing (CI) mode. The average engine power is significantly higher than the average road-load power.

6) Parked charging mode: At this time, the vehicle parks and the road-load power is zero. The engine power is used to charge the battery pack completely through the generator, and the driving motor does not operate. At this time, the battery pack works in the Charge-Increasing (CI) mode. The average engine power is significantly higher than the average road-load power.

7) Hybrid charging mode: At this time, the road-load power is a negative number (for going downhill or braking), the engine charges the battery pack through the generator, and the battery pack is also charged by the driving motor through regenerative braking. At this time, the battery pack works in the Charge-Increasing (CI) mode. The average engine power is significantly higher than the average road-load power.

The operational sub-modes of the ACE HDT (under series-hybrid iSS or parallel-hybrid iPS control) in the present disclosure are significantly different from that of the prior art technology set of the above-mentioned hybrid vehicle. Through the series-hybrid intelligent Stop Start (iSS) control technology or the parallel-hybrid intelligent Power Switching (iPS) control technology, various analog electronic control technical measures of the other six control sub-modes except the parked charging mode in the above-mentioned existing hybrid vehicle control technology set on the mechanical power flow or electric power flow of a hybrid vehicle are organically fused and digitized within a pulse cycle (sub-minute level) of the instantaneous engine power pulse-width modulation (PWM) pulse sequence; through the pulse modulation (PM) control, especially the series-hybrid iSS bipolar rectangular pulse-width modulation (PWM) control or the parallel-hybrid iPS bipolar non-rectangular PWM control of the instantaneous engine power of the ACE HDT, the technical problem of analog control over the mechanical power flow or electric power flow of a hybrid vehicle in operation is transformed into an equivalent technical problem of digital control through pulse modulation (PM), the worldwide hard technical problem of simultaneous optimization of RDE energy saving and emission reduction of HDTs is solved with a novel technical solution, so that the three key metrics of full vehicle driving performance, real driving environment (RDE) pollutant emissions (NOx and PM), and RDE fuel consumption (L/100 km) of the ACE HDT are significantly improved over the existing HDTs with internal combustion engines, and the overall fuel saving ratio (i.e., fuel consumption reduction ratio) can be up to 30%; analogous to the implementation of frequency control or vector control for the upgrading of modern AC motors, where the AC-DC-AC electric energy conversions plus computer control are implemented by using the electric and electronic power modules based on PWM control technology so that significant improvement is achieved in motor performance and power saving compared with the fixed frequency control technology of the traditional AC motor. The distinctive technical features of the above-mentioned seven control sub-modes and other technical solutions of the engine Stop Start (SS) technology of traditional fuel-based vehicles, engine Cylinder Deactivation (CDA) and hybrid vehicles in a set of the prior art include that: whether part or all of the engine cylinders perform combustion working (CDA), whether the engine operates by rotation (SS), and the switching among different sub-modes is highly correlated with the instantaneous vehicle road-load power; whereas the technical solutions of engine pulse modulation (PM) control of ACE HDT of the present disclosure includes the series-hybrid intelligent Stop Start (iSS), parallel-hybrid intelligent Power Switching (iPS), and intelligent Mode Switch (iMS); the distinctive technical features include that: the engine always rotates (high-state or low-state), and all the cylinders of the engine either perform combustion operation to do positive work (high-state) or perform non-combustion operation to do negative work (low-state), the classification method of different operational sub-modes, the specific control method of mechanical power flow or electric power flow in each sub-mode and the power function generated are fundamentally different from those of the above technology set of the prior art, and the switching among different operational modes is only highly correlated with the average road-load power function (i.e., the minute-level rolling time average) regardless of the instantaneous vehicle road-load power function. Obviously, the series-hybrid iSS or parallel-hybrid iPS control technology not only retains the main advantages of the existing engine Stop-Start (SS) and Cylinder Deactivation (CDA) (such as fuel saving, exhaust gas temperature control and the like), but also overcomes their main disadvantages (such as the interruption of the functions of air conditioning and other sub-systems, increased complexity and cost of the engine system, reduced reliability and life of the engine system and the like) effectively, so that the simultaneous optimization of energy saving and emission reduction of ACE HDTs is achieved with higher performance-to-cost ratio under the condition of no addition hardware. It should be emphasized that the series-hybrid iSS control or parallel-hybrid iPS control is applicable to the global full vehicle operating conditions of the ACE HDT from the static condition to the maximum legal speed theoretically. However, when the average speed of the ACE HDT is less than 25 miles/hour and active acceleration or braking is frequent (i.e., congested highway conditions or urban traffic conditions), the series-hybrid iSS control has obvious advantages over the parallel-hybrid iPS control in terms of the driving performance of the full vehicle and the effect of energy saving and emission reduction, so the series-hybrid iSS control shall be the preferred choice.

Currently, the e-Coast technology is used for further fuel saving in some high-end HDTs with internal combustion engines in Europe and US. If the absolute value of the average road-load power of the vehicle in a certain road section is less than the predetermined threshold (for example, the absolute value is less than 25 kW; the HDT is going down a gentle slope), the vehicle control unit (VCU) of the HDT can command the automatic mechanical transmission (AMT) to shift to a neutral gear for coasting or disengage the clutch-by-wire for coasting. At this time, the engine is decoupled from the input shaft of the transmission and the driving wheels mechanically, its torque is reduced at first, then its speed is reduced, and its operation is switched to the idle operating point (positive engine speed and torque in low load). Relying on its huge inertia, the vehicle can still glide without engine propulsion at close to a constant speed for some distance (at the mile or minute level) to achieve the effect of fuel saving; when the absolute value of the average road-load power exceeds a specific threshold (for example, the absolute value is greater than 25 kW), the VCU commands the engine to increase the speed again to synchronize the speed of the engine with that of the transmission, then the clutch-by-wire is re-engaged and the transmission is put into gear again, and the normal driving mode or braking mode of the engine is restored. The engine of the HDT is at a low speed and a low load under the idle condition, with higher brake specific fuel consumption (BSFC), and there is still relatively high fuel consumption and emissions. At this time, however, the fuel consumption absolute amount is not high due to the low engine load (the power load rate is less than 15%), but the intensity of pollutant emissions will increase significantly; fuel saving can be achieved when the HDT is gliding down a gentle slope in neutral gear (including coasting with the clutch disengaged), but the vehicle loses the engine braking function at this time, the burden of the mechanical braking system (for vehicle deceleration) is significantly increased, and the vehicle also loses the capability of rapid acceleration, which is obviously detrimental to the active driving safety; when a driver is going downhill in a HDT with manual transmission (MT), the vast majority of fleets explicitly prohibit coasting in neutral gear to save fuel from the perspective of active driving safety. Subject to the slow response speed of the engine, transmission, and other mechanical systems, the mode switching interval of e-Coast is at the minute level, and it is difficult to switch back and forth with high frequency at second-level intervals; the e-Coast is only applicable to some sections of the roads where the HDTs for long-haul freight actually run; for example, the proportion of distance traveled is less than 35%, the actual fuel saving effect is not significant, and it is necessary to balance the contradiction between fuel saving during coasting in neutral gear and braking safety and effectiveness at any time; the e-Coast will significantly increase the cumulative number of gear shifts of the transmission or the cumulative number of clutch disengagement and engagement operations, which has a negative impact on the service life of both the shifting mechanism of the transmission and clutch and may also affect the NVH performance of the full vehicle.

The ACE HDT operating in series-hybrid iSS or parallel-hybrid iPS control, the instantaneous engine power function in each PWM cycle includes distributed engine operating condition of zero fuel consumption and zero emission (i.e., series-hybrid non-combustion idle condition (low-state) or parallel-hybrid non-combustion low-state with electricity consumption). The following “intelligent Mode Switching” (iMS) control technology can also be adopted for further fuel saving. The specific technical measures to be implemented are as follows. The ACE HDT can calculate and predict the instantaneous road-load power function and the average road-load power function (sub-minute-level rolling time average) at an hour level in the future or in a 100 km-flat road section with a kW-level granularity in real time (with sub-second level delay) according to the vehicle configuration parameters, dynamic condition data, priori 3D road data on the electronic horizon and other information (with vehicle dynamic equation); for road sections where the absolute value of the average road-load power function is less than the pre-set threshold (e.g., 50 kW), it is preferred to switch to the series-hybrid iSS control mode for vehicle operation; for road sections where the absolute value of the average road-load power is greater than the pre-set threshold (e.g., 50 kW), it is preferred to switch to the parallel-hybrid iPS control mode for operation. Obviously, the periodic low-state equivalent energy consumption of PWM in the series-hybrid iSS mode is noticeably lower than that in the parallel-hybrid iPS mode. The former has lower energy consumption (i.e., electricity consumption) per unit distance, which is more beneficial to fuel saving; no matter in the series-hybrid iSS mode or in the parallel-hybrid iPS mode, the vehicle transmission is always put into gear for operation, coasting in neutral gear is completely avoided, so that series considerations can be given to energy saving & emission reduction as well as braking effectiveness. The peak torque of the driving motor (MG2) can be equal to that of the engine, but the adjustment of the motor operating condition (i.e., torque or speed) is one order of magnitude faster than that of the engine. No matter in the series-hybrid iSS mode or in the parallel-hybrid iPS mode, the driving motor (MG2) can always provide the vehicle with 100-kW level positive driving power or negative regenerative braking power through the transmission within the response time at a 10-millisecond level to not only optimize the fuel consumption and emission of the engine, but also completely avoid coasting in neutral gear and ensure braking safety, reduce the shifting times of the automatic transmission, and improve the NVH performance of the full vehicle; the actual fuel saving effect of intelligent Mode Switching (iMS) is significantly better than that of the existing e-Coast, and the iMS also completely overcomes the negative impacts of the latter on the life of the shifting mechanism, the life of the clutch-by-wire, the NVH performance of the full vehicle and other aspects due to the increase in the shifting times of the transmission, as well as the disadvantages of reduced braking effectiveness, increased brake pad wear and the like of the full vehicle.

Similar to the tires and brake pads, the clutches of the traditional HDTs with internal combustion engines are consumables, the core function of the clutch is on-off control over torque transfer between the engine and the input shaft of the transmission, and the clutch completes the speed synchronization between the engine and the transmission through its internal friction plates in the second-level transition state when the clutch is switched from a fully disengaged state (off) to a fully engaged state (on); the normal service life of the clutch is significantly lower than that of the engine or transmission and is highly correlated with the driving styles of HDT drivers, and the clutch and brake are one of the key focuses of daily operation and maintenance of HDTs; clutch replacement or repair not only costs a lot, but also affects the attendance rate of the vehicles, which has always been one of the pain points in daily operation and maintenance of trucking fleets. When the traditional HDT with an internal combustion engine shifts gears during operation, especially at the time of Downshift, the clutch must be disengaged first to realize Torque Interrupt. Clutch engagement can be restarted after shifting operation of the transmission is completed and the engine speed is increased at a low load rate. In the second-level transition period, the speed difference between the engine flywheel and the input shaft of the transmission is eliminated by using the slip of the friction plates inside the clutch to realize speed synchronization of the engine and transmission. The engine operation at a high load rate can be restored to drive the vehicle only after the clutch is completely engaged; the whole shifting operation of the transmission is generally completed in a second-level period; it is inevitable that the friction plates of the clutch slip in varying degrees each time the clutch is engaged because it is difficult for the engine to regulate and control its speed quickly and accurately in the universal working condition. Obviously, factors such as the frequent shifting of the transmission and the excessive speed difference or torque difference between the driving end and driven end of the clutch in the second-level transition period (i.e., before complete engagement) have a negative impact on both the clutch life and NVH of the full vehicle. The modern AC motors achieves dynamic and precise control of its motor speed and torque through vector control, the velocity of motor speed control is nearly one order of magnitude faster than that of engine speed control, and a 100-kW level motor can complete the instantaneous torque interruption and speed regulation synchronization (at the second level) necessary for transmission shift operation easily through Vector Control without any assistance from the clutch. The fuel-saving robot of ACE HDT of the present disclosure can command the dual-motor mixed hybrid powertrain to realize the function of Clutch-less Gear Shift (CGS) of the vehicle, that is, the synchronized disengagement and engagement actions of the clutch is not required during transmission shifting no matter in the series-hybrid mode or the parallel-hybrid mode of the ACE HDT, and the clutch is always in the fully engaged (on) state (parallel-hybrid) or fully disengaged (off) state (series-hybrid) throughout the transmission shifting operation (at the second level). The specific technical measures are as follows. When the ACE HDT operates in the series-hybrid iSS mode in a steady state, the clutch is disengaged all the time, the engine and the transmission are completed decoupled, the electrical power split device (ePSD) can realize instantaneous driving torque interruption and variable speed synchronization at the input end of the transmission by commanding the driving motor through the vector control technology, enabling the transmission to complete its shifting operation smoothly. When the ACE HDT operates in the parallel-hybrid iPS mode in a steady state, the clutch is always engaged, and the speed of the engine is synchronized with that of the duo-motors (MG1 and MG2) and that of the transmission. If the transmission needs to shift gears, the working condition of the engine can be switched to and maintained in a PWM pulse low-state (at the second level) by dynamically adjusting the duty cycle of the PWM pulse sequence of the engine instantaneous power function, and the engine is dragged to rotate by the generator in the driving mode. At this time, the engine is equivalent to a small or medium-sized mechanical load with a power consumption of less than 50 kW, the 100-kW level generator (MG1) and the driving motor (MG2) are at the same speed (coaxial connection) or have fixed speed ratio (parallel axis connection), torques can be combined, and the total peak torque can be higher than 3,000 NM. The electrical power split device (ePSD) can not only easily drag the non-combustion engine to run, but also realize the instantaneous driving torque interruption and variable speed synchronization of the input end of the transmission by commanding the coordination of the duo-motors (MG1 and MG2) through the vector control technology, enabling the transmission to complete the shifting operation smoothly (at the second level), and then the engine can switch back to the PWM pulse high-state again.

When switching between the series-hybrid iSS mode and the parallel-hybrid iPS mode (i.e., intelligent mode switching; iMS), especially switching from series-hybrid to parallel-hybrid (i.e., the clutch is switched from a disengaged state to an engaged state), the engine is controlled to operate in the low-state pulse period (at the second level) by adjusting the duty cycle of the PWM pulse sequence, the non-combustion engine doing negative work is dragged by the generator (MG1) to realize the variable speed synchronization between the engine speed and the speed of the mechanical shaft of the driving motor or the speed of the input shaft of the transmission, and then the clutch is engaged; Both speed and torque of the generator and the driving motor can be controlled dynamically and accurately, it can be ensured that both the generator (MG1) and the driving motor (MG2) can realize fast variable speed synchronization (Synchronize) under various vehicle operating conditions, the relative speed difference can be controlled within 2% strictly, so the wear-and-tear of each engagement or disengagement of the clutch of the ACE HDT is significantly lower than that of the clutch of the traditional HDT with an internal combustion engine in the iMS control mode; obviously, the clutch of the ACE HDT needs two steady states: normally engaged (on state) and normally disengaged (off state), and the requirements in other aspects are the same as those of the clutch of the traditional HDT. In other words, a clutch disengagement or engagement operation is required only when the ACE HDT is switched between series-hybrid mode and parallel-hybrid mode; if the transmission needs to shift gears (in the series-hybrid iSS mode or the parallel-hybrid iPS mode) during steady-state operation of the vehicle, the Clutch-less Gear Shift (CGS) control is preferred without any operation of the clutch. A HDT with an internal combustion engine for long-haul freight needs to complete hundreds of transmission gear shifts if it travels an average of 500 miles per day; the driving performance (referring to the total peak power or peak torque of the full vehicle) of the ACE HDT is significantly better than that of all HDTs with internal combustion engines for long-haul freight, and the number of transmission gear shifts for such a vehicle travelling 500 miles per day can be reduced by more than 50%; the number of daily average intelligent mode switching (iMS) control operations is only a few dozen times; in addition, the Clutch-less Gear Shift (CGS) function can basically eliminate the clutch engagement and disengagement operations caused by transmission shifts. In summary, through the Clutch-less Gear Shift (CGS) and the intelligent Mode Switching (iMS), compared with the clutch of the modern diesel HDT (i.e., the prior art), the ACE HDT in the present disclosure can reduce the cumulative number of engagement and disengagement operations of the clutch by more than 75%, increase the effective life (i.e., replacement mileage) of the clutch by more than 150%, significantly reduce the vehicle operation and maintenance costs, and improve the attendance rate. A perpetual pain point for the drivers and fleets in the daily operation and maintenance of HDTs is solved with high performance to cost ratio under the condition of no addition hardware.

When the traditional HDT with an internal combustion engine is running, the instantaneous engine power is proportional to the instantaneous vehicle road-load power, and both of these instantaneous power items are analog time-varying functions; when a computer-based simulation analysis is performed on the problem of optimization of energy saving and emission reduction of the vehicle, a single combustion working stroke of the engine cylinder needs to be taken as a basic unit to perform modeling analysis. Engine operation in all operating conditions of the universal characteristic curve is a very complex multi-variable nonlinear systemic problem. The total time of a single combustion working stroke of the engine cylinder is much less than 100 milliseconds. Up until now, mankind is still unable to realize high-fidelity computer real-time simulation ((at the 100 millisecond level) of the dynamic characteristics, specific fuel consumption and pollutant emissions of the engine by establishing a complete dynamic microscopic (molecular level) mathematical model (or digital model) with each 100 millisecond-level in-cylinder combustion chemical reaction as a basic unit at the level of combustion working stroke under the global surface working condition; mankind is also unable to collect the big data that can completely describe the problem of optimization of energy saving and emission reduction under the global working conditions of the engine at a single four-stroke micro level (intake/compression/combustion/exhaust) of the engine; the electronic control technology of fuel injection of the traditional internal combustion engine essentially takes the single combustion working stroke of the engine as the minimum basic unit to perform analog signal processing and analog electronic control (AEC) on the analog time-varying function of instantaneous engine power.

By implementing the series-hybrid iSS control or parallel-hybrid iPS control on the instantaneous output power of the engine, the fuel-saving robot of ACE HDT can convert the complex and dynamic analog time-varying function of the instantaneous power of the engine and that of the instantaneous power of the battery pack into two relatively simple pulse time sequences, i.e., a bipolar rectangular (series-hybrid) or bipolar non-rectangular (parallel-hybrid) pulse-width modulation (PWM) pulse time sequence and a non-rectangular pulse-amplitude modulation (PAM) pulse time sequence respectively and synchronously, convert the problem of vehicle driving performance (instantaneous, time differential) or energy management (steady state, time integral) and others complex problems of analogue signal processing and control into a relatively simpler problems of digital signal processing and control, and then solve these digital signal processing and control problems of optimization of energy saving and emission reduction of the ACE HDT automatically and effectively relying on computer programs. Analogous to the technological path evolution of upgrading of feature phones in the 1G/2G era to smart phones in the 3G/4G/5G era of the mobile communication industry, the fuel-saving robot of the ACE HDT in the present disclosure truly realizes a software defined and fully digital hybrid powertrain. It should be emphasized that any mainstream HDT engine mass-produced in the three major HDT markets in Europe and US, whether basic type or advanced type, can meet the performance requirements (steady or dynamic state) of the engine of the ACE HDT in the present disclosure and produce the PWM pulse time sequence of the instantaneous power of the engine; the digital control technology (i.e., series-hybrid iSS or parallel-hybrid iPS) of engine power pulse modulation (PM) of the present disclosure greatly simplifies the engine from the complex universal surface working condition into a pre-set two-point operating conditions or a two-line operating conditions in the engine high-efficiency zone, effectively shields the differences in steady-state performance, dynamic performance, fuel consumption, emissions and other aspects of HDT engines of various technical grades in the universal characteristic curve, so that the engine is no longer the bottleneck in the vehicle driving performance and the actual energy saving and emission reduction effects of the ACE HDT, and its system cost effectiveness can be improved significantly. Relying on 100-kW level duo-motors plus 10 kWh-level power-type battery pack, the 100-kW level large engine of the ACE HDT, which are essentially two sets of mutually independent and redundant powertrains, have complementary advantages to realize the simultaneous optimization of vehicle fuel consumption and emissions under the condition of improving the vehicle driving performance and active safety; moreover, the actual effect of energy saving and emission reduction of the ACE HDT is basically decoupled from the dynamic performance limiting values (universal characteristic curve) of the engine of the ACE HDT in the global working condition range or the driver's skill level & style. Therefore, the fuel-saving robot of ACE HDT can also effectively solve the long-term pain point of the highway logistics industry that the actual fuel consumption of vehicles is highly dispersed due to different powertrain configurations and different driving levels of drivers of traditional engine HDTs, so that each ACE HDT can achieve the optimization of energy saving and emission reduction of the vehicle with high consistency under the control of the fuel-saving robot and defeat human drivers.

Obviously, the change speed of 100-kW level instantaneous power of the battery pack or motor is one order of magnitude higher than that of 100-kW level instantaneous power of the internal combustion engine or that of 100-kW level instantaneous road-load power. Under the collaborative control of some combination of the five electronic power modules (such as inverters 121, 122a&b, choppers 132a&b) in ePSD 123, the power-type battery packs 130a&b can track the dynamic change of the difference between the instantaneous road-load power function and the instantaneous engine power function quickly and accurately to satisfy the series-hybrid power balance equation (2-4) or the parallel-hybrid power balance equation (3-3) in real time. Corresponding to the bipolar rectangular or non-rectangular PWM pulse sequence of the instantaneous power of the engine 101, the pulse-amplitude modulation (PAM) time sequence of the charge-discharge power of the battery packs 130a&b is generated synchronously, the amplitude of the PAM sequence is continuously adjustable between the charge peak power (negative value) and the discharge peak power (positive value), the cycle is one tenth of the cycle of the engine PWM sequence, and the digital control of the instantaneous power analog time-varying function of the vehicle road-load is completed. In other words, the problem of real-time control of the analog time-varying function of the road-load instantaneous power of ACE HDT can be converted into the following equivalent problems: pulse-width modulation (PWM) control is performed on the instantaneous mechanical power of the engine at first, and pulse-amplitude modulation (PAM) control is performed on the instantaneous electric power of the battery pack synchronously; then a digital road-load instantaneous power pulse sequence function (digital road-load power for short) equivalent to the original road-load instantaneous power analog time-varying function (original road-load power for short) is generated by superimposing both powers according to the series-hybrid power balance equation (2-4) or the parallel hybrid equation (3-3) to ensure that the vehicle dynamics equation (1-1) is satisfied in real time. Although there are subtle differences between the original road-load power function and the digital road-load power, they have the same impulse (i.e., the same time integral of the power function); HDT driving is an inertial dynamic system. According to the impulse equivalence principle, both the digital road-load power and the original road-load power can satisfy the vehicle dynamics equation (1-1) in real time, and the same vehicle driving effect will be generated; obviously, the digital road-load power is a composite pulse sequence function including an engine power PWM pulse sequence and a battery pack power PAM pulse sequence. Once the technical problem of energy management (steady state, time integral) or power management (instantaneous, time differential) of the ACE HDT for long-haul freight throughout a transportation event is completely digitalized through the series-hybrid iSS technology, parallel-hybrid iPS technology, intelligent Mode Switching (iMS), Clutch-less Gear Shift (CGS), intelligent cruise control (iCC), predictive adaptive cruise control (PACC) and other combined technologies of the present disclosure, the technical problem of “simultaneous optimization of energy saving and emission reduction of the full vehicle” is converted into a Narrow AI problem that is completely equivalent to the problem “Computer playing Go” (such as Google's AlphaGo), and it is very suitable to solve this problem by the machine learning (ML) algorithm, especially a variety of Deep Learning algorithms; AlphaGo has defeated the best human player in the Go game, the fuel-saving robot of the ACE HDT can also win over human drivers in the specific vertical application field of simultaneous optimization of energy saving and emission reduction of HDTs for long-haul freight and become the best assistant or co-driver of truck drivers.

The ACE HDT in the present disclosure can be configured with a plurality of motors, and at least two large automotive-grade electric motors with nominal power of more than 150 kW and independently and arbitrarily adjustable speed and torque are configured as standard (mandatory) devices. The main operation mode of one motor (MG1) is the electric power generation mode, which is referred to as the generator for short; the other motor (MG2) mainly operates in the driving mode, which is referred to as the “primary driving motor” or driving motor for short; of course, the generator can also operate in the driving mode, and the driving motor can also operate in the power generation mode (regenerative braking); an optional secondary driving motor (MG3) with a 100-kW level nominal power can also be provided, the speed of the secondary driving motor (MG3) is proportional to that of the primary driving motor, and the torque is arbitrarily adjustable. The system architecture of the ACE HDT is a duo-motor hybrid architecture, in which the generator in the hybrid position P1 is connected with the flywheel of the engine bidirectionally and mechanically (coaxial at equal speed, or parallel axes at constant speed ratio) to form a generator set (Gen-Set); the driving motor in the hybrid position P2 is connected with the input shaft of the transmission bidirectionally and mechanically (coaxial at equal speed, or parallel axes at constant speed ratio), as well as the flywheel of the engine and the mechanical shaft of the generator through a clutch-by-wire of the HDT bidirectionally and mechanically. Obviously, the range-extended series-hybrid HDT can be regarded as a special case of the above mixed-hybrid ACE HDT when the clutch is always disengaged or cancelled, while the single motor (P1 or P2) parallel-hybrid vehicle can be regarded as another special case of the above mixed hybrid ACE HDT when the clutch is normally engaged; but at this time, the generator and driving motor at a fixed speed ratio can be equivalent to a larger motor, and the nominal power of this larger motor is the sum of that of the generator and the driving motor. It can be proved theoretically that the cost effectiveness of the Mixed Hybrid ACE HDT of the present disclosure is obviously higher than that of a range-extended series-hybrid HDT or single-motor parallel-hybrid HDT with the same configuration parameters when the energy saving and emission reduction of the ACE HDT are optimized under the condition of ensuring the driving performance and active safety of the full vehicle in all operating conditions.

The ACE HDT further comprises a Global Navigation Satellite System (GNSS) which is a dual-antenna carrier phase real-time kinematic (RTK) differential receiver, capable of calculating the longitude, latitude, altitude, longitudinal slope, linear velocity and other parameters of a longitudinal road in the running process of the vehicle in real time; or a high precision single-antenna Global Navigation Satellite System, capable of calculating the longitude, latitude and linear velocity of the road at the meter-level positioning precision in the running process of the vehicle in real time; and combined with an inertial measurement unit (IMU) containing a dynamic roll-angle sensor, capable of measuring the longitudinal slope of a road in real time with the measurement accuracy of 0.1%. The vehicle control unit (VCU) or AIU of the ACE HDT is configured for predictive control over the generator set (engine+generator), clutch, driving motor, automatic transmission, ePSD and battery pack (collectively referred to as the “mixed hybrid powertrain”) of the ACE HDT based on the longitude, latitude, longitudinal slope, vehicle speed and vehicle acceleration measured and calculated by the Global Navigation Satellite System (GNSS) in real time in the running process of the vehicle in combination with the priori 3D road information (longitude, latitude, longitudinal slope and the like) within the electronic horizon of the vehicle.

The power-type battery pack is one of the most expensive subsystems in the ACE HDT, and it is often one of the weaknesses in performance and life in various important subsystems of the full vehicle. The three major problems of cost, performance and life of the power-type battery pack must be simultaneously solved in order to realize the large-scale commercial use of the ACE HDT. The technical requirements for battery cell and battery pack of ACE HDTs are obviously different from the requirements of hybrid passenger vehicles. Firstly, the requirements for weight or volume of battery packs and the like are less strict, and there is basically no limitation; however, the requirements for resistance to high and low temperatures and vibration of the battery pack, especially for the cycle life under the high-rate charging and discharging (HRPSoC) condition and the like, are higher. The ACE HDT needs to be provided with the power-type battery pack with super long cycle life, low temperature resistance, safety, reliability and high cost effectiveness; its battery cell must withstand 5C-10C rate of continuous charge-discharge and 10C-25C rate of peak charge-discharge (10 s or 15 s pulse) under the condition of high-rate partial charge-discharge in the high-efficiency zone (e.g., SoC 30%˜70%), the battery cell should work under the most challenging high rate partial charge-discharge (HRPSoC) condition for a long time, its charge rate is often higher than the discharge rate, and a further challenge is posed on the weakness that the charging rate of lithium-ion battery cells is significantly less than the discharging rate currently; the working environment temperature outside the vehicle is −30° C.˜+55° C., and the battery pack should work normally in a wide temperature range; the equivalent deep charge-discharge (DoD 100%) cycle life is more than 12,000 times. The battery pack shall be able to work normally after the vehicle is turned off for 24 hours outdoors at −30° C. in cold winter and the engine 101 is cold started, within three minutes of warm-up at idle speed in place, and after the vehicle is started to run; at the moment, the charge and discharge performance of the battery pack is allowed to be temporarily reduced. When the internal temperature of the battery cell rises to 10° C., the full charge and discharge ability is restored. However, it is not allowed to damage the battery cell permanently due to low temperature and high rate charging, reduce the cycle life, or even lead to the major hidden danger of thermal runaway of the battery cell.

Mainstream lithium-ion power cells, such as lithium iron phosphate (LFP) and ternary lithium (NCM or NCA and the like), are generally protected against cold. When the cell temperature is lower than 0° C., the high rate discharge (above 2C) ability of the cell decreases obviously and temporarily; when the cell temperature rises to more than 10° C., the discharge performance of the cell returns to normal, and the low-temperature discharge does not damage the cell permanently; however, high rate charging at low temperature (especially when it is less than 0° C.) inside the battery cell easily causes Lithium Plating on the carbon negative electrode of the cell and serious and permanent reduction of the cell life; the damage mechanism of the battery cell is mainly that the metallic lithium dendrites generated by the negative electrode lithium plating may puncture the diaphragm, which results in a short circuit in the cell and leads to the hidden safety danger of thermal runaway. The battery management system (BMS) will monitor the temperature of the battery cell in real time. It is forbidden to charge the battery cell at high rate at low temperature. It is difficult for the LFP, NCM or NCA mainstream automobile power cell to undertake the important mission of the ACE HDT battery pack alone. Different from the above-mentioned mainstream automotive-grade power battery cells, the phenomenon of lithium plating will never occur to the lithium titanate oxide (LTO; positive ternary lithium/negative lithium titanate), which is the only mass-produced automotive power cell that can fully meet all the technical requirements of ACE HDT. Compared with the several mainstream lithium-ion cells mentioned above, the LTO cell has not only the obvious advantages of ultra long life, high safety, low temperature resistance, high-rate charging and discharging (HRPSoC), best performance and the like, but also the two obvious disadvantages of low specific energy (less than 65 wh/KG) and high cost (in $/kWh, about four times as much as that of LFP/NMC cell). There is no need to worry about the disadvantage of low specific energy of LTO and large volume because the ACE HDT basically has no rigid arrangement limitation on the volume, weight and the like of the battery pack with a total capacity of only dozens of kWh; however, the disadvantage of high cost will seriously affect the mass commercial use of ACE HDTs, so the total cost of the power-type battery pack system must be reduced in every possible way; according to the present disclosure, both the overall performance and cost of the battery pack of ACE HDT are optimized by connecting at least two 10 kWh-level power-type battery packs consisting of different electrochemical cells in parallel; this will be described in detail in subsequent embodiments sections.

The battery pack of the ACE HDT can work in three different modes: 1) In the Charge-Sustaining (CS) mode, both the instantaneous SoC and minute-level time average SoC of the battery pack are always maintained to fluctuate up and down and change continuously between the best upper limit (BUL) and the best lower limit (BLL) of the high-efficiency zone of the battery pack; 2) In the Charge Depleting (CD) mode, the instantaneous SoC of the battery pack is always maintained to fluctuate continuously between the upper red line (URL) and the lower red line (LRL), and the average SoC (minute-level rolling time average) of the battery pack declines continuously between the upper red line (URL) and the lower red line (LRL) over time; 3) In the Charge-Increasing (CI) mode, the instantaneous SoC of the battery pack is always maintained to fluctuate continuously between the upper red line (URL) and the lower red line (LRL), and the average SoC of the battery pack increases continuously between the upper red line (URL) and the lower red line (LRL) over time. The best working range (also known as high-efficiency zone) of the battery pack refers to the state of charge (SoC) between the best lower limit (BLL) and the best upper limit (BUL); in the best working range, the battery pack has the best performance during high-rate partial charging and discharging (HRPSoC) and has the longest actual equivalent cycle life (i.e., the ratio of the total throughput to the effective capacity of the battery pack) in its whole life cycle; when the SoC of the battery pack is in high-rate partial state of charge (HRPSoC) operation between the lower red line (LRL) and the best lower limit (BLL) or between the best upper limit (BUL) and the upper red line (URL), although the battery pack does not have the best charge-discharge performance, no permanent damage will be caused to the battery cells. As a result, the battery pack cycle life is reduced. In the PACC technical solution of ACE HDT of the present disclosure, the charge-discharge power control strategy of the battery pack is closely linked with the mechanical power control strategy of the engine of ACE HDT and the control strategy of the total driving power (i.e., the sum of the effective mechanical power and the effective electric power of the closed loop) of the full vehicle; the core of the power control strategy for the ACE HDT in the present disclosure is to decompose and convert the complex analog control problem of “full vehicle power management” (multi-variables and nonliner) into two relatively simpler pulse modulation (PM) digital control problems: one is the digital control problem of sub-second level “instantaneous power management”, and the other is the digital control problem of minute-level “average power management”; in terms of instantaneous power (sub-second level) control, through series-hybrid iSS control or parallel-hybrid iPS control, the instantaneous electric power analog function of the battery pack and the instantaneous mechanical power analog function of the engine are converted into two Synchronized PAM pulse sequences and a bipolar PWM pulse sequence to satisfy the vehicle dynamics equation (1-1), series-hybrid power balance equation (2-4), or parallel-hybrid power balance equation (3-3) in real time; at this time, the instantaneous state of charge (SoC) time-varying function of the battery pack fluctuates continuously up and down between the lower red line (LRL) and the upper red line (URL); in terms of steady-state average power (minute-level rolling average) control, by adjusting the amplitude of the above battery pack PAM pulse sequence or the duty cycle of the engine PWM pulse sequence dynamically and respectively, and implementing minute-level rolling time average operation on the above PAM pulse sequence or PWM pulse sequence respectively, the average power function value of the battery pack or the average power function value of the engine are dynamically and continuously adjusted respectively; the instantaneous power function of the road-load and its average power function (minute-level time average) within the electronic horizon (hour level or hundred kilometer level) can also be calculated and predicted in real time (in sub-second level time delay) with the kW-level granularity according to the vehicle dynamics equation (1-1), then the battery pack is controlled to operate stably in one of the three working modes of Charge Sustaining (CS) (the difference is basically equal to zero), Charge Depleting (CD) (the difference is significantly larger than zero) and Charge-Increasing (CI) (the difference is significantly smaller than zero) or to switch smoothly among the three working modes by dynamically adjusting the difference between the average road-load power function and the average engine power function, and the power-type battery pack is controlled to work in its high-efficiency zone stably for a long time to the maximum extent possible in order to seek the maximization of the regenerative charge turnover rate of the battery pack and the minimization of the engine charge turnover rate and achieve simultaneous optimization of multiple beneficial effects of driving performance, active safety, energy saving and emission reduction and the like of ACE HDT.

There are two kinds of charges stored in the battery pack of the ACE HDT: one is the high-cost charge from the direct generation of electricity by the engine, i.e., “Engine Charge”, and the other is the quasi-zero-cost charge recovered from the regenerative braking of the driving motor, i.e., “Regen Charge”; obviously, the Regen Charge is also originated from the engine indirectly. The power control strategy (equivalent to the energy management strategy) for the fuel-saving robot of the ACE HDT in the entire freight event has two key aspects: the first is to maximize the total charge throughput (kWh) of the battery pack for driving the vehicle; the second is to maximize the proportion of Regen Charge in the total charge while reducing the proportion of Engine Charge in the total charge as far as possible. Obviously, the total charge is equal to the sum of Regen Charge and Engine Charge, and the dimensions of the three charge items are kWh. The ratio of the total charge throughput to the effective capacity of the battery pack is the total charge turnover rate; the expression “optimization of energy management” or “simultaneous optimization of energy saving and emission reduction” of the ACE HDT in the present disclosure can refer to either the technical problem to be solved, or the technical effects achieved by solving the above technical problem (i.e., minimization of fuel consumption); the predictive adaptive cruise control of ACE HDT (i.e., PACC function of Level I fuel-saving robot) is a technical solution for achieving the beneficial effect of minimization of RDE fuel consumption, and it is a collection of various specific technical measures in the present disclosure. PACC is essentially the complete-vehicle dynamic power control strategy of the ACE HDT. One of its core elements is to seek the maximum value of regenerative charge turnover rate and the minimum value of engine charge turnover rate under the condition of improving the total charge turnover rate of the battery pack in each freight event as far as possible.

The VCU can be configured to calibrate the built-in clocks of subsystem microprocessors, including the built-in clock of the VCU, based on the precise time service of the GNSS receiver in real time, and annotating the dynamic operational data of the complete ACE HDT and all subsystems associated with the traverse or longitudinal control of vehicle driving by using the system time sequence with unidirectionality and uniqueness to perform measurement, calculation and storage with a sampling frequency of higher than 5 Hz; aligning and assembling into a data set the configuration parameters and/or dynamic condition data including at least two subsystems among the GNSS receiver, the map unit, the engine, the generator, the ePSD, the clutch, the driving motor, the automatic transmission and the battery pack on the first dimension; calibrating, aligning or arranging a plurality of data sets on the second dimension according to the system time sequence to form structured big data (i.e., fuel-saving data set) about the operation of the ACE HDT, which is used to describe the dynamic operating condition of the ACE HDT, specially focusing on energy saving and emission reduction of vehicles and autonomous driving safety; optionally, in order to protect the privacy and trade secrets of drivers and fleets, the proprietary structured big data is desensitized and encrypted first, and then uploaded in a safe way to the cloud computing platform for storage through the mobile Internet in real time (sub-second level delay) or in time (hour-level time delay) afterwards for subsequent big data analysis and processing.

The VCU can also be configured for real-time control over at least one of the engine, the generator, the battery pack, the ePSD, the automatic transmission and the driving motor correspondingly based on at least one of a priori road longitudinal slope distribution function of 3D map within the electronic horizon, vehicle GNSS positioning, a digital model of the universal characteristic curve of the engine, a digital model of charge-discharge characteristics of the battery pack, a digital model of transmission characteristics, and a digital model of universal characteristics of the driving motor.

The VCU can also be further configured for commanding a collection of many on-board sensors and microprocessors for real-time collection and local storage of the structured big data (i.e., fuel saving data set) of the operation of ACE HDT in the running process of the vehicle; and sending and storing the stored fuel data set stored onboard to the remote cloud computing platform via a wireless mobile Internet in real time (sub-second time delay) or in time (hour-level time delay) for subsequent cloud analysis and processing. On the cloud platform, the deep learning algorithm, the cloud platform computing power and the fuel saving data set of many ACE HDT clusters are integrated to train the cloud AI brain (i.e., AI training chip) of the fuel-saving robot of ACE HDT, establish a deep neural network (DNN) model of the fuel saving algorithm, and download or push through over-the-air (OTA) the default fuel saving algorithm for specific freight events to the designated ACE HDT, then the local real-time reasoning operation is performed by the vehicle AI brain (i.e., AI reasoning chip) to optimize the fuel consumption and emission of the vehicle. According to a specific ACE HDT and a specific freight path combined with the big data of the operation of all ACE HDTs on the same path in history, the cloud AI brain quickly calculates the default optimal fuel saving power control plan for the vehicle running on the path and downloads and pushes the plan to the vehicle, and then the vehicle AI brain performs local reasoning and calculation and corrects the power control strategy in real time according to specific vehicle and road conditions to achieve the optimization (i.e., minimization) of fuel consumption (L/100 km) and emission of the vehicle.

The after-treatment system (ATS) of the China BG-6 diesel engine of the HDT and the modern diesel engine of the HDT in Europe and US use basically the same technical pathway and consist of three subsystems: diesel oxidation catalyst (DOC), diesel particulate filter (DPF) and selective catalytic reducer (SCR) for eliminating nitrogen oxides (NOx), which are connected in series successively in proper order from front to back. The high efficiency temperature range for catalyst emission reduction conversion is generally between 250° C. and 550° C. Under engine medium and high-load conditions, the exhaust temperature of the diesel engine is generally 250° C.˜500° C., and the ATS is in the high-efficiency zone to facilitate emission reduction; during cold start (which means that the surface temperature of the catalysts inside the after-treatment system is below 100° C.) or low-load operation of the engine, the exhaust temperature of the engine is significantly lower than 250° C., the surface temperature of various catalysts in the after-treatment system cannot reach 250° C. (a threshold in the high-efficiency zone, i.e., the so-called Light-off Temperature) rapidly, and at this time, the conversion efficiency of the catalysts is not high (e.g., less than 50%), and the pollutant emissions (PM, NOx and the like) are high. A large portion of the accumulated emissions of the vehicle mainly comes from the cold start or low-load idle of its engine, and other instantaneous states of sudden changes in engine speed and torque; how to satisfy the regulatory limits on pollutant emissions under the real driving environment (RDE) of vehicles stably for a long term within the warranty scope of 700,000 km of the ATS is another important and hard technical problem to be solved effectively for the new China BG-6 compliant HDTs.

The modern diesel HDT controlled by the On-Board Diagnostics-II (OBD-II) module for monitoring the vehicle exhaust emission in real time must stop to complete Active Regeneration of the DPF system and remove carbon particles deposited in the DPF every once in a while (at the 100-mile or 1000-mile level); the frequency of Active Regeneration (times/100 km) mainly depends on the configuration parameters of the vehicle and its mainstream Duty Cycle; the Active Regeneration of DPF is both time consuming (idling stop of diesel engine for about 30 minutes) and fuel consuming with useless work, which has always been one of the pain points for European and US HDT drivers and transportation companies, and will also become one of the pain points for Chinese drivers and fleets using new China BG-6 HDTs.

The mixed hybrid ACE HDT of the present disclosure can set the engine at its combustion high-efficiency zone or optimal operating point stably for a long time throughout its operational life cycle by implementing the series-hybrid iSS and the parallel-hybrid iPS, and can reduce the active regeneration frequency of the ATS by more than 80% compared with that of the single-motor parallel-hybrid HDT or the traditional diesel HDT; it can also ensure that the surface temperature of catalysts inside the emission after-treatment system (ATS) falls within the efficient conversion temperature range (higher than 250° C.) stably for a long time while optimizing the vehicle fuel consumption, so that the number of cold start of the engine of ACE HDT is reduced by more than 75% compared with that of the single-motor parallel-hybrid HDT or the traditional diesel HDT; it can not only reduce the fuel consumption, but also reduce the pollutant emissions in the actual operation of HDTs to meet the requirements under actual driving in the China BG-6 RDE emission regulations stably for a long time.

As described above, the overall fuel consumption (L/100 km) of the duo-motor single-clutch mixed hybrid HDT of the disclosure in the long-haul freight application can be reduced by 30% compared with that of the traditional HDT with an ICE, and the former has much better driving power performance, active safety and RDE emission compliance. Also, the mixed hybrid HDT has more advantages in fuel saving, driving power, active safety, performance-to-cost ratio, etc., compared with the range-extended series-hybrid HDT.

The fuel-saving robot (VCU and AIU) of the ACE HDT of the present disclosure can calculate and predict the space-time function of road-load power in the electronic horizon with a refresh frequency of higher than 1.0 Hz at kW-level granularity according to the priori road 3D data (longitude, latitude, longitudinal slope), vehicle configuration parameters, dynamic operation data (total mass, rolling friction coefficient, wind resistance coefficient, vehicle speed, vehicle acceleration, real-time positioning and the like) and other information within the electronic horizon, according to the vehicle dynamics equation (1-1), then generate and execute the vehicle power control strategy automatically in real time (in sub-second level delay) at the vehicle end according to the machine learning (ML) algorithm focusing on energy saving and emission reduction, and command the mixed hybrid ACE HDT to implement a series of combined control technologies such as series-hybrid iSS or parallel-hybrid iPS, intelligent Mode Switching (iMS), Clutch-less Gear Shift (CGS) or intelligent cruise control (iCC) dynamically, so that both the engine and battery pack can work in their respective high-efficiency zones stably for a long time under the condition of ensuring the driving power and active safety of the vehicle, so as to achieve the simultaneous optimization of RDE energy saving and emission reduction of ACE HDTs, especially the minimization of overall fuel consumption; a collection of the various technical measures mentioned above is defined as a technical solution or function of “Predicative Adaptive Cruise Control” (PACC) of the ACE HDT. Compared with the traditional HDT with an internal combustion engine, the fuel-saving robot of the ACE HDT can reduce the RDE fuel consumption by more than 25% through the technical solution of PACC with the same freight route, the same payload and the same freight delivery time, the fuel saving effect is highly consistent and basically decoupled from the level of ACE HDT human drivers and the ultimate performance parameters of the engine. Obviously, the technical solution of PACC can realize the longitudinal L1 autonomous driving function of the ACE HDT; In the present disclosure, PACC can represent not only the specific technical solution, but also the L1 autonomous driving function that can be realized by the technical solution; PACC is the cornerstone function of Level I to L V fuel-saving robots of ACE HDTs. Within the ODD (operation design domain) of expressway, the PACC function (i.e., vehicle longitudinal control) plays a decisive role in terms of the energy saving and emission reduction of vehicles, the weight factor can be as high as 98%, and the weight factor of vehicle lateral control is only 2%, which is basically negligible; however, the PACC function still plays an important role in terms of active safety of vehicle driving, with a weight factor of 65%, while the weight factor of vehicle lateral control increases to 35%, and both longitudinal control and lateral control are almost of equal importance; obviously the longitudinal control and lateral control (with a weight factor of 50% for each) are equally important within the ODD for urban open roads in terms of active safety of vehicle driving.

Currently, all countries in the world use basically the same Metrics to measure the vehicular traffic safety. Among the Metrics, Fatality Rate (FaR; person-time/100 million miles) and Injury Rate (InR; person-time/100 million miles) are the two most important and commonly used Lagging Indicators. The USA has the most comprehensive and open government traffic accident database in the world, which provides detailed data and analysis reports for the general public. Only by comparing the Lagging Indicators such as Fatality Rate (FaR) and Injury Rate (InR) of HAVs against manned vehicles in the real driving environment (RDE), the HAV manufacturers, the government, the public, insurance companies, courts and other road traffic safety stake-holders can collectively exercise their judgments based on real and sufficient statistical data, decide whether to amend relevant transportation laws and regulations, and allow the HAVs to be put into commercial applications within its Operational Design Domain (ODD).

The first key point of the HAV Value Proposition is that AI drivers can significantly reduce over 90% of road traffic accidents caused by human drivers' errors. However, it is only a vision or assumption that AI drivers (i.e., L3 or L4 system) are safer than human drivers who drive vehicles within the ODD, which has not been supported by sufficient statistical validation data, let alone fact-and-truth. The active safety and reliability of the HAV operation inside ODD are based on the two Metrics of mutually orthogonal dimensions (independent); the first dimension is the safety and reliability of the cyber-physical system of the vehicle, for example, the steering system, braking system, powertrain, tire, electronic control unit and the like. Based on modern physics, all these elements are lifeless and unconscious, which belong to a pure engineering technology problem with certainty and predictability; at present, there is a full set of mature technical standards and validation methods in the global automotive industry; the second dimension is the safety and reliability of the AI driver's performance of the dynamic driving task (DDT) inside ODD, which is a complicated ecological & social system problem rather than a pure engineering & technology problem based on the dynamic interactions and collaborations among the AI drivers and other road users (especially other human drivers) and road infrastructure, as well as the evolution of the human brain over tens of thousands of years. In this problem, many elements are both live and conscious. This problem is a mixture of technical and social problems full of uncertainty (i.e., randomness) and unpredictability, rather than having certainty and predictability. At present, a set of mature technical standards and validation methods for the safety and reliability of HAV AI drivers when performing dynamic driving tasks (DDTs; in the ODD) are not yet available in the global automotive industry. How to statistically prove with high confidence that AI drivers are safer and more reliable than human drivers in performing DDTs (in the ODD) without producing additional traffic risks to existing road users, especially vulnerable road users, before the HAV is approved for commercial applications in volume is a worldwide difficult technical problem like “chicken or egg”. At present, there is no effective solution that is both technically and commercially feasible in the world.

A research report of the RAND Corporation (RAND) in 2016 described how many miles of driving (i.e., the number of samples) of the 3R Test (Real Vehicle/Real Road/Real Load) it would take to demonstrate the safety and reliability of the HAV through statistical reasoning. Nidhi Kalra, Driving to Safety: How Many Miles of Driving Would It Take to Demonstrate Autonomous Vehicle Reliability? RAND Corporation, 2016. According to the report, statistical reasoning is made with the statistical confidence of 95% by using the Fatality Rate (FaR) of manned vehicles of 1.09 person-times/100 million miles and the Injury Rate (InR) of 77 person-times/100 million miles in America in 2013 as the benchmarks. If the HAV can really be perfect (i.e., zero casualty, no traffic accident), then the HAV needs to travel 275 million miles to demonstrate that the level of Fatality Rate (FaR) is the same and 3.9 million miles to demonstrate that the level of Injury Rate (InR) is the same; but in fact, the HAV cannot be perfect. It will be involved in traffic casualties or accidents. At this time, the HAVs need to travel 8.8 billion miles to demonstrate that the levels of Fatality Rate (FaR) are the same and to travel 125 million miles to demonstrate that the levels of Injury Rate (InR) are the same. Most of the above-mentioned traffic accident data is based on passenger vehicles; the FaR and InR data of HDTs for long-haul freight is at the same order of magnitude as the above-mentioned traffic accident data, and the difference ratio is less than 50%. In other words, to demonstrate that the safety of HAV HDTs is basically the same as that of ordinary HDTs driven by humans (i.e., basically the same FaR and InR), 3R Test data for more than 10 billion miles needs to be accumulated for HAVs when FaR is taken as the measurement baseline; 3R Test data for more than 100 million miles needs to be accumulated for HAV when InR is taken as the measurement baseline. Although both computer simulation and closed access car-testing proving ground are necessary means of Verification & Validation in the R&D process of HAVs, neither of them can shake the essential status of 3R Test in the HAV Validation. The cumulative mileage and cost required for the Validation of Safety/Reliability of HAVs are nearly a thousand times (i.e., three orders of magnitude) higher than those required for the Validation of Safety/Reliability of L2 vehicles (physical information systems with certainty and predictability), so it is called Batch Validation; the Batch Validation of Safety and Reliability of AI drivers of HAV HDTs is essentially validation of the difference between AI drivers and human brains that have evolved over tens of thousands of years in completing dynamic driving tasks (DDTs), as well as the AI drivers' comprehensive capacities of dynamic interaction and collaboration with a large number of human road users, so the Batch Validation is a mixture of technical problems and social problems without a complete mathematical model, which has uncertainty and unpredictability; obviously, the resources (staff, funds and properties) for completing the Batch Validation of the above-mentioned autonomous driving system of a HAV HDT are nearly a thousand times higher than that consumed for validation of the safety and reliability of L2 ADAS system. In other words, the real difficulty in the commercialization of HAV HDTs is not the engineering development of the L4 system, but the Batch Validation that it must pass before volume commercialization.

The 3R Test for validation of HAV Robo-taxi can be performed on an urban or suburban road with a circumference of 100 miles, but the 3R Test for Batch Validation of HAV HDTs for long-haul freight is statistically significant only if it is performed on expressways nationwide. In addition to the huge time and money consumption challenges, an even bigger challenge for the Batch Validation of HAV HDTs is that the 3R Test of HAV HDTs may bring a pair of irreconcilable contradictions—additional huge driving risks and the requirements of the government and the public for ensuring road traffic safety—to the vehicles driven by the vast majority of human drivers on expressways. For HAV HDTs running on expressways, almost all other vehicles are Vulnerable Road Users because the volume and weight of HDTs are one order of magnitude higher than that of passenger vehicles; for the vast majority of existing road users, both the perceived and actual traffic risks are likely to rise temporarily during validation tests of HAV HDTs on expressways due to the huge size and weight of HDTs relative to passenger vehicles; the Public will not agree to become lab rats or vulnerable road users in the process of 3R Test of HAV HDTs passively before sufficient statistical data is available to demonstrate the safety and reliability of the HAV HDTs; Governments around the world are very cautious about highway tests of HAV HDTs. By the first quarter of 2020, there is no central government in any country in the world that allows HAV HDTs to carry out the 3R Test of L3/L4 system on expressways nationwide, regardless of whether there is a Safety Driver in the vehicle. In California, the pacemaker of HAV R&D in the world, the 3R Test of HAV HDTs on public roads in California is still prohibited explicitly according to current California law although more than 50 enterprises are carrying out the 3R Test of HAV passenger vehicles on Public Road; at present, the Chinese government does not permit the mixed running of HAV HDTs with public vehicles on expressways to carry out the 3R validation test of L3/L4 system either. In other words, for the commercialization of L4 passenger vehicles such as regional Robo-Taxi, the main technical and commercial difficulty is the low cost (thousands of dollars level/vehicle) for product R&D and volume production of the L4 system, there is no regulatory barrier for the Batch Validation, and the problem of cost and time consumption can be solved; however, for the commercialization of L4 heavy duty trucks for long-haul freight, the high cost for product R&D and volume production of the L4 system is no longer a key challenge, while the current regulatory barrier and huge cost and time consumption for L4 system Batch Validation have become an insurmountable obstacle. The problem of “Right-of-way” for the validation or commercialization of HAV HDTs on public roads is a difficult problem that must be solved before the HAV HDTs can start volume commercial applications. For governments in the world, the general public and other road traffic safety stake-holders, the right-of-way of HAV HDTs should be obtained by “Earning” rather than “Requesting”; the developers of HAV HDTs, whether they are OEMs, Tier I suppliers, or scientific and technological enterprises, shall not “assume” that the L4 system is safer and more reliable than human drivers, request the right-of-way from the governments in the name of innovation encouragement at first, and turn the existing highway users into “lab rats” in the 3R Test of HAV HDTs; instead, they should demonstrate statistically that the HAV HDTs are indeed not unsafe and unreliable by completing the 3R Test of the L2 ADAS system in a “Shadow Mode” at the hundred million-mile level as permitted by the current traffic regulations, and earn from the government the right-of-way for the 3R Test of the L3 system in a “Disengagement Mode” later.

Under the regulatory framework of current traffic laws and regulations in all countries around the world, the only pragmatic way is to reduce the L4 autonomous driving system of the HAV HDT down to a L2 ADAS system to use. The 3R Test of the L2 system in the shadow mode commercial operation can be performed on expressways nationwide provided that each HAV HDT is equipped with at least one Safety Driver with a Commercial Driver's License (CDL) to accumulate real-world road traffic safety data; then the 3R Test of L3 system within the ODD of expressways can be carried out after the public understanding and the government approved right of way are obtained gradually by communicating with the government and the public continuously and effectively and demonstrating that the 3R Test of L3 system of HAV HDTs on expressways is “not unsafe” with the 3R Test data at the hundred million-mile level and the Disparity Report. In addition to the legal barriers for the ACE4 HDTs in carrying out the 3R Test of L3 or L4 system within the ODD of expressways in North America, another huge challenge is that the Variable Cost per unit of 3R Test of a L4 HDT exceeds USD 1.0/mile (mainly refers to driver's pay and fuel cost), about three times as much as the variable cost of the 3R Test of a L4 passenger vehicle; the 3R Batch Validation of the safety and reliability of the L4 autonomous driving system at the billion mile level should be completed for ACE4 HDTs, and the validation cost alone can be as high as one billion dollars, which is nearly 100 times higher than that of a new traditional HDT; the total variable cost of the annual 100,000 mile-level 3R validation of a single vehicle is more than 100,000 dollars, which is also much higher than the total cost of the L4 system hardware and software of the same vehicle (within 30,000 dollars).

According to the current laws and regulations in America and Canada (i.e., North America), ACE2 HDTs can directly enter the mass production and commercialization (Deployment) stage in North America after the million mile-level 3R Test for full vehicle validation including L2 ADAS system is completed for ACE2 HDTs in the product Development phase; obviously, human drivers are always fully responsible for traffic safety when ACE4 HDTs operate; however, the preliminary product validation (million mile-level 3R Test) completed in the product Development stage of ACE4 HDT can only demonstrate the safety and reliability of the cyber-physical system of the vehicle, and it is impossible to demonstrate the safety and reliability of L4 AI drivers' performance of the dynamic driving task (DDT) within the ODD of expressways at all; in addition, the 10 billion mile-level Batch Validation of the safety and reliability of performance of DDT by L4 AI drivers of HAV HDTs needs to be completed through the intermediate steps of the initial low volume production and Demonstration phase before the government and the public are persuaded by sufficient statistical data to agree to amendments the relevant laws and regulations and the L4 AI drivers and human HDT drivers are granted the same right of way to enter the Deployment phase of commercialization of the Level IV fuel-saving robot of ACE4 HDT; obviously, the ACE4 HDT can not only optimize the driving power, safety and energy saving and emission reduction of the vehicles simultaneously, but also greatly improve the labor productivity and freight timeliness of human drivers. In the Product Development phase (stage), there is no material difference between the L4 system of a passenger vehicle and the L4 system of a HDT, especially at the level of hardware, software and perception-decision-control AI algorithm; however, in the demonstration stage (i.e., Batch Validation stage), for road traffic safety stake-holders such as the government and the public, since the weight of HDTs can be one order of magnitude higher than that of passenger vehicles, for existing road users and the public, the subjective safety and objective safety of L4 HDTs are greatly different than that of L4 passenger vehicles during Batch Validation of L3 or L4 AI drivers within the ODD of expressways, and we must treat them differently and act cautiously. There are two types of indicators for measuring the safety and reliability of operation of HAV HDTs: 1) the first type is a Leading Indicator, which includes the disparity number (time/thousand mile) or disparity mileage (mile/time) in the shadow mode, and the disengagement number (time/thousand mile) or disengagement mileage (mile/time) in the disengagement mode and other proxy measures, with the characteristics of moderately Valid, moderately Reliable, highly Feasible, moderately Non-manipulatable, and the like; 2) the second type is a Lagging Indicator, which includes the actual road traffic Injury Rate (InR; person-time/100 million miles) and Fatality Rate (FaR; person-time/100 million miles) and other Outcome Measures, with the characteristics of highly Valid, highly Reliable, moderately Feasible, highly Non-manipulatable, and the like.

According to the classification and definition of the autonomous driving system in the SAE J3016 standard, within the Operational Design Domain (ODD), the L2 ADAS system is responsible for Driving Control (i.e., continuous longitudinal and lateral driving control of the vehicle), and the human driver is responsible for perception and decision-making (i.e., Object and Event Detection and Response; OEDR). As a DDT Fallback, the human driver is allowed to perform “feet off” or “hands off”, but not allowed to perform “eyes off” or “mind off”, and should always be ready to take over the dynamic driving task (DDT=Vehicle Control+OEDR) within one second; the L3 system can complete a full set of dynamic driving tasks (DDTs), the human driver as the DDT Fallback is allowed to perform “feet off”, “hands off”, and “eyes off”, but not allowed to perform “mind off”, and should always be ready to take over the dynamic driving task (DDT) within fifteen seconds; the L4 system can complete a full set of dynamic driving tasks (DDTs), the L4 system has its own DDT Fallback, and the human driver is allowed to perform “feet off”, “hands off”, “eyes off”, and “mind off”, leave the driver's seat and take a rest behind the cockpit. Unless otherwise specified, the default Operational Design Domain (ODD) of the fuel-saving robot of ACE HDT is a controlled access expressway.

In the USA, the maximum Hours of Service (HOS) of HDT drivers, like civilian airplane pilots, are restricted by federal mandatory regulations. The specific requirements of federal regulations on Hours of Service (HOS) for HDT drivers in the USA are as follows: the driver can only work for 14 hours at most every day (24 hours) from ignition-on of the HDT engine, wherein the driving time is 11 hours at most, then the driver must leave the driver's seat and take a rest for 10 hours before restarting the next 24-hour cycle. From 2018, all HDTs in North America (the USA and Canada) must use government certified electronic logging devices (ELDs) to record the operation of HDTs in real time and avoid the disadvantage that paper HOS records can be modified artificially. Heavy duty truck drivers are professionals who must have commercial driver's licenses (CDLs) and they account for less than 3% of all the people having passenger vehicle driver's licenses. Different from the high proportion of Team Drivers operation in HDTs for long-haul freight in China, the proportion of Team Drivers in HDTs for long-haul freight in the USA is less than 10% and most of the HDTs for long-haul freight in the USA are configured with a single driver. The driver's pay and fuel expense are cost factors with the highest percentage (about 40%) and the second-highest percentage (about 25%) in the total operation cost of HDTs for long-haul freight in the USA, and the total percentage of both cost factors in the fleet operating cost is as high as ⅔. Based on the existing legal and regulatory systems for the commercial operation and supervision of HDTs for long-haul freight in the USA, the actual driving time of human drivers may be increased by one to three hours per day (equivalent to improvement of drivers' labor productivity by 9%˜27%) by obtaining Special Waiver from the government's HOS regulations in the commercialization stage of L3 HAV HDTs; once L4 HAV HDTs are approved by the government for commercial use, if a human driver and an AI driver operate the vehicle alternately within the ODD of expressways, the two can be used as team drivers (two persons), the vehicle can travel day and night with all possible speeds and runs continuously for almost 24 hours, an L4 HDT driver can travel more than 1,000 miles a day, the human driver's labor productivity is greatly improved by more than 75%, the freight delivery time for ultra-long-haul freight (more than 1,000 miles for a single trip) is shortened by more than 35%, the freight cost (USD/ton-mile) for long-haul freight is significantly reduced, and the freight timeliness is improved greatly. Greater, faster, better, and more economical results are really achieved. This will have great economic effect and social significance and will bring revolutionary changes to the trillion dollar-level global long-haul freight industry. It is generally believed in the industry that L2 HDTs for long-haul freight have been commercially available in volume; L3 HDT for long-haul freight is only a transitional product, which has second-best cost effectiveness if 20% of its beneficial effects can be achieved at 80% of the cost of L4 system; only realization of the large-scale commercialization of L4 HDTs for long-haul freight as soon as possible is the striving goal of the global trillion dollar-level long-haul freight industry in the next decade. Unless otherwise specified, the Operational Design Domain (ODD) refers to the expressway when L1˜L4 autonomous driving systems are discussed in the present disclosure; the driver generally refers to the Human Driver; the AI driver specifically refers to the Machine Driver, i.e., L3 or L4 autonomous driving system.

When the vehicle is running in the same lane on an expressway, the continuous longitudinal control (acceleration, braking or cruising) and continuous lateral control (such as lane change and the like) of the vehicle are basically decoupled in a uni-directional manner in terms of vehicle energy management and active driving safety, so it is called one-dimensional (1D) Longitudinal Control, which satisfies the vehicle dynamics equation (1-1) within the one-dimensional coordinate system with the longitudinal displacement of the vehicle as the independent variable, without considering the influence of lateral control; however, the continuous lateral control of the vehicle is highly related to its longitudinal control (i.e., bidirectional deep coupling), and the active vehicle driving safety can only be ensured by the dynamic collaboration of both continuous lateral control and continuous longitudinal control, therefore it is called two-dimensional (2D) Lateral Control. Within the ODD of expressways, from the perspective of simultaneous optimization of fuel saving and emission reduction of the ACE HDT, the weighting factor of longitudinal control (i.e., PACC function) is 98%, while the weighting factor of lateral control is only 2% and its influence on fuel consumption is negligible; from the perspective of safety and reliability of the DDT, the weighting factor of longitudinal control (i.e., PACC function) is 65%, while the weighting factor of lateral control is only 35% and both the longitudinal control and the lateral control must be well coordinated. If changed to within the ODD of open-access suburban roads, from the perspective of simultaneous optimization of energy saving and emission reduction of the ACE HDT, the weighting factor of longitudinal control (i.e., PACC) is 95%, while the weighting factor of lateral control is only 5% and its impact on fuel consumption is still rather small; from the perspective of active safety and reliability of DDTs, the weighting factor of longitudinal control (i.e., PACC function) and that of lateral control are 50% respectively, both are equally important. It should be emphasized that in terms of energy saving and emission reduction of vehicles (based on L1 1D longitudinal PACC control), the ACE4 HDT (i.e., Level IV fuel-saving robot) is essentially the same in function and performance as the ACE1 HDT (i.e., Level I fuel-saving robot); however, in terms of safety and reliability of DDT and drivers' labor productivity, the ACE4 HDT is vastly different from the ACE1 HDT in terms of function and performance, and are downward compatible in all functions. The Level I fuel-saving robot is the “economic foundation”, and the Level IV fuel-saving robot is the “superstructure”. It should be emphasized that the simultaneous optimization of energy saving and emission reduction of vehicles is essentially a steady-state macroscopic property in the process of vehicle driving, which reflects the time integration of the instantaneous power function of the engine or battery pack, and the energy saving and emission reduction effects can be combined; it is analogous to playing the Go game, one should not strive for the local gains and losses, but focus on overall victory; the PACC control function of the Level I fuel-saving robot can be commercially available in volume when its reliability reaches 99%. However, when the Level IV fuel-saving robot is performing the L4 DDT, the safety and reliability is essentially an instantaneous microscopic characteristic in the process of vehicle driving. Similar to the safety of civil aviation aircraft, no accident is normal, and no points will be deducted; once an accident occurs, the aircraft may be destroyed and people in the aircraft may die. The government and the public will not allow the Level IV fuel-saving robot to be commercially available in volume even if its reliability of performing the L4 DDT reaches 99.9999% (six nines). And the government and the public may allow the Level IV fuel-saving robot to enter the stage of being commercially available in volume only when its FaR must be significantly less than the human driver's skill level of 1.09 person-times/100 million miles (i.e., reliability of more than eight nines). In other words, there's a huge difference between Level I fuel-saving robot and Level IV fuel-saving robot in terms of system safety and reliability threshold for commercialization. The Level I fuel-saving robot is the “economic foundation”, and the Level IV fuel-saving robot is the “superstructure”.

The ACE HDT in the present disclosure uses the powertrain by-wire, brake by-wire and steering by-wire (x-by-wire), and the lateral or longitudinal control function of the vehicle must be a dynamic control function with very high reliability (ASIL-D) and low time delay (ten-millisecond level). Whether a traffic accident occurs or the severity of the accident depends largely on the real-time, accurate and robust Object and Event Detection and Response (OEDR) around the vehicle and the continuous control of the vehicle operation (i.e., dynamic driving task (DDT)) by the controller (human driver, ADAS system, or AI driver) within ten second-level time before and after the Collision Time. By optimizing the vehicle energy management strategy through the 1D longitudinal control PACC function, the Level I fuel-saving robot can win over any human driver in terms of simultaneous energy saving and emission reduction. Compared with the traditional HDT with an internal combustion engine, the Level I fuel-saving robot ensures that the overall fuel consumption (L/100 km) is reduced by nearly 30%, this RDE fuel saving result is highly consistent, and is basically decoupled from the driver's skill level and the technical parameters of the engine; the ACE1 HDT is creating additional value of energy saving and emission reduction every time it runs for one minute or one mile, and the ACE1 HDT is the solid foundation for the other three advanced fuel-saving robots; Level II˜IV fuel-saving robots are advanced versions of the fuel-saving robot. In terms of vehicle driving control, the vehicle 2D Lateral Control function is added, and the system accuracy and robustness, system redundancy, on-board AI computing power and the like of the Object and Event Detection and Response (OEDR) of the vehicle are enhanced step by step. Within the ODD of expressways, the 1D longitudinal control (i.e., PACC function) of the ACE HDT in the same lane is in a steady state (at the sub-hour level), and this proportion of operating time is more than 95%; the 2D lateral control of actions, including vehicle lane changing, roadside emergency vehicle parking, entry into the expressway service area or leaving from the highway and the like, is instantaneous (sub minute level), and this proportion of operating time is less than 5%; the RDE fuel consumption (L/100 km) of the vehicle depends entirely on the energy management optimization AI algorithm of the fuel-saving robot of HDT in the 1D longitudinal control PACC mode, and is basically independent of the 2D lateral control.

A Comparator module (either a real electronic module or a virtual logic module) of the highest Automotive Safety Integrity Level D (ASIL-D) configured inside or outside the vehicle control unit (VCU) of the ACE HDT can Compare & Switch in real time three sets of dynamic control signals (lateral or longitudinal) of vehicle driving, which are completely independent of each other, at a refresh rate of not less than 20 Hz and generate the final dynamic wire Control Signals of vehicle driving, and these vehicle wire Control Signals satisfy the following equation:

$${C}_{si} = {k}_{i 1} {W}_{i 1} + {k}_{i 2} {W}_{i 2} + {k}_{i 3} {W}_{i 3} \qquad ( 5 - 1 )$$

Where i=1 represents longitudinal vehicle control, and i=2 represents lateral vehicle control; Wᵢ₁ represents the human driver's wire control signal, Wᵢ₂ represents the ADAS wire control signal, Wᵢ₃ represents the AI driver's wire control signal, and the three are mutually independent variables (time-varying functions); Cₛ₁ and Cₛ₂ represent the longitudinal or lateral wire control signal that finally controls the vehicle, and both are mutually independent variables (time-varying functions); kᵢⱼ represents six weighting factors that can be set by software dynamically, which is a constant that can be either preset by the driver or fleet, or adjusted over-the-air (OTA).

The Comparator is functionally equivalent to a small computer controlled switchboard with at least six input channels (Wᵢⱼ) and at least two output channels (Cₛᵢ), different comparison, fusion and switching strategies (referred to as comparison strategies) of vehicle wire control signals can be implemented through software definition and over-the-air (OTA) updates, i.e., “intelligent Comparison & Switching” (iCS) function, and this will be described in detail in the subsequent embodiment section; basic comparison strategies refer to various On-Off Comparison strategies, only one of the three factors, kᵢ₁, kᵢ₂ and kᵢ₃ is set to be 1, and the other two are set to be 0 at each moment; advanced comparison strategies refer to various Weighted Comparison strategies, the three factors kᵢ₁, kᵢ₂ and kᵢ₃ are non-negative numbers between 0 and 1, and the boundary condition is that the sum of these three weighting factors is equal to 1 forever; the priority or weight value of the driver's weighting factor kᵢ₁ is usually the highest among the three.

Sufficient space and power are available on the ACE HDT to install and support at least one set of L4 autonomous driving system (also known as L4 system to be validated) that has been frozen and finalized in engineering design and can be mass-produced and put into commercial use after passing the Batch Validation, and then the ACE HDT will be upgraded to an ACE4 HDT. At present time (in April 2020), governments around the world explicitly prohibit L3/L4 3R Test to be carried out by the HAV HDTs on expressways nationwide; the so-called “L3 3R Test” means that the AI driver completes the dynamic driving task (DDT) and the onboard Safety Driver serves as the DDT Fallback (L3 system) to be ready to take over the DDT within 15 seconds at any time; in the “L4 3R Test”, the L4 system provides Fallback for itself, and the driver can leave the driver's seat and take a rest in the rear cabin of the vehicle; under the existing traffic regulation framework of all countries around the world, the only way to make the 3R Test on expressways legal and compliant is to downgrade the ACE4 HDT by two levels temporarily at first, so that the ACE4 HDT operates in the L2 ADAS mode (i.e., the shadow mode), the AI driver and human driver are responsible for Object and Event Detection and Response (OEDR) jointly, and the human driver serves as the DDT Fallback and takes full responsibility for vehicle driving safety. At this time, the ACE4 HDT operates in the “shadow mode” to carry out the L2 3R Test in practical terms; the Comparator sets kᵢ₃ to zero in the shadow mode and compares the driver wire control signal Wᵢ₁ and the AI driver wire control signal Wᵢ₃ in real time (at a refresh rate of above 20 Hz), and a digital “Disparity Report” will be generated automatically when the absolute value of the difference between Wᵢ₁ and Wᵢ₃ is greater than the preset threshold. In other words, in the shadow mode, although the AI driver can complete the Object and Event Detection and Response (OEDR) and produce the vehicle driving wire control signal Wᵢ₃ in real time when simulating the human driver in real time in a 3R expressway environment, at this time, the Comparator of the ACE HDT completely shields the wire control signal of the AI driver and only takes orders from the human driver to ensure that the shadow mode operation of the ACE4 HDT has no negative impact on road traffic safety during batch validation.

Learning from the current regulatory approach of California for public road test of HAV light vehicles, that is, each developer testing the HAV on California roads is mandatorily required to submit a “Disengagement Report” on a regular basis; when the ACE2 HDT operates in the shadow mode, if the Comparator finds that the absolute value of the difference between the human driver's wire control signal Wᵢ₁ and the AI driver's wire control signal Wᵢ₃ is greater than the preset threshold, it will create an electronic record of “Disparity Event” using the VCU's system clock as the unique annotation. The VCU generates a digital Disparity Report for the Disparity Event automatically combined with all the original data of the L4 system sensor set and the vehicle operation data within a ten-second-level time range before and after the Disparity Event. The confidential information involving the driver's privacy or the vehicle is desensitized (anonymized) and encrypted, and uploaded to the cloud timely for subsequent analysis and processing. In the shadow mode, the human driver is a teacher, the mass-produced and commercially available ADAS system (i.e., L2 system) is a teaching assistant, and the L4 system to be validated is a student. Through imitation learning or Supervised Learning, when the L4 system to be validated performs the L2 DDTs, its performance and safety are measured and improved by using two Leading Indicators of Disparity Mileage (mile/time) or Disparity Number (time/thousand miles); obviously the shadow mode has no negative impact on road traffic safety because kᵢ₃=0.

The average annual accumulated mileage of the ACE HDT for long-haul freight is roughly 120,000 miles; 1000 ACE4 HDTs operating for one year (in four seasons of a calendar year) in the L2 shadow mode nationwide can accumulate 120 million miles and generate Disparity Reports based on the 3R Test data when the L4 system to be validated performs the L2 DDT to prove with statistical significance that it is Not Unsafe to perform the L3 3R Test on the expressways with these ACE4 HDTs; the Key Stake-holders of road traffic safety led by the government may, according to the 100-million mile level L2 Disparity Report of the ACE4 HDTs, approve the L3 3R Test to be carried out by these ACE4 HDTs on expressways nationwide, i.e., test run in an L3 “Disengagement Mode”; at this time, the L4 system to be validated is downward reduced to an L3 system to perform all the dynamic driving tasks (DDTs; including OEDR and vehicle control), but the onboard Safety Driver is required to serve as the DDT Fallback, the driver is allowed to perform “feet off”, “hands off” and “eyes off”, but not allowed to perform “mind off”, let alone take a sleep. The driver must be always ready to take over the vehicle control within fifteen seconds and perform all DDTs. Similar to the above-mentioned Disparity Report, if the Comparator finds that the absolute value of the difference between the driver's wire control signal Wᵢ₁ and the AI driver's wire control signal Wᵢ₃ is greater than the preset threshold, the Comparator will create an electronic record of Disengagement Event automatically using the VCU's system clock as the unique annotation. The VCU generates a digital Disengagement Report for the event automatically combined with all the original data of the L4 system sensor set and the vehicle dynamic operation data within a ten-second-level time range before and after the Disengagement Event; the private or confidential information of the driver or vehicle in the Disengagement Report is desensitized and encrypted, and the Report is uploaded to the cloud timely (hour-level time delay) for subsequent analysis and processing. The so-called Disengagement Event means that the AI driver is disengaged for any reason and the human driver takes over the vehicle control actively or passively and performs all or part of the DDTs. Two Leading Indicators, i.e., Disengagement Mileage (mile/time) or Disengagement Number (time/thousand miles), together with two Lagging Indicators, i.e., Fatality Rate (FaR; person-time/100 million miles) and Injury Rate (InR; person-time/100 million miles) may be used to measure and improve the safety and reliability comprehensively when the L4 system to be validated performs L3 DDTs. The L3 3R Test data and Disengagement Report for 1.2 billion miles can be accumulated by a fleet of 10,000 ACE4 HDTs operating for one year continuously (in four seasons of a calendar year) in the disengagement mode nationwide. The Key Stake-holders of road traffic safety led by the government may, according to the billion mile-level 3R Test L3 Disengagement Report and the actual data of the Lagging Safety Indicator (FaR or InR), make statistical reasoning with high confidence. Under the condition of ensuring the Road Safety, large-scale commercial operation of the L3 autonomous driving system of ACE 4 HDTs at the level of 10,000 vehicles on expressways nationwide can be opened gradually, and the stage III ten-billion-mile-level 3R Test (when the L4 system to be validated performs the L3 DDTs) will be continued. In the extremely long process of Batch Validation that is upgraded gradually in three stages, from L2 validation in the shadow mode at a level of hundred million miles (the first stage), L3 validation in the disengagement mode at a level of a billion miles (the second stage), to L3 commercialization in volume at a level of ten billion miles, the Level IV fuel-saving robot to be validated in the ACE4 HDT fleet experienced an autonomous evolution process from being a trainee to finishing its apprenticeship in terms of safety and reliability in performing the L4 DDT. Analogous to the growth process of young people from graduation from a high school and admission to an university to obtaining a doctor's degree, the ACE4 HDT is significantly better than the traditional HDT with an internal combustion engine in many aspects such as vehicle driving power, active safety, freight timeliness, driver labor productivity, vehicle fuel saving and emission reduction, so that the commercialization of the L4 system of ACE4 HDT in volume can be realized soon.

Compared with the ACE HDT of the present disclosure, the traditional HDT with an internal combustion engine (referred to as L4 traditional HDT) configured with L4 system can also adopt the shadow mode (i.e., L2 3R Test) or disengagement mode (i.e., L3 3R Test) to conduct Batch Validation of the L4 system, but it faces the following additional challenges: first of all, the driving performance and fuel consumption of the traditional HDT with an internal combustion engine are highly correlated with the performance of the engine and the driver's skill level, and the actual fuel consumption data are highly dispersed (the difference ratio of the fuel consumption can be up to +−20%); secondly, the L2 ADAS system of the traditional HDT focuses on safety and convenience, and the traditional HDT is obviously inferior to the ACE HDT with a fuel consumption reduction rate of over 25%, due to lack of the energy recovery function through regenerative braking, and its RDE fuel consumption reduction rate is less than 5% even if predictive cruise control (PCC) is used; thirdly, the time delay (second-level) for the traditional HDT to switch from the 100-kW level driving power to the 100-kW level auxiliary engine braking or pneumatic mechanical braking system is one order of magnitude slower than that of the ACE HDT, therefore the traditional HDT is also inferior in terms of braking performance; finally, the redundancy of the traditional HDT in driving power, braking, steering, power supply and other aspects is significantly lower than that of the ACE HDT. To make up for the redundancy deficiency, the L4 traditional HDT needs to be completely retrofitted and this process will be costly and time-consuming. Theoretically, the traditional internal combustion engine vehicles (referred to as traditional vehicles) can be configured with L4 systems; however, since all-electric vehicles and hybrid vehicles have overwhelming advantages over the traditional vehicles in all aspects, especially x-by-wire, redundancy, digitization and the like, in consideration of HAV R&D, all the L4 light vehicles developed by countries around the world for the purpose of mass production and commercial use are retrofitted on the mass-produced all-electric vehicle and hybrid vehicle platforms, and there are very few exceptions. However, since there are no mass-produced all-electric or hybrid HDTs for long-haul freight in the world at present, many enterprises in the world have to configure L4 systems on the traditional diesel engine HDT platforms to carry out the R&D of L4 HDT products. As stated above, the greatest challenge for the commercialization of L4 HDTs for long-haul freight in the world in the future is not the development of the L4 systems for these HDTs, but the huge challenge of how to complete the 3R Test in volume at a level of one billion to ten billion miles with high performance-to-cost ratio without endangering the traffic safety of existing highway users; it is necessary to accumulate the leading indicator disengagement report and lagging indicator actual casualty rate data (FaR and InR) on L3 operation in a disengagement mode at a level of ten billion miles to prove statistically with high confidence level that the safety and reliability of L4 AI drivers performing DDTs are indeed superior to those of human drivers, urge the government to revise existing traffic laws and regulations, and allow the L4 HDT to enter the stage of commercialization in volume as soon as possible.

Based on the current laws and regulations of the USA on the commercial use of HDTs, the second-hand (or used) traditional diesel HDTs in the USA can be retrofitted into ACE4 HDTs in volume by using the present disclosure. The commercial operations for long-haul freight at L2 can be directly carried out, and the Batch Validation of L4 system can be carried out at the same time without additional government certification or approval; we should start with the easier tasks before moving on to the more difficult ones, which is a gradual upgrading process, i.e., from the 3R Test in the L2 shadow mode at a level of one hundred million miles in the first stage, to the 3R Test in the L3 disengagement mode at a level of one billion miles in the second stage, and finally to the commercial operation in the L3 disengagement mode at a level of ten billion miles in the third stage (i.e., L4 3R Test in the disengagement mode); the 3R Batch Validation in the L4 disengagement mode at a level of ten billion miles can be completed in three years with high performance-to-cost ratio on expressways all over the USA by using a fleet of retrofitted ACE4 HDTs at a level of tens of thousands of vehicles to generate the Disengagement Report which accumulates the actual traffic casualty rate (FaR and InR) data, proves statistically with high confidence the safety and reliability when the Level IV fuel-saving robot (i.e., L4 system) performs the L3 DDT, and paves the way for ACE4 HDTs to obtain the required government approval as soon as possible and enter the commercialization of L4 system in volume. In the USA and other countries, the product R&D cycle of new genuine ACE4 HDTs is more than three years. In China or Europe, the new ACE4 HDTs must be further certified and approved by the government before mass production and commercial sales, and the Batch Validation and final commercialization of OEM ACE HDTs may lag behind that of the retrofitted ACE HDTs by three years. Obviously, in terms of validation of the safety and reliability when the AI drivers perform the L3 or L4 DDTs, the L3 commercial operation is equivalent to the L4 3R Test, all the drivers serve as the DDT Fallbacks, and must be always ready to take over the vehicles in fifteen seconds; the L3 commercial operation and the L4 3R Test are technically equivalent in terms of traffic safety and the difference is only in commercial aspects; while the commercial operation of ACE3 HDTs is performed, the technical solution of concurrently completing the 3R Test Batch Validation of the L4 system to be validated in the disengagement mode at a level of ten billion miles is much more commercially feasible than that of leapfrogging over the transitional stage of commercialization of L3 system in volume and starting from scratch to complete the 3R Test Batch Validation of the L4 system to be validated in the disengagement mode at a level of ten billion miles directly.

To reduce the operational dimension of the ACE4 HDT to L2 operation in the shadow mode or L3 operation in the disengagement mode, 1D longitudinal L1 automatic driving and optimization of energy saving and emission reduction of the vehicle are realized at first through the predictive adaptive cruise control (PACC) of the present disclosure, and the reduction rate in RDE fuel consumption (L/100 km) can exceed 20% compared with that for the operation (in the shadow mode or disengagement mode) of diesel HDTs equipped with L4 systems; the ACE4 HDTs create additional economic value for the drivers and transportation companies for every minute or mile they travel; in other words, in the stage of Batch Validation of the L4 system, when the ACE4 HDT is running, its primary business is to save fuel and make money in freight transport, and 3R Test is an auxiliary business. This is analogous to the fact that both hauling of goods and carrying billboards can be performed, and we can kill two birds with one stone or cook one lobster in three ways; when the traditional L4 HDT operates, the 3R Test is the primary business, and freight transport is the auxiliary business. Through the predictive adaptive cruise control (PACC) function and the intelligent comparison switching (iCS) function of the present disclosure, the ACE4 HDT changes the high “Variable Cost” for 3R Test of the traditional L4 HDT into a much lower “Marginal Cost” during business operation of the L2 ACE4 HDT based on operational dimension reduction, and the actual cost of the 3R Test (USD/mile) can be reduced by up to 90%. To sum up, the device and method for Batch Validation of ACE4 HDTs of the present disclosure can complete the 3R Test of the L4 system to be validated at the level of ten billion miles on expressways nationwide within three years (firstly in the L2 shadow mode, then in the L3 disengagement mode) with high performance-to-cost ratio without increasing the traffic safety risks of existing road users, and the safety and reliability when the AI drivers perform the L3 or L4 DDTs can be proven statistically with high confidence. The Batch Validation is divided into two parts: preliminary validation in the development stage (the first stage), and final validation in the demonstration stage (the second and third stages); it is possible to convince the government and the public with real-world operational data so that they have no objection to the 3R Test to be carried out by ACE4 HDTs on expressways nationwide in the L2 disengagement mode to step into the demonstration stage from the development stage provided that the ACE4 HDTs complete the 3R Testing at a level of one hundred million miles in the shadow mode at first (i.e., preliminary validation in the first stage); the safety and reliability when the Level IV fuel-saving robot performs the L3 DDT based on operational dimension reduction can be proven preliminarily and statistically in high confidence to earn the right of way for L3 business operation and the right of way for L4 Batch Validation only after the ACE4 HDT accumulates the 3R Testing data in the disengagement mode at a level of one billion miles and completes the L3 final validation (i.e., the second stage) successfully; the L4 final Batch Validation (i.e., the third stage) is considered to be completed only after tens of thousands of ACE4 HDTs (retrofitted or OEM) complete the L3 business operation mileage at a level of ten billion miles within two years and accumulate the Disengagement Report of L3 commercialization or L4 validation and the actual casualty rate (FaR and InR) data, so as to prove statistically with high confidence that the Level IV fuel-saving robot is safer and more reliable than human drivers when performing the L3 DDTs, and persuade the government and the public to amend relevant laws and regulations and allow ACE4 HDTs to carry out the commercialization of L4 autonomous driving system in volume in the true sense step by step on expressways nationwide. Similar to the five-year cumulative fuel cost of new HDTs, which is significantly higher than the purchase cost of the full vehicle, the Batch Validation expense shared by each ACE4 HDT is significantly higher than the L4 software and hardware system cost of the vehicle even if the high variable cost for Batch Validation of Level IV fuel-saving robot at a level of ten billion miles can be converted into low marginal cost to realize the cost reduction by 75%; the Level IV fuel-saving robot can be considered as a teacher and become the co-driver of the human driver once the ACE4 HDT earns the right of way for L4 commercialization from the government and the public and enters the stage of commercialization in volume. The additional economic value created by the Level IV fuel-saving robot for the fleets or human drivers after operation for one year is enough to cover all the hardware and software costs of the L4 system, and it can create significant and far-reaching impacts on the global trillion-dollar level long-haul freight industry.

Under the framework of current laws and regulations for regulating the sales and operation of HDTs in the USA, the different levels of rights of way for HAV HDTs, which correspond to L3 or L4 Batch Validation or business operation within the ODD of expressways, must be specially approved by the government; the classification of rights of way for all levels of fuel-saving robots is described as follows: similar to high school education for all the people, no special approval is required for the right of way for business operation of Level II fuel-saving robot (i.e., L2 ADAS system); the right of way for L3 3R Test is like undergraduate education; similar to graduating from a high school and being admitted into a university, the L2 3R Test in the shadow mode at a level of one hundred million miles is completed at first, then the L3 test right of way is earned from the government to enter the L3 3R Test stage in the disengagement mode; similar to graduating from a university with a bachelor's degree, the L3 3R Test in the disengagement mode at a level of one billion miles is completed to earn the right of way for L3 business operation and L4 test, then specific exemption can be obtained from the US government, the driver's driving time limit within every 24 hours can be gradually increased from 11 hours to 14 hours, and the labor productivity of drivers is increased by nearly 25%; similar to studying for a doctorate degree, the L4 3R Test in the disengagement mode (i.e., the L4 system operation is dimensionally reduced to L3 system before use) is started at the same time; similar to receiving a Ph.D. degree, the L4 3R Test at a level of ten billion miles in the disengagement mode is completed to prove with high confidence that the L4 AI drivers are indeed safer and more reliable than human drivers, and the right of way for L4 business operation is earned from the government; at this time, the ACE4 HDT can be operated by the human driver and the Level IV fuel-saving robot in turns, the human driver can get enough rest, the 24-hour day and night continuous driving can be realized, the driver's labor productivity is increased by more than 75%, the timeliness of thousand-mile level extra-long freight is greatly improved, the overall freight cost is significantly reduced, and it will have a revolutionary impact on the global long-haul freight industry. In China or Europe, the problem can also be handled by referring to the regulatory approach and the classification method of right of way in the USA, so that the government and other road traffic safety stake-holders can effectively balance the contradiction between promoting the commercialization of HAV HDTs in volume as soon as possible and practically ensuring the traffic safety of existing road users. In the three major automobile markets of the USA, China and Europe, there are small differences in the Batch Validation of L4 system within the ODD of expressways, and the global versatility of 3R Test data is strong; however, there are great differences in the Batch Validation of L4 system within the ODD for urban open roads, and the 3R Test data is highly regional and is basically not universal.

With the modern diesel HDTs operated by human drivers as the comparison benchmarks, the commercialization of L4 operation of ACE4 HDTs within the ODD of expressways is realized, and the Level IV fuel-saving robot can make the ACE4 HDTs safer, more fuel efficient and cleaner, while greatly improving the labor productivity of drivers and freight timeliness. From the perspective of technical pathway for R&D of ACE4 HDTs, a leap forward approach can be taken toward the R&D and commercialization of L4 system; however, from the perspective of legal supervision of 3R Test or commercialization in volume of ACE4 HDTs, a human life is of far greater value than everything else; “safety first”, we must be cautious and conservative, and proceed in an orderly way and step by step; governments in the world and the public will not agree to promote HAV HDTs to complete Batch Validation as soon as possible and enter large-scale commercialization at the cost of temporarily reducing the traffic safety of current highway road users; they will explicitly reject the flexible regulatory strategies of “opening the flood-gate to release water”, “mixing the good and the bad”, and “easy to get in, but hard to stay in”, large-scale 3R Tests are allowed to be carried out on public roads, including expressways, for various modified HAV HDTs, just like modified HAV passenger vehicles, the existing road users are changed into “small white lab rats” for the Batch Validation of the safety of AI drivers of HAV HDTs, and the hero will be judged by the final result of the Batch Validation at a level of one billion miles or ten billion miles; to ensure that the traffic safety of existing road users will not be temporarily compromised due to 3R Test of the HAV HDTs, the strict regulatory strategies of “hard to get in, and hard to stay in”, “national examination” and “upgrading” must be taken, different levels of right of way for HAV HDTs will be opened step by step according to the 3R Test data accumulated by HAV HDTs, which is similar to the learning and growth journey of young people from graduation from a high school to admission to an university to receiving a Ph.D degree. The Batch Validation (at a level of ten billion miles) of the safety and reliability when the Level IV fuel-saving robot performs the L4 dynamic driving tasks (DDTs) can be broken down into the following three different stages: L2 shadow mode stage at a level of one hundred million miles (i.e., the first stage), L3 disengagement mode stage at a level of one billion miles (i.e., the second stage of L3 Batch Validation), and L4 disengagement mode stage at a level of ten billion miles (i.e., the third stage of L3 commercialization and L4 Batch Validation); the three different stages mentioned above correspond to the following five different levels of right of way: 1) right of way for commercial operation of L2 system, which is similar to universal education and graduation from high school; 2) right of way for 3R Test of L3 system, which is similar to undergraduate education; 3) right of way for commercialized operation of L3 system, which is similar to graduation from a university and receiving a bachelor's degree; 4) right of way for 3R Test in the disengagement mode of L4 system, which is similar to taking part in the postgraduate entrance exams and studying for a doctorate; and 5) right of way for commercialized operation of L4 system, which is similar to receiving a doctor's degree. By implementing various combinations of multiple technical solutions including iSS, iPS, iMS, CGS, iCC, PACC and iSC, the ACE4 HDT and Level IV fuel-saving robot device of the present disclosure can optimize the power, safety and energy saving and emission reduction effect of the ACE4 HDT simultaneously; according to the three-stage implementation method of Batch Validation and the method for obtaining five levels of right of way mentioned above, the Batch Validation of Level IV fuel-saving robot at a level of ten billion miles is completed rapidly with high performance to cost ratio to prove with high confidence that the Level IV fuel-saving robot is safer and more reliable than human drivers when performing the L4 DDT, and the government and the public are persuaded to amend relevant laws and regulations to promote the ACE4 HDTs to enter the stage of large-scale commercialization at a level of 10,000 vehicles as soon as possible within the ODD of expressways nationwide. It should be emphasized that from the perspective of driving safety of HDTs, the difference between L4 systems of various developers is significantly greater than that between human drivers of HDTs with a Commercial Driver's License (CDL). The L4 system from a single manufacturer is preferred for a fleet of 10,000 ACE4 HDTs to complete the 3R Test at a level of one billion miles per year; otherwise, the universality or confidence level of statistical data of Batch Validation will be greatly reduced. Of course, the fleet of ACE4 HDTs can also install at least two sets of L4 systems from different manufacturers on each vehicle simultaneously to perform synchronous Batch Validation, so as to further share the marginal cost of Batch Validation and improve the validation efficiency. The evolution of the L4 HDT industry for long-haul freight in the future is likely to be similar to that of the civil aviation large aircraft industry, traffic safety is the most important thing, and the government will strictly control commercial access. The weak are knocked out, and the winner takes all. Finally, it is likely that only a few Big Players of L4 system of HDTs in all countries will remain in the market for long-term competition.

All the core subsystems or parts and components of the ACE HDT of the present disclosure are based on industrialized products and technologies. Compared with the HDT with a diesel engine in the prior art, the ACE HDT of the disclosure can achieve the beneficial effects of overall fuel saving ratio of 30% in the application of long-haul freight on expressways under the condition of ensuring the driving power, active safety, long-term compliance of RDE emission and attendance of the vehicles. ACE HDTs enable fleets or individual vehicle owners to recover the TCO difference (refers to the price difference of Total Cost of Ownership (TCO) between ACE HDT and traditional diesel HDT) within two years or 500,000 km by saving the fuel and M&R costs of the vehicles and improving the labor productivity of HDT drivers without any government subsidies. The mass production of new ACE HDTs (i.e., OEM ACE HDTs) can meet the 2025 carbon emission target value of Euro VII regulations issued by EU in 2019 and the 2027 carbon emission target value of the US GHG-II ahead of schedule. In USA, the average service life of a HDT (especially the chassis or frame) is up to 20 years or 1.5 million miles, a set of frame of each HDT may be configured with two to three sets of powertrains (engine+transmission; replaced after travelling about 600,000 miles) throughout the life cycle, and the second or third powertrain is mostly a remanufactured powertrain overhauled by an enterprise approved by the OEM. The average annual sales of new HDTs in North America is about 200,000, while the number of modified HDTs (i.e., second-hand HDTs with remanufactured powertrains) exceeds 200,000 every year. Thanks to the current system of regulatory laws and regulations for HDTs (adopting the strategy of “easy to get in, but hard to stay in”) in the USA, modified HDTs (including modifying the traditional HDT with an internal combustion engine into the ACE HDT) are allowed to be put into commercialized operation (L1/L2 system) directly in the US market without re-certification or re-approval by the government of the full vehicle; the fuel-saving robot for ACE HDTs of the present disclosure can also be used to modify and upgrade in volume the nearly 2 million second-hand traditional HDTs with internal combustion engines in the current US market to realize large-scale commercialization of modified ACE2 HDTs at a level of 10,000 vehicles in three years, so that a large number of modified ACE HDTs can, like new OEM ACE HDTs, achieve the 2027 carbon emission target value of the US GHG-II in advance, the fuel consumption (L/100 km) and emission of a large number of second-hand traditional HDTs in use can be significantly reduced, which is of great and far-reaching economic and social significance to the long-haul freight industry in the USA; and a solid foundation is laid for promoting the mass production and commercialization of OEM new ACE HDTs worldwide. It should be emphasized that China and Europe adopt the compulsory government certification system for the production and sales of all road vehicles, and the modification of second-hand hybrid HDTs is not feasible under the current legal framework in China or Europe; however, the early commercialization of the modified ACE HDT of the present disclosure in the USA will greatly promote the commercialization process of the OEM ACE HDTs in the USA, China or Europe.

Although the content of the present disclosure focuses on HDTs for long-haul freight, the technical problems to be solved, specific technical solutions, technical measures and beneficial technical effects of the present disclosure also apply to the operation of large mixed hybrid commercial vehicles (trucks or buses) with a total weight of more than ten tons; individual technologies or combined technologies, such as series-hybrid intelligent Stop Start (iSS), parallel-hybrid intelligent power switching (iPS), intelligent mode switching (iMS), Clutch-less Gear Shift (CGS), predictive adaptive cruise control (PACC), intelligent pulse heating (iPH), intelligent Comparison & Switching (iCS) and the like, also apply to duo-motor mixed hybrid light vehicles (with a total weight of less than four tons).

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a system block diagram of the ACE HDT of one embodiment of the present disclosure;

FIG. 2 illustrates a system block diagram of the electrical power split device (ePSD) of the ACE HDT of one embodiment of the present disclosure.

FIG. 3 illustrates a system block diagram of the Comparator of the ACE HDT of one embodiment of the present disclosure.

FIG. 4 illustrates a universal characteristic curve of the engine of the ACE HDT of one embodiment of the present disclosure.

FIG. 5 illustrates a terminal-channel-cloud system block diagram of network communication between the ACE HDT and cloud computing platform through the mobile Internet of one embodiment of the present disclosure.

In these figures, the same or similar reference symbols are used for representing the same or similar elements.

### DETAILED DESCRIPTION

A description of example embodiments follows.

The teachings of all patents, published applications and references cited herein are incorporated by reference in their entirety.

The following is the description of the embodiments by reference to some examples. It should be known that the description of these embodiments is only for those skilled in the art to properly understand the present disclosure and accordingly achieve the present disclosure, and are not hints of limitations to the present disclosure.

For example, the term “including” and the variants thereof should be interpreted as the open term of “including but not limited to”. The term “based on” should be interpreted as “at least partially based on”. The terms “an embodiment” and “a kind of embodiment” should be interpreted as “at least one embodiment”. The term “another embodiment” should be interpreted as “at least one other embodiment”. The terms “first”, “second” and the like can refer to different or the same objects. The followings may include other definite and implicit definitions. In this paper, “unidirectional” or “bidirectional” connection refers to whether the direction of the electric or mechanical power flow or energy flow flowing from the power source to the load is reversible or not, and whether the roles of the power source and the load can be exchanged with each other or not. During unidirectional connection, the roles of the power source and the load are fixed, and the power flow from the source to the load is unidirectional and irreversible; during bidirectional connection, the roles of the power source and the load can be switched, and the direction of power flow is reversible or bidirectional. Unless otherwise specified, all electromechanical parts, modules or devices in the present disclosure are of automotive grade. A vehicle engine includes an automotive-grade internal combustion engine or turbine motor, more than 95% of the HDTs in the world adopt a diesel engine, and a small portion of the HDTs adopt a natural gas engine. Both “Zhuan Ju” and “Niu Ju” in Chinese mean torque in English.

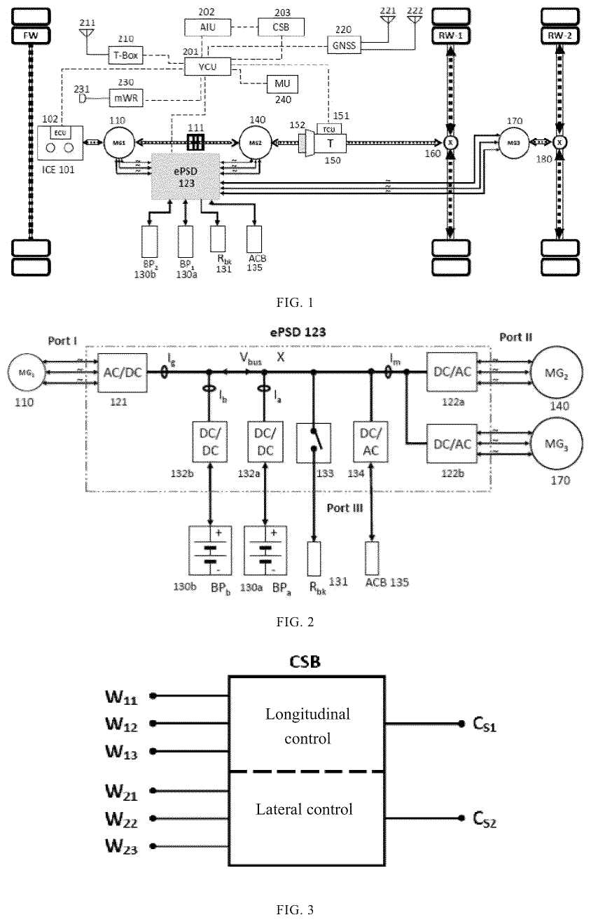

The following is the description of the basic principles and some embodiment of the invention by reference to the figures. FIG. 1 illustrates the mixed hybrid powertrain, vehicle control unit, core sensors and other devices of the ACE HDT 010 disclosed by one embodiment of the present disclosure. The system can be configured either as a 6×2 powertrain system with duo-motors (a generator (MG1) 110 in a hybrid P1 position and a primary driving motor (MG2) 140 in a hybrid P2 position), an active driving axle 160 and a passive (driven) driving axle 180, or as a 6×4 powertrain system with three motors (a generator (MG1) 110 in the hybrid P1 position, a primary driving motor (MG2) 140 in the hybrid P2 position, and an secondary driving motor (MG3) 170 in the P3 position), and two active driving axles 160 (primary driving axle) and 180 (auxiliary driving axle). In some embodiments, the HDT can be the hybrid HDT with the gross vehicle weight of larger than 15 tons for long-haul freight.

As shown in FIG. 1, generally, the mixed hybrid powertrain of the ACE HDT includes an engine 101, an engine control unit (ECU) 102, a generator (MG1) 110, an electrical power split device (ePSD) 123, a clutch 111, at least one primary battery pack 130a, a brake resistor 131, an automatic transmission (T) 150, a transmission control unit (TCU) 151, a flexible connector 152, at least one primary driving motor (MG2) 140, a vehicle control unit (VCU) 201, a primary driving axle 160 and an auxiliary driving axle 180. Wherein the primary battery pack 130a and the primary driving motor 140 are required (standard), while the auxiliary battery pack 130b and the secondary driving motor 170 are optional.

Specifically, the flywheel end of the engine 101 is connected with the mechanical shaft of the generator (MG1) 110 configured in the hybrid position P1 bidirectionally and mechanically, and controlled by the engine control unit (ECU) 102, and is mainly used for converting the chemical energy of onboard fuel such as diesel or natural gas into electric energy by the combustion working of the engine; the combination of the engine 101 with the generator 110 is called as a generator set. The flywheel end of the engine 101 and the mechanical shaft of the generator 110 are also connected with one end (also known as the driven end) of the clutch-by-wire 111 bidirectionally and mechanically, and the bidirectional and mechanical connection among the three (101, 110 and 111) is either single-axis coaxial rigid connection (coaxial connection for short) or multi-axis parallel plus gear rigid connection (parallel-axis connection for short). The coaxial connection is preferred, and such mechanical connection is the simplest and the most effective; however, the 100-kW level generator 110 requires large automotive-grade electrical motor with a large torque (with a peak torque of greater than 1,200 NM), a low speed (with a maximum speed of less than 3,000 RPM) and a high cost; the parallel-axis connection can also be preferred, at this time, the flywheel output end of the engine 101 is connected with one end of the clutch 111 directly, bidirectionally and mechanically, the more cost-effective 100-kW level generator 110 with a middle torque (with a maximum torque of less than 500 NM) and a middle-to-high speed (with a maximum speed of less than 12,000 RPM) can be optional, and the mechanical shaft of the generator 110 is connected with the flywheel output end of the above engine 101 and the driven end of the clutch 111 bidirectionally and mechanically through a heavy-duty reducer with a fixed gear ratio (4-8), but the reducer will increase the complexity, cost and reliability risk of the parallel-axis connection system.

As shown in FIG. 2, the electrical power split device (ePSD) 123 shown in FIG. 2 is a power electronics network (PEN) with three ports of 100-kW level nominal power, wherein the three-phase AC terminal of the 100-kW level inverter 121 in the port I (also known as the “first port”) of the ePSD is connected with the three-phase AC terminal of the external generator 110 bidirectionally and electrically; the external battery pack 130a or 130b is bidirectionally DC-connected with the low voltage terminal of the 100-kW level chopper (also known as DC-DC converter) 132a or 132b in the port III (also known as the “third port”) of the ePSD 123, respectively; the external 100-kW level brake resistor 131 is unidirectionally DC-connected with one end (external connection end) of the 100-kW level voltage-controlled switch (VCS) 133 in the port III. The externally optional 10 kW-level AC distribution panel 135 is connected with the AC terminal of the 10 kW-level inverter in the port III bidirectionally and electrically. The three-phase AC terminals of the external 100-kW level driving motors 140 and 170 are connected with the AC terminals of the 100-kW level inverters 122a and 122b in the port II (also known as the “second port”) of the ePSD bidirectionally and electrically; the DC terminals of the inverters 121, 122a and 122b are bidirectionally DC-connected with the DC bus junction point X in the ePSD; the other terminal of the 100-kW level voltage-controlled switch (VCS) 133 is unidirectionally DC-connected with the DC bus junction point X; the high-voltage terminal of the chopper 132a or 132b is bidirectionally DC-connected with the junction point X, respectively. The DC terminal of the inverter 134 is bidirectionally DC-connected with the junction point X.

As shown in FIG. 1, the output shaft of the automatic transmission 150 is connected with the input shaft of the primary driving axle 160 of the vehicle bidirectionally and mechanically, and controlled by the transmission control unit (TCU) 151. The mechanical shaft of the standard primary driving motor (MG2) 140 configured in the hybrid position P2 is connected with the other end of the clutch 111 bidirectionally and mechanically, and connected with the input shaft of the transmission 150 through the flexible coupling or clutch-by-wire 152 bidirectionally and mechanically. The drive end of the clutch 111 and the mechanical shaft of the driving motor 140 are also connected with the input shaft of the transmission 150 bidirectionally and mechanically, and the bidirectional and mechanical connection among the three (clutch 111, primary driving motor 140 and transmission 150) is either single-axis coaxial connection or parallel-axis connection. When the parallel-axis connection is adopted, the mechanical shaft of the driving motor 140 can be connected with the input shaft of the transmission 150 and the drive end of the clutch 111 bidirectionally and mechanically through the heavy-duty reducer with a fixed gear ratio. The optional secondary driving motor (MG3) 170 configured in the hybrid position P3 is connected with the input end of the second driving axle 180 bidirectionally and mechanically through the heavy-duty reducer. The standard primary driving motor (MG2) 140 or the optional secondary driving motor (MG3) 170 can be operated for converting the electric energy into the mechanical energy for driving the ACE HDT (electrical driving), or converting the mechanical energy of the ACE HDT into the electric energy (regenerative braking) to charge the battery pack 130a or 130b through the inverter 122a or 122b and the chopper 132a or 132b in the ePSD 123, so that the energy can be effectively recovered. The secondary driving motor (MG3) 170 may not be selected with focus on reducing the system cost and the complexity.

As one of the key components of the present disclosure, the vehicle control unit (VCU) 201 and AI unit (AIU) 202 of the ACE HDT work cooperatively, equivalent to the brain and cerebellum of the fuel-saving robot, so that the time-space function of vehicle road-load power in the electronic horizon can be predicted at a refreshing frequency of higher than 1 Hz and a kW-level granularity by using the vehicle dynamics equation (1-1) according to the vehicle-mounted data bus (as indicated by the dotted line in FIG. 1 and without marker; such as CAN bus or virtual data cable for wireless communication) based on the vehicle locating and 3D position data (longitude, latitude and longitudinal slope) measured by the onboard Global Navigation Satellite System (GNSS) 220, the electronic horizon priori road 3D data, vehicle configuration parameters and dynamic work condition data (such as vehicle speed and vehicle acceleration) stored in the map unit (MU) 240, vehicle longitudinal drive-by-wire signals (reflecting the driving intention of a human driver or AI driver) and other information; and one or more of the above engine 101, generator 110, ePSD 123, clutch 111, driving motors 140 & 170, automatic transmission 150 and battery packs 130a & 130b can be dynamically controlled separately or simultaneously in an “independent” manner according to the machine learning (ML) for optimizing the vehicle fuel consumption and emission.

In some embodiments, the VCU 201 can be an automotive-grade high-performance embedded single-core or multi-core microprocessor. Similar to the graphic processing unit added to the early personal computer to enhance the image processing performance of the overall unit, the VCU 201 can also use the plug-in vehicle-end AI inference chip (AIU) 202 (also known as an AI processor) to improve the artificial intelligence (AI) inference computing capability when executing the energy-saving and emission-reduction machine learning algorithms on the ACE HDT 010; and at the same time, the AIU 202 can also be upgraded to a hardware computing platform that supports the L4-level autonomous driving software stack. It should be known that, non-restrictively, the VCU 201 or AIU 202 can be also an isomeric microelectronic hardware logic unit, including a general-purpose microprocessor (CPU), a field-programmable gate array (FPGA), a graphic processing unit (GPU), an application-specific integrated circuit (ASIC), a digital signal processor (DSP), a system on chip (SOC), a complex programmable logic device (CPLD), etc.

Preferably, the engine 101 is a six-cylinder HDT diesel engine or natural gas engine with a displacement of 9 L to 13 L and a peak power between 260 kW and 350 kW; the engine with a larger displacement (13 L-16 L) can also be selected, its peak engine power can be higher than 400 kW and there will be more power reserve, so that the vehicle gradeability performance is better when the vehicle encounters an uphill road condition on a highway (climbing a hill for more than ten kilometers in length, with a longitudinal slope of greater than 2.0 degrees), but the fuel saving effect has no advantage over that of the preferred engine, the engine volume, weight and cost are obviously increased, and the cost effectiveness is suboptimal; the engine with a smaller displacement (lower than 9 L) can also be selected, generally with a peak power of less than 300 kW; though the fuel saving effect can be slightly better and the engine volume, weight and cost are lower, the engine power reserve in this case is insufficient; if the electric charge in the battery pack is exhausted and it is impossible to continue to supply sufficient electric power for the driving motor when the vehicle encounters a large upslope condition on a highway, the gradeability performance of the ACE HDT 010 will be noticeably insufficient, and the vehicle cannot continue to go up a slope at speed until it is shifted into a lower gear and slowed down; in addition, analogous to a small horse to pull a large wagon, which is unfavorable to the long B0 life (1,000,000 km) of the engine, and the cost effectiveness is suboptimal. It should be known that, optionally, the engine 101 can also be a on-vehicle gas turbine meeting the above power requirements. The gasoline engine is obviously inferior to the diesel engine in terms of thermal efficiency of combustion, low speed high torque and service life (kilometers for B10 life), so it is not suitable for HDTs for long-haul freight.

It is noted that, as shown in FIG. 1, in the embodiments of the present disclosure, the ACE HDT powertrain system operates in a series-hybrid mode when the clutch 111 is disengaged (off); no mechanical connection between the engine 101 and the driving axle 160 or 180 of the vehicle is provided at this time, and accordingly the operating conditions of the engine 101 and that of the vehicle are decoupled completely, so that the engine 101 can stably work at several operating points (specified speed/torque) specified in the high efficiency zone (including the optimal fuel efficiency range and/or the optimal emission range) of the universal characteristic curve for a long time. When the clutch 111 is engaged (on) and locked, the ACE HDT powertrain is switched to operate in the parallel-hybrid mode; at this time, the engine 101 is directly connected with the active driving axle 160 or auxiliary axle 180 of the vehicle through the transmission 150 bidirectionally and mechanically, the speed of the engine 101 is jointly determined by the vehicle speed and the gear of the transmission 150, and the output torque of the engine 101 can still be dynamically adjusted independently and is not subject to the driving conditions of the vehicle; therefore, the output power of the engine is still independently adjustable, but at this time the engine is in an operating condition line rather than an operating condition point in the high efficiency zone of the universal characteristic curve. Under expressway operating conditions, the engine can always work in its high efficiency zone stably by the gear shifting strategy of the transmission. The combined nominal power of the generator 110 (MG1) and the driving motor 140 (MG2) is greater than the peak power of the engine 101, and in the parallel-hybrid mode, the peak load shifting of the vehicle instantaneous road-load power can be absolutely realized by dynamically adjusting the total driving power of the dual motors (110 & 140) according to the parallel-hybrid power equilibrium equation set (3-1) & (3-2) to satisfy the vehicle dynamics equation (1-1) in real time. For a basic on-off control strategy of the drive-by-wire clutch 111, the parallel-hybrid mode (clutch engaged) is preferred under expressway operating conditions (an average speed over 50 km/h; infrequent active acceleration or braking); the series-hybrid mode (clutch disengaged) is preferred under urban operating conditions or driving on a congested expressway (with an average speed of less than 45 km/h; frequent active acceleration or braking). The above-mentioned intelligent mode switching (iMS) strategy can also be preferred as the advanced intelligent dynamic control strategy of the drive-by-wire clutch 111, and the actual energy-saving and emission-reduction effects of the iMS strategy is superior to that of the on-off control strategy, which will be explained in details later.

The difficulty in the electronic control of the traditional engine of HDTs is the simultaneous optimization of multiple contradictory targets such as engine power, fuel saving, emission behavior and cost under global area operating conditions (all speed and torque ranges) to meet the increasingly stringent emission regulations (pollutant and carbon emissions) of all countries in the world; over the past two decades, the global modern mass-produced HDT engines have an accumulated improvement rate of less than 15% in terms of minimum brake specific fuel consumption (BSFC; g/kWh) or brake thermal efficiency (BTE; %), or actual comprehensive fuel consumption (L/100 km), and the bottleneck of technology and production process has been encountered. If the operating range of the engine can be changed from the global area operating conditions to the point operating conditions or line operating conditions with a limit range, it will open up a new field (new technological route) to break through the current upper limit (46%) of brake thermal efficiency (BTE) of the HDT engines that can be mass-produced and optimize the fuel consumption and emissions to the maximum extent at high cost-effectiveness through technological innovation; at the same time, it is also possible to effectively cope with the severe challenges of surging complexity and product costs of design, calibration and manufacturing of the engine body, ECU and exhaust after-treatment system (ATS) of HDTs in order to meet the stricter new mandatory regulations on emissions (pollutant and carbon emissions) for internal combustion engine vehicles continuously issued by all countries in the world in the next 20 years.

Compared with a spark-ignition (SI) gasoline engine, a compression ignition (CI) diesel engine, with the advantages of fuel saving, large torque at low speed, practicality, durability, ultra-long life (B10 life is longer than 1,000,000 km) and high cost effectiveness, becomes the preferred engine for most HDTs (exceeding 95%) in the world. However, in the aspect of pollutant emissions, especially pollutant emissions of nitrogen oxides (NOx) and particulate matter (PM) harmful to atmospheric environment and human health, the diesel engine is inferior to the gasoline engine. The world's mainstream after-treatment technologies that meet the EPA-2010, Euro VI and China BG-6 mandatory regulations on engine emission for reducing exhaust pollutant NOx and PM emissions from the diesel engines of HDTs include selective catalytic reducer (SCR) and diesel particulate filter (DPF), and the catalyst in the after-treatment system can work normally and efficiently provided that the working temperature (i.e., the exhaust temperature) inside the SCR and the DPF reaches the specified high temperature (Light-off) above 250° C.; when the exhaust temperature is lower than 200° C., the catalytic conversion efficiency of the catalyst is greatly reduced, and the tail-pipe emissions of engine pollutants will be greatly increased; low-temperature catalysts with a working temperature of 150° C. are still in the early stage of laboratory research in Europe and the USA, and the time to mass production should be calculated in decades. Both the pollutant emissions and specific fuel consumption (g/KWh) of the diesel engine are greatly increased in a short term during cold start, low-load operation, or instantaneous substantial changes of output power; while the engine can work steadily in the high efficiency zone of its universal characteristic curve under the working condition of expressways, and both the pollutant emissions and the specific fuel consumption of the diesel engine are small at the moment. For the traditional HDT, it is difficult to optimize both the fuel consumption and the pollutant emission within the whole range of speed/torque of the universal characteristic curve of the engine. Through the Intelligent Stop Start (iSS) control of the engine in the series-hybrid mode or the Intelligent Power Switching (iPS) control in the parallel-hybrid mode, the ACE HDT of the present disclosure enables the engine 101 to stably work at least one optimal operating point or at least two high and low-state power condition lines within the high efficiency zone of the universal characteristic curve of the engine 101, so that engine cold start, low-speed or low-load idling and other instantaneous conditions outside the high efficiency zone are basically eliminated; while the specific fuel consumption and carbon emissions are reduced, the engine exhaust temperature can also be effectively elevated and maintained, so that the after-treatment system of the engine 101 can stably work in the high-temperature and high-efficiency zone (above 250° C.) to reduce the emissions of pollutants (NOx, PM) and realize the beneficial effect of simultaneously minimizing fuel consumption and emissions. Meanwhile, due to the high temperature and low NOx content in the engine-out exhaust of the ACE HDT, its SCR system can also reduce the urea consumption (g/100 km), and the operating cost of the ACE HDT can be further reduced accordingly; moreover, the both the diesel engine and the diesel particulate filter (DPF) of the ACE HDT can also work steadily in their own high efficiency zone for a long time, and the DPF system active regeneration performed by periodic mandatory parking for 30-45 min and the idling of the diesel engine by injecting excessive diesel is basically avoided to eliminate the long-term shortcoming of consuming more time and more fuel caused by the deposition of a large number of particles inside the DPF for industrial users, thereby further reducing the fleet operating cost and improving the freight efficiency.

Different from the traditional HDT with diesel engine, the engine of the ACE HDT can have the functionality of clean cold start (CCS). When the ACE HDT is cold started after long-term parking outdoors (for more than 10 hours) in a severe cold region (with an ambient temperature below −10° C.), the preheating time for the cold start is preset by the driver, the vehicle VCU instructs the drive-by-wire clutch 111 to disengage, and then the vehicle enters the series-hybrid mode; by using the 10 kWh level effective DC power of the battery pack, the 100-kW level ePSD 123 completes the inversion and outputs alternating current; after the SCR module of the exhaust after-treatment system is rapidly heated to 250° C. at a minute level through the onboard electrically heated catalyst (EHC) with the power of tens of kilowatts, the generator 110 (MG1) in the electric driving mode drags the engine 101 to rotate under the non-combustion condition to a specified idle speed of 500 RPM-800 RPM, followed by the first fuel injection, compression ignition and work, and series hybrid intelligent stop start (iSS) control is performed on the engine; the duration (i.e., “Light-off Time”) from the cold start and ignition of the engine to the time that the exhaust after-treatment system reaches its high efficiency operating temperature is greatly reduced by more than 75%, and the pollutant emission can be reduced by more than 75% compared with that of the traditional diesel engine HDT during cold start; in order to achieve ultra-low emission diesel engines, and reduce pollutant emission limits by more than 80% based on the current EPA-2010 or China-VI emission regulations, the above CCS function must be adopted. During cold start of the traditional diesel engine HDT, the gear is engaged and the vehicle starts to run only after the vehicle is parked to warm up the engine at idle speed for several minutes (i.e., warm-up time); the warm-up time of the SCR module of the exhaust after-treatment system for parking and warm up during clean cold start (CCS) of the ACE HDT is less than the warm-up time of the traditional HDT, so that the work of the driver will not be delayed, and the warm-up start time can also be preset by the software; it should be emphasized that within the warm-up time during parking of the ACE HDT to heat the engine after-treatment system, the engine 101 and the generator 110 do not work, neither the driving motor 140 nor the driving motor 170 works, and the vehicle has no vibration or noise; power can be temporarily supplied by the battery pack, the AC terminal of the inverter 122a or 122b with 100-kW level nominal power contained in the ePSD 123 can be utilized to supply power to the onboard electrically heated catalyst (EHC) at the level of tens of kilowatts, so that the temperature of the SCR module can be rapidly elevated from minus tens of degrees Celsius to 250° C. in minutes, and the VCU 201 can automatically adjust the operating power consumption and time of the electrically heated catalyst (EHC) according to the data of the ATS temperature sensor. The vehicle after-treatment system is protected by a thermal insulation layer, and the holding time is of a sub-hour level due to the higher heat capacity of the system; once the engine enters stable operation, the sub-minute low-state (non-combustion) operation of its PWM pulse sequence will not work, and as a result, the operating temperature of the catalyst inside the after-treatment system (ATS) is reduced to below 250° C.; when the engine is hot started or the low-state condition of the PWM pulse sequence is switched to the high state condition, the EHC does not need to turn on the electric heating function, and at that time, the after-treatment system (ATS) can maintain high temperature and operate efficiently and stably.

For most domestic engine and key powertrain component suppliers with insufficient technological accumulation, the Limits and Measurement Methods for Emissions from Light-duty Vehicles (China BG-6) coming into force in China in 2021 for heavy-duty diesel trucks are huge technical and business challenges. Under the condition of ensuring that the full vehicle reaches and continuously meets the requirements of China BG-6, especially the warranty period of the 700,000 km for the RDE discharge system when leaving the factory, the technical performance requirements of the diesel engine of the ACE HDT of the present disclosure are much lower or relaxed than the general technical requirements of traditional heavy-duty diesel trucks after dimensional reduction from overall area operating condition to point operating condition or line operating condition within the high efficiency zone of the engine, providing new opportunity for the commercial implementation of multiple new and concise technological lines with high performance to cost ratio technologies, and providing another new field for survival and development of Chinese suppliers of HDT powertrain and key component in the later period of China BG-6.

The power of the motor is directly proportional to the product of its speed and torque, and the volume, weight and cost of the motor have highly positive association with its maximum torque. Hybrid or electric passenger vehicles (with a gross weight of less than 3.5 tons) mostly adopt middle-sized automotive-grade motors with a high speed (with peak value of greater than 12,000 RPM) and a low torque (with peak value of less than 350 NM); hybrid HDTs usually use large-sized automotive-grade motors with a low speed (with peak value of less than 3,000 RPM) and a high torque (with peak value of greater than 1,500 NM). For example, both the large-sized motor I with a speed of 1,200 RPM and a peak torque of 2,000 NM and the small-sized motor I with a speed of 12,000 RPM and a peak torque of 200 NM have a nominal power of 251 kW; however, the volume, weight and cost of the motor I are obviously higher than those of the motor II. Compared with the applications of passenger vehicles, the ACE HDT has less restrictions on the volumes and weights of motor, battery pack and other subsystems, but both the passenger vehicles and the ACE HDT are highly sensitive to their costs. The annual production and sales of new energy vehicles of passenger vehicles are nearly 30 times higher than those of HDTs. Currently, most nominal power of high-speed and low-torque motors used in new energy passenger vehicles is less than 175 kW, and the unit cost (USD/kW) is obviously decreased year by year with the increase of production; however, for the low-speed and large-torque motors with the nominal power of greater than 200 kW used in large-sized new energy commercial vehicles (with a gross weight of greater than 15 tons), the unit cost (USD/kW) will still be high, and it is hard to reduce significantly year by year. New energy passenger vehicles or HDTs have basically the same requirements for IGBT or SiC and other electrical and electronic core devices, and the devices of the same voltage platform can be in common use. If the hybrid HDT keeps close, or partial overlapping, to the requirements of new energy passenger vehicles in terms of model selection (especially in voltage platform, peak torque and peak power) of three major electrical systems (motor, battery and electric control), it will be in favor of cost reduction as well as quality and supply guarantee for the three major electronic systems of the ACE HDT year by year by making full advantage of the economy of scale effect of the mature supply chain of the new energy passenger vehicles.

Preferably, for the embodiment in FIG. 1, the standard generator (MG1) 110 is a permanent magnetic synchronous motor (PMSM) with nominal power of 150-225 kW, and the AC induction motor or reluctance motor meeting the above requirements for nominal power can also be selected; the primary driving motor (MG2) 140 is preferably a permanent magnet synchronous motor with the nominal power of 175-250 kW, and the AC asynchronous motor or reluctance motor of the same power specification can also be selected; the optional secondary driving motor (MG3) 170 is preferably a permanent magnet synchronous motor with the nominal power of 125-200 kW, and the AC asynchronous motor or reluctance motor of the same power specification can also be selected. The ACE HDT can still work normally when the nominal power of the three motors (110, 140 and 170) exceeds the above preferred parameter range respectively in various embodiments in FIG. 1; the motor cost, volume and weight are reduced when the nominal power is lower than the preferred lower limit, but the power and fuel saving ratio of the vehicle will also be significantly decreased; the power and fuel saving ratio of the vehicle will be improved when the nominal power is higher than the upper limit, but the motor cost, volume and weight are significantly increased; all are the second-best choices. The peak power (10 s pulse) of the motor or battery pack is obviously higher than its continuous nominal power, with an overload rate within 10 s reaching over 150%.

The electrical power split device (ePSD) 123 shown in FIG. 2 is an power electronics network (PE) with three ports and 100-kW level nominal power, wherein the power electronics network includes at least two insulated gate bipolar transistors (IGBT) or silicon carbide (SiC) power modules, but can exclude any power source or electric energy storage device. Various power electronics circuit topology designs are available to achieve the input/output characteristic of the three-port network and the functions of various internal subsystems. It should be noted that the present disclosure is not intended to limit the implementation of specific circuit topology of a three-port PE network including the IGBT or SiC power module, but all power electronic circuit topology designs capable of realizing the key input/output functions and characteristics of the ePSD 123 described in the present disclosure should fall into the range of the present disclosure. In view of the integrated design flexibility of the power electronics modules, the inverters 121 and 122a&b, the choppers 132a&b and the voltage-controlled switch (VCS) 133 inside the ePSD 123 can be either integrated in one metal box, or distributed in multiple metal boxes, and packaged and arranged in a decentralized way in order to improve the system performance and/or reduce the cost. At present, IGBT is the most cost-effective global mainstream automotive-grade power electronic power module; the SiC power module is a rising star with better performance but higher cost in the near future, and its commercial proportion will increase year by year with the increased production of SiC. The IGBT modules mentioned in the present disclosure can generally refer to various industrialized power electronic power modules, including IGBT or SiC.

In the embodiment shown in FIG. 2, the AC port of the inverter 121 in the port I of the ePSD is connected with the three-phase AC output end of the external generator (MG1) 110 bidirectionally and electrically; the AC port of the inverter 122a in the port II is connected with the three-phase AC output terminal of the external primary driving motor (MG2) 140 bidirectionally and electrically, and the AC port of the inverter 122b is connected with the three-phase AC output end of the external secondary driving motor (MG3) 170 bidirectionally and electrically; the low-voltage end of the chopper 132a connected in the port III is DC-connected with the external battery pack 130a bidirectionally and electrically; and the low-voltage end of the chopper 132b is DC-connected with the external battery pack 130b bidirectionally and electrically. The DC ends of all the inverters (121, 122a and 122b) are DC-connected to the DC bus junction point X of the ePSD bidirectionally, and the high-voltage ends of all the choppers (132a and 132b) are also DC-connected to the DC bus junction point X in the ePSD bidirectionally and electrically. One end of the voltage-controlled switch (VCS) 133 with 100-kW level nominal power is DC-connected with the junction point X unidirectionally and electrically, and the other end is DC-connected with the external 100-kW level brake resistor 131 with a radiator electrically. The DC end of the 10 kW-level inverter 134 is connected with the DC bus junction point X bidirectionally and electrically, and the AC end of the 10 kW-level inverter 134 is connected with the external AC switchboard 135 bidirectionally and electrically.

Preferably, the IGBT power module is adopted to realize the voltage-controlled switch 133, and a DC voltage triggering method is adopted to control the on or off of the voltage-controlled switch; the control method is defined by software and dynamically adjustable, so it is called a voltage-controlled switch. The implementation method of the “intelligent voltage-controlled switch” (iVS) control strategy is as follows: Vₒₙ=(1+kₒₙ)V_{bus0}; V_{off}−(1+k_{off})V_{bus0}; where Vₒₙ is an ON voltage threshold, and V_{off} is an OFF voltage threshold; V_{bus0} is nominal voltage of the DC bus, with a preferred range of 600 V-750 V; kₒₙ is a bias coefficient for ON, with a preferred range of 2%-10%; k_{off} is a bias coefficient for OFF, with a preferred range of −5% to +2%; kₒₙ and k_{off} are defined by software and can be adjusted dynamically; when the DC voltage of the junction point X is equal to the ON voltage Vₒₙ, the voltage-controlled switch 133 can switch from the off state to the on state with a millisecond response time and maintain the on state, so that the brake resistor 131 can become the effective electrical load of the ePSD 123; when the DC voltage of the junction point X is equal to the OFF voltage V_{off}, the voltage control switch 133 can switch from the on state to the off state with a millisecond response time and keep the off state. When the instantaneous state of charge (SoC) function value of the battery pack 130a or 130b exceeds the upper red line (URL), the chopper 132a or 132b will quickly cut off the charging path to the battery pack (at a 10-millisecond level) in order to protect the battery pack; but at this time, if the ACE HDT still needs the regenerative braking function of the driving motor 140 or 170, and if the alternating current generated by the regenerative braking suddenly loses the effective electrical load, the DC voltage at the junction point X will rise sharply instantaneously and exceed the breakdown voltage (i.e., 1,200 V) of the IGBT module, the instantaneous “extreme pulse voltage condition” occurs, which may cause permanent damage to each IGBT module or other electronic components in the ePSD 123. It should be emphasized that the intelligent Voltage-controlled Switch (iVS) control strategy can not only turn on the brake resistor 131 when the battery packs 130a&b are basically full (the SoC reaches the URL) to provide the steady-state vehicle non-friction retarding function, but also provide another important instantaneous over-voltage protection function to avoid the serious failure modes such as tripping interrupting work or permanent damage (especially the overvoltage breakdown damage to the IGBT) of the main electronic components with the IGBT modules inside the ePSD 123, such as inverters 121, 122a and 122b and choppers 132a and 132b, under some extreme conditions of the ePSD 123. The nominal power of the voltage-controlled switch 133 is preferably in a range of 200 kW to 350 kW; the nominal power of the corresponding brake resistor 131 should be less than the nominal power of the voltage-controlled switch; in terms of increasing the system redundancy and reducing the costs, two sets of voltage-controlled switches with the nominal power of about 150 kW and the matched brake resistors are preferably connected in parallel to realize the voltage-controlled switch (VCS) function with a total nominal power of 300 kW.

When the nominal voltage V_{bp} of the battery pack 130a or 130b is equal to the nominal voltage V_{bus0} of the DC bus of the ePSD, in order to simplify the system and reduce its cost, it can be considered to omit the chopper 132a or 132b and directly connect the battery pack to the junction point X bidirectionally and electrically; however, the nominal voltage of the battery pack must be equal to the nominal voltage of the DC bus, and the battery pack will also lose the flexibility and the capability to adjust the 100-kW level instantaneous charge-discharge power; moreover, the ePSD 123 also loses the capability of flexibly matching various battery packs with high performance to cost ratio and different nominal voltages through software definition (on-site or OTA remote iteration); and it is a suboptimal option. The battery pack 130a or 130b is one of the most expensive subsystems of the ACE HDT, as well as a potential weak spot of the performance, reliability and durability of the full vehicle, and its high-rate partial state of charge (HRPSoC) characteristic curve and cycle life are highly correlated with data of dynamic operating conditions, such as state of charge (SoC) and cell temperature; another benefit of adopting the chopper 132a or 132b is that the instantaneous charging and discharging rates of the battery pack (132a or 132b) can be quickly adjusted (delayed at a 10-millisecond level) according to the cell HRPSoC digital characteristic curve list provided by the battery pack supplier, the working condition data of the cell (SoC and temperature), and the dynamic working condition data of the ACE HDT, so that the battery pack can work steadily for a long time within the high efficiency zone to achieve the beneficial effect of optimizing the performance and cycle life of the battery pack.

The DC bus junction point X in the ePSD 123 of the present disclosure is the nerve center for the power network of the hybrid powertrain of the ACE HDT; the unique DC voltage time-varying function at this junction and a set of the DC current time-varying functions of all inlet/outlet branch circuits mathematically describe the dynamic working state of the electric power loop of the ACE HDT completely; and thus the DC bus junction point X is the key point of energy saving, emission reduction and safety control for the operation of the ACE HDT. The junction point X is a point in circuit topology, but it can be realized by multiple physical methods, for example, it may be a metal busbar or a section of multi-joint high-power cable.

The ePSD 123 can dynamically adjust the path, amplitude and direction of electric power flow in a 10 millisecond-level response time and at a 100-kW level nominal power amplitude among its three ports through the digital control over several major power and electronic functional modules (i.e., inverters 121, 122a&b, 134; choppers 132a&b; VCS 133), integrate the mechanical power flow with the electric power flow according to the series-hybrid power equation (2-4) or the parallel-hybrid power equation (3-3), dynamically match the time-varying function of road-load power Pᵥ, and satisfy the vehicle dynamics equation (1-1) in real time. Thus, the drive-by-wire clutch 111 and the ePSD 123 are jointly controlled by the VCU 201 and the AIU 202 according to the energy-saving and emission-reduction machine learning algorithms, enabling smooth switching (i.e., intelligent mode switching (iMS)) between the two different working modes: series-hybrid iSS and parallel-hybrid iPS; and the fuel consumption and emissions of the engine are optimized (i.e., minimized) under the condition of meeting the vehicle driving driving performance, safety and freight timeliness. The frequency of switching between the series-hybrid mode and parallel-hybrid mode of the vehicle is low under the application of long-haul freight for the ACE HDT, and it is switched for less than 20 times per 100 miles.

Optionally or additionally, the ePSD 123 can be further provided with a plurality of sensors and memories so as to measure and record a time sequence of dynamic voltage V_{bus}(t) and currents I_{g}(t), Iₘ(t) and I_{b}(t) at the DC bus junction point X at the measuring frequency of not lower than 5 Hz, and the time sequence, serving as a part of the fuel saving data set, is uploaded to the cloud computing platform 001 for storage through the vehicle-mounted wireless communication gateway 210 in time for subsequent analysis and processing. The following is the detailed description of the implementation mode of the fuel saving data set.

It is known that the electric power equilibrium equation at the DC bus junction point X in the ePSD 123 is as follows:

P_{g}+P_{bat}+Pₘ+P_{br}=0 (4-1),

where P_{g}ϵ[−P_{igx},P_{igx}], P_{bat}ϵ[−P_{bx},P_{bx}], Pₘϵ[−Pᵢₘₓ,Pᵢₘₓ]. P_{igx} is the peak power of the inverter 121, P_{bx} is the aggregated peak charge-discharge power of the primary battery pack 130a and the auxiliary battery pack 130b, Pᵢₘₓ is the aggregated peak power of inverters 122a and 122b, P_{bx}>Pᵢₘₓ>P_{igx}. P_{g} is an instantaneous electric power time-varying function of the generator (MG1) 110 and is controlled by the inverter 121, and P_{gx} is its peak power (P_{igx}>P_{gx}), the positive value is the driving power (electric energy into mechanical energy), and the negative value is the gen-set power (mechanical energy into electric energy); P_{bat} is an aggregated instantaneous electric power time-varying function of the battery packs (130a&b) and controlled by the choppers (132a & b), the positive value is the charging power (electric energy into chemical energy), and the negative value is the discharging power (chemical energy into electric energy); Pₘ is an aggregated instantaneous electric power time-varying function of the active driving motor (MG2) 140 and the secondary driving motor (MG3) 170 and controlled by the inverters 122a&b, Pₘ is its peak power (Pᵢₘₓ>Pₘₓ), the positive value is the driving power (electric energy into mechanical energy), and the negative value is the regenerative braking power (mechanical energy into electric energy, recovered energy); P_{br} is the instantaneous electric power time-varying function of the brake resistor 131, it is a nonnegative number under control of the voltage-controlled switch 133, and the peak power is not lower than the peak power of the active driving motor (MG2) 140. In the present disclosure, the peak power is the maximum continuous mechanical power for the engine unless specially noted; the peak power refers to the maximum pulse electric power in 10 or 15 s for the motor, inverters, choppers or battery packs, and it is obviously higher than the nominal power (i.e., the maximum continuous electric power).

The embodiment of the present disclosure is described by focusing on the scenario in which there are only the standard primary driving motor (MG2) 140 and primary battery pack 130a. If the ACE HDT system further includes the optional secondary driving motor (MG3) 170 and/or the auxiliary battery pack 130b, it is easy for ordinary technicians in the industry to extend the description. It is preferred to engage the clutch 111 to realize the parallel-hybrid mode for the ACE HDT under high speed conditions (the average speed is above 50 km/h, with few active acceleration or braking); it is preferred to disengage the clutch 111 to realize the series-hybrid mode under urban/suburban conditions and on congested expressways (the average speed is below 45 km/h, with frequent active acceleration or braking). For vehicle driving safety and power considerations, the parallel-hybrid mode should be preferred regardless of average speed when the ACE HDT is climbing an upslope or mountain (the absolute value of longitudinal slope is greater than 2.0 degrees, the continuous uphill or downhill journey is more than 5 km). In the application of long-haul freight, nearly 90% of mileages are high speed conditions, and the clutch 111 of the ACE HDT does not need to be switched frequently. Thanks to dynamic coordination of the dual motors (MG1 and MG2), both of them can control the speed or torque rapidly and accurately, neither obvious interruption of driving torque nor a sense of vehicle driving frustration will occur to the ACE HDT powertrain in the second level transition period of switching between engaged and disengaged states of the clutch 111, and the vehicle power and NVH performance are obviously better than the HDT with internal combustion engine in the existing technology.

The battery packs 132a&b are the most expensive subsystems in the ACE HDT, and also the potential weaknesses in driving performance, reliability and durability (i.e., long life) of the complete ACE HDT, so the cost-effective design of battery packs is very important. The technical requirements for power-type battery packs of ACE HDTs are obviously different from those of hybrid light-duty vehicles. The ACE HDT has no hard limit on the volume and mass of battery packs with a total capacity of tens of kilowatt-hours, but has higher requirements on high and low temperature resistance (ambient temperature range: −30° C. to +50° C.) and shock resistance of battery packs, especially has very high requirements on the equivalent deep DoD cycle life (i.e., the equivalent number of full charge and full discharge; 100% DoD) of battery packs under high-rate partial state of charge (HRPSoC) conditions. For example, the battery pack of the ACE HDT has an accumulated charge throughput of more than 300,000 kWh in the full life cycle; if the effective capacity of the power-type battery pack is 30 kWh, the continuous charge-discharge rate of the battery pack is higher than 5C, the peak (10 seconds) charge-discharge rate is higher than 12C, and the equivalent deep cycle life is higher than 12,000 times considering the end of life (EOL) decay rate of 20%.

By mixing and matching lithium titanium oxide (LTO) primary battery pack 130a (with a capacity of 10˜20 kWh) with high performance (low-temperature high-rate charge/discharge), ultra-long life and high cost and the low-cost LFP or NCM auxiliary battery pack 130b (with a capacity of 20˜50 kWh), the cost effectiveness of ACE HDT system can be optimized according to the specific application of the ACE HDT 010. The LTO primary battery pack 130a is cold-resistant and can be involved in high-rate charge/discharge work immediately after cold start of the vehicle parked outdoors for more than 10 hours in winter (below minus 10° C.). At this time, the auxiliary battery pack 130b with LFP or ternary lithium cell is controlled by the chopper 132b and can be not involved in work or works at low C-rate temporarily. After the internal cell of the auxiliary battery pack 130b is heated to above 10° C. after the vehicle runs for more than ten minutes, the auxiliary battery pack 130b is involved in high C-rate work. The battery packs 130a&b are the most expensive subsystems in the ACE HDT. Mixing and matching two or more battery packs with different electrochemical cells is good for improving the overall performance of battery packs, reducing the total cost of battery packs and crucial to optimize the performance-to-cost ratio of the ACE HDT. Through a pulse-width modulation (PWM) technology and software definition and over-the-air (OTA), the chopper 132a or 132b can adjust the charge-discharge current value of the battery pack 130a or 130b dynamically and continuously according to the charge-discharge characteristic curve and various protective limitations of the battery cell at different temperatures, and optimize the performance, charge throughput and equivalent cycle life of the battery pack under the premise of satisfying the driving performance of the complete ACE HDT.

The single cell voltage of the LTO is only 2.2 V, which is lower than the single cell voltage 3.3 V of the LFP and the single cell voltage 3.7 V of the NCM. For battery packs with the same capacity (kWh), when the high-voltage battery pack solution (more cells connected in series and less cells connected in parallel; the nominal voltage is about 650 V) is compared with the low-voltage battery pack solution (more cells connected in parallel and less cells connected in series; the nominal voltage is about 400 V), the former is complex in design and control of the battery management system (BMS), high in material and manufacturing cost of the complete battery pack, and poor in system redundancy and robustness; while the latter is more likely to take advantage of the mainstream new energy passenger vehicle voltage platform (such as the range of 300 V˜450 V) to obtain more cost-effective battery packs, and guarantees quality and supply by multiple channels. Mixing and matching preferred battery packs of at least two different electrochemical cells connected in parallel is good for improving the cost effectiveness of the ACE HDT system. At present, the nominal voltages of the Li-ion power battery packs used in global mainstream new energy passenger vehicles range from 300 V to 500 V (referred to as the 400 V platform battery packs). There is a mature supply chain. The total annual production and sales of automotive-grade Li-ion power batteries of more than ten leading manufacturers in China, Japan and South Korea accounts for more than 85% of the global market share, the global production of the 400 V platform battery packs is increasing rapidly year by year, and the cost (USD/kWh) is decreased significantly year by year; while the annual global production of battery packs (referred to as 800 V platform battery packs) with a voltage rating higher than 600 V is more than an order of magnitude smaller, the cost is higher, the qualified suppliers are few, and the annual price reduction is low. The peak electric power of the ePSD 123 of the present disclosure can be up to 500 kW, and the preferred range of nominal voltage of the DC bus is 600 V˜800 V (i.e., 800 V platform). The preferred nominal voltage value of the battery packs (130a&b) used in the disclosure is between 350 V and 450 V, as far as possible to coincide with the nominal voltage range of the battery packs used in mainstream new energy passenger vehicles with the huge annual total production and sales to facilitate making full use of the mature 400 V platform power battery supply chain of the new energy passenger vehicles nowadays, reducing the cost and guaranteeing the supply. These battery packs 130a or 130b can match the voltage rating of the ePSD 123 DC bus through the 100-kW level bidirectional Boost-Buck DC-DC converter (Boost-Buck, also called the chopper) 132a or 132b in the port III of the ePSD 123, as shown in FIG. 2. In addition to DC voltage transformation, the chopper (132a&b) has another beneficial function of regulating the charge-discharge current amplitude and direction of the battery packs 130a&b automatically and accurately through the PWM within 0%˜100% of the charge-discharge current peak value according to the charge-discharge characteristic curves of various battery cells at different temperatures or in different life cycle stages (SOH) as well as the manufacturer's various limitations on the operating conditions for cycle life and safety guarantee of the battery cell through the software definition and OTA of the microprocessor contained in the chopper (132a&b) to ensure that both the performance and cycle life of the battery pack are optimized in the full life cycle. The cost-effective technical measures such as performing intelligent pulse preheating (iPH) on the battery packs 132a&b by means of the chopper 130a&b in cold winter can also be taken to solve the industry problem that the Li-ion batteries are afraid of cold but difficult to heat efficiently and evenly, which will be detailed below.

Preferably, the primary battery pack 130a can adopt lithium titanate oxide (LTO) cell combination with the total capacity of 12 kWh˜26 kWh, and can be charged and discharged for 5C˜10C continuously; the pulse peak charge-discharge current is 15C˜30C in 10 or 15 seconds, and the equivalent deep charge-discharge (100% DoD) cycle life (i.e., the accumulated total charge throughput in the full life cycle) exceeds 12,000 times; and the working environment temperature is −30˜+55° C. Among worldwide modern commercialized automotive power cells of various electrochemical formulations, only a set of LTO cells can satisfy all the above strict requirements of the ACE HDT battery packs, especially the requirements of ultra-long cycle life and low-temperature HRPSoC. The disadvantage of low specific energy (Wh/KG) of LTO cells has little effect on the application of ACE HDTs, but another disadvantage of LTO battery packs is high cost and few qualified suppliers available worldwide. The cost (yuan/Wh) of the cells per kilowatt-hour (kWh or degree) is above three times the cost of other mainstream automotive Li-ion cells (such as LFP, NCM and NCA), which leads to high cost of LTO battery packs. If the LTO cells are used completely, it will seriously limit the wide application of ACE HDT in the world due to too high total cost of the battery pack. For the primary battery pack 130a, the following power cells, such as NiMH battery, LFP battery, NCM/NCA battery or PbC battery, suitable for HRPSoC applications in severe working environment can be further selected. At least two sets of such four kinds of cells may be required for satisfying the requirements of the 100% DoD ultra-long cycle life exceeding 12,000 times. The costs (yuan/Wh) for the four kinds of cells are all obviously lower than those of the LTO cells, but two sets of systems are required for satisfying the ultra-long cycle life requirements. The parallel hybrid collocation of battery packs of the above several kinds of cells with different electrochemical components can be taken into consideration, as shown in FIG. 2, and the gross capacity of the battery packs (130a and 130b) is increased to 40 kWh˜90 kWh so as to achieve the optimal cost effectiveness of the battery pack within the full life cycle of ACE HDTs.

Preferably, the auxiliary battery pack 130b can adopt mainstream Li-ion power-type cells (continuous charge-discharge rate 3C+) with the capacity of 20 kWh˜50 kWh, such as lithium iron phosphate (LFP) or ternary lithium (NCM or NCA). Of course, an auxiliary battery pack 130b with a capacity of more than 50 kWh can be further selected, which is in favor of improving the driving performance of the full vehicle under various operating conditions and reducing the upper limit value and the charge-discharge peak rate of the equivalent cycle life of the battery pack, but the weight, volume and cost of the large-capacity battery pack are all obviously increased, the overall cost effectiveness is not optimal, and comprehensive consideration is required. In the present disclosure, the function of the battery pack is like a high-power engine with a small fuel tank, which has the characteristics of high explosive power but insufficient endurance. The battery packs 130a&b can be used for not only providing the 120 kW nominal electric power of the driving motor (140 or 170) for a long time (more than 10 minutes) continuously, but also providing the peak electric power of the driving motor above 300 kW within a short time (at the minute level). Provided that the total available capacity of the battery pack is 30 kWh, and the nominal power of the driving motor is 300 kW; with zero power output from the generator set in the series-hybrid mode, the battery pack is continuously discharged at 10C from the upper red line (URL) of its state of charge (SoC) to the lower red line (LRL), the driving motor can be continuously supplied with power at the intensity of 300 kW for 6 minutes to allow the pure electric driving of the fully loaded (with a gross weight of 40 tons) ACE HDT on a flat and non-congested highway at the speed of 90 km/h for nearly 10 km.

The ACE HDT is provided with the power-type battery pack that needs to support the charge-discharge demand of the driving motor for total continuous power of nearly 200 kW or 10-second pulse peak power of nearly 400 kW. When the preferred effective capacity of the battery packs (130a&b) ranges from 25 kWh to 65 kWh, the average continuous charge-discharge rate of the battery pack ranges from 3C to 8C, the 10-second peak charge-discharge rate ranges from 6C to 16C, and the charge rate (continuous or peak) of the battery pack is often higher than the discharge rate, working in an asymmetric mode. To achieve the accumulated fuel saving by 30% during the operation for a distance of 500,000 miles compared with the traditional diesel HDT, the equivalent accumulated charge throughput of the battery pack of the ACE HDT in the full life cycle (i.e., 500,000 miles) should be up to 300,000 kWh. If the battery pack with an effective capacity of 30 kWh in the beginning of life (BOL) is used, the 100% DoD cycle life of the battery pack should be up to 12,000 times considering that the capacity of the battery pack is decreased by 20% at the EOL. The requirements of the battery pack of the ACE HDT for the performance and life of the battery cell are significantly higher than those of the new energy passenger vehicle for the battery cell. Subject to the current technical pathway and industrial development level of automotive-grade Li-ion battery cells in the world, the actual performance and cycle life of battery pack are closely related to the instantaneous operating conditions (such as current, voltage, temperature, SoC and SOH) of cells. The ACE HDT requires the chopper (132a or 132b) to communicate with the BMS in real time. According to the instantaneous state of charge (SoC), cell temperature, state of health (SOH) and other data of the battery pack (130a or 130b), dynamical control on the actual charge/discharge rate of the battery pack can achieve the performance and cycle life optimization of the battery pack more effectively and reliably.

In order to guarantee a standard performance and achieve an ultra-long cycle life of the power-type battery pack, the current amplitude and direction of high rate state of charge must be dynamically adjusted under the HRPSoC condition according to the condition data (such as SoC, SoH, temperature and voltage) of the battery packs 130a&b, and the time-varying function of the SoC of all the cells of the battery pack must be controlled strictly. The URL of the SoC of the power-type cell is generally between 80% and 90%, the LRL is generally between 10% and 20%, the best upper limit (BUL) is between 65% and 75%, and the best lower limit (BLL) is between 30% and 40%. The battery pack SoC provides optimal performance, safety and cycle life for all cells when working in the high efficiency zone between BLL and BUL. The core of the predictive charge control strategy for battery pack is to maximize the stable operation of battery pack in the high efficiency zone under the condition of optimizing the driving performance and energy saving and emission reduction effect of the ACE HDT. If the HRPSoC is forced beyond the red line range of the SoC of the battery pack, it will have a serious long-term negative impact on the instantaneous performance, safety and cycle life of the battery pack, which should be avoided.

For the ACE HDT 010 in the series-hybrid mode (with the clutch 111 disengaged) or parallel-hybrid mode (with the clutch 111 engaged), the VCU 201 and the AIU 202 jointly perform Intelligent Stop Start (iSS) in the series-hybrid mode or Intelligent Power Switching (iPS) in the parallel-hybrid mode on the instantaneous output power of the engine 101 according to the energy saving and emission reduction machine learning algorithm, vehicle configuration parameters, operating conditions of the full vehicle and each related subsystem, instantaneous road-load power and 3D information (especially the longitudinal slope function) of the road within the range of electronic horizon, so as to instantaneously satisfy the power balance equation (2-4) or (3-3) and continuously adjust the time average value (e.g., rolling time average power in five minutes) of the engine output power. The continuous operation of the battery packs (130a&b) of the ACE HDT in any one of the following three charge modes (CS, CD, CI) and the smooth switching between the modes can be realized by controlling the 100-kW level dynamic distribution of electric power among the three ports of the ePSD 123: 1) In the Charge-Sustaining (CS) mode, both the instantaneous SoC time-varying function (referred to as instantaneous SoC) and minute-level time average SoC function (referred to as average SoC) of the battery pack need to be always maintained to continuously fluctuate between the BUL and the BLL. At this time, the minute-level time average output power function of the engine 101 (referred to as engine average power) is basically equal to the minute-level time average value of the vehicle road-load power (referred to as road load average power), the vehicle driving (series or parallel hybrid) is dominated by the engine 101, the battery pack 130a or 130b supplies power to the driving motor 140 or 170 to realize peak load shifting on the instantaneous road-load power and satisfy the vehicle dynamics equation (1-1) in real time; 2) In the Charge Depleting (CD) mode, the instantaneous SoC of the battery pack continuously fluctuates while the average SoC continuously declines between the LRL and the URL. At this time, the average power of the engine is obviously less than the average power of the road load, the vehicle driving (series or parallel hybrid) is supplemented by the engine 101, the driving motor 140 or 170 is mainly supplied with power by the battery pack 130a or 130b to realize peak load shifting on the instantaneous road-load power and satisfy the vehicle dynamics equation (1-1) in real time; 3) In the Charge-Increasing (CI) mode, the instantaneous SoC of the battery pack continuously fluctuates while the average SoC continuously rises between the LRL and the URL. At this time, the average power of the engine is obviously greater than the average power of the road load, the vehicle driving (series or parallel hybrid) is dominated by the engine 101 and supplemented by peak load shifting of the driving motor on instantaneous road-load power to satisfy the vehicle dynamics equation (1-1) in real time. Most of the mechanical power of the engine is directly used for driving the vehicle in the parallel-hybrid mode or indirectly used for driving the vehicle in the series-hybrid mode, and the surplus mechanical power is used for continuously charging the battery pack 130a or 130b through the generator 110, thereby ensuring that the SoC average value of the battery pack continuously rises over time.

There are two types of electric energy stored in battery packs 130a and 130b. One is the “engine charge” generated by the generator 110 driven by the engine 101, which is “high cost electric energy”, referred to as “engine electric energy”; the other is the “regen charge” generated by mechanical energy of the vehicle recovered by regenerative braking of the motor 110, 140 or 170, which can be regarded as “quasi-zero electric energy”, referred to as “regen electric energy” To minimize the overall fuel consumption (FC; L/100 km) of the ACE HDT in the whole transportation event, the electric energy (i.e., charge) in the battery pack (130a or 130b) needs to be discharged and charged whenever we like to improve the accumulated total throughput capacity (kWh; the sum of engine electric energy and regen electric energy) or turnover rate of charge (defined as the ratio of the accumulated total throughput capacity to the equivalent battery pack capacity) of the battery pack in each transportation event. Secondly, it is necessary to maximize the proportion of regen electric energy in the total electric energy, while minimizing the proportion of engine electric energy; and minimize the occurrence probability of the undesirable scenario that because the SoC of the battery package reaches the URL and fails to accept the newly added regen electric energy, the voltage-controlled switch 133 is turned on, and the brake resistor 131 completely wastes the regen charge. According to the priori 3D road data in the vehicle-mounted map unit 240, vehicle configuration parameters and dynamic condition data, the ACE HDT can accurately calculate the instantaneous power space-time function and average power space-time function of the road load (minute-level rolling average) in the electronic horizon (at an hour level or in a 100 km-level) with a kW-level granularity in real time (with sub-second level delay), unless in the special case that the accumulated recovered regen charge (i.e., quasi-zero charge) exceeds the total effective capacity of the battery pack when the vehicle encounters a long downhill (e.g., more than 10 km). The fuel-saving robot of ACE HDT always have forethought. By dynamically adjusting the difference between the average power of the road load and the average power of the engine, in the way of just-in-time (JIT) production, the battery pack is discharged and charged to maximize the stable operation of the battery packs 130a&b in the high efficiency zone, thereby avoiding two undesirable scenarios that the battery pack is too full (SoC reaches the URL) to recover regen electric energy or too empty (SoC reaches the LRL) to provide driving explosive power. And it seeks to maximize the turnover rate of the regen charge and minimize the turnover rate of the engine charge. Obviously, it is cost-effective to provide a large-capacity power-type battery pack (such as an effective capacity of more than 50 kWh) for ACE HDTs operating in high mountain areas for a long time; while provide a power-type battery pack with an effective capacity less than 30 kWh for ACE HDTs operating nationwide. The core (i.e., the fundamental core function of Level I fuel-saving robot eBOT) of the fuel saving strategy for the ACE HDT of the present disclosure is to dynamically adjust the path, amplitude, or direction of mechanical power flow and electric power flow of the vehicle by performing PWM or pulse-amplitude modulation (PAM) on the instantaneous power of engine or battery pack through predictive adaptive cruise control (PACC) (i.e., one-dimensional longitudinal L1 automatic driving) by making full use of the prior 3D data of the road in the electronic horizon and the 100-kW level grade power positive and negative fluctuations brought by the grade change along the road under the condition of ensuring the driving performance and active safety of the vehicle to satisfy the vehicle dynamics equation (1-1) and power balance equation (2-4) or (3-3) in real time. The battery packs 130a&b stably work in any one of the three modes of CS, CD and CI or smoothly switch among the three modes to maximize the accumulated regen charge throughput or turnover rate of the battery packs while minimizing the accumulated engine charge throughput or turnover rate, so as to realize the predictive SOC control (PSC) function and achieve the beneficial effect of energy saving and emission reduction optimization of the vehicle.

In the series-hybrid mode (with the clutch 111 disengaged), when the battery packs 130a&130b are discharged, driving power is supplied to the ACE HDT 010 through the driving motors 140 and 170, and when the battery packs 130a&130b are charged, the energy is recovered through the regenerative braking of the driving motors 140 and 170; in the parallel-hybrid mode (with the clutch 111 engaged and locked), in addition to the engine 101 directly involved in vehicle driving or braking, the generator 110 can also be involved in vehicle driving or regenerative braking to recover energy, which can further increase the regen charge throughput and improve the fuel saving effect. If the ACE HDT is climbing a long slope and the battery packs 130a&b are basically exhausted (SoC reaches the LRL), the ACE HDT at this time should work in the parallel-hybrid mode, and its driving performance depends entirely on the peak power of the engine 101. If the peak power of the engine 101 is not large enough, the truck has to shift to a lower gear to speed down and continue to climb the slope, temporarily reducing the driving performance and freight timeliness of the vehicle. The generator 110 and/or the driving motors 140&170 can take a chance for charging the battery packs 130a&b by regenerative braking again until there is a flat road or downslope ahead of the vehicle considered.

After parking outdoors at low temperature (below 0° C.) for a long time (more than ten hours) in winter, the HDT for long-haul freight generally needs to idle at parking to warm up the engine for a few minutes before running. The LTO battery pack can still maintain high rate charge-discharge performance of more than 75% after being placed outdoors at minus 30° C. for a long time (more than 10 hours), with small capacity decline and no impact on cycle life. Moreover, the cell will be heated internally in an uniform mode due to bidirectional pulse current excitation under the HRPSoC condition. The internal heating rate of the cell is higher than 1.0° C./minute, and the optimal working temperature of all the automotive-grade Li-ion battery cells is basically plus 25° C. Heat is constantly generated inside the cells when the power-type battery packs 130a&b of the ACE HDT run under the HRPSoC condition for a long time, so it is necessary to configure a liquid cooling unit to basically maintain the temperature inside the battery packs at 25° C. In addition to the cooling function, the unit can also be provided with a PTC electric heater to preheat the refrigerant fluid and perform external heating on the cells.

In addition to the LTO cell is not afraid of cold, the mainstream automotive-grade battery cells such as NMC or LFP are afraid of cold. At high-rate discharge below minus 10° C. (2C+), the effective capacity is severely reduced temporarily (less than 50%), but low-temperature high C-rate discharge will not permanently damage the cells. At high C-rate charge below 0° C. (2C+), not only the effective capacity is severely reduced temporarily, but also lithium plating on the graphite anode of the cell will happen, resulting in permanent damage to the cell life, and even causing a short circuit inside the cells and thermal runaway, leading to a fire. In cold winter, the LFP or NMC cell must be preheated to plus 10° C. before it starts to work under the HRPSoC condition. There are two types of low temperature preheating methods for Li-ion cell: external heating method and internal heating method. The existing electromechanical systems that perform external heating method (gas heating or liquid heating) are mature, relatively simple and cost-controllable, but cannot guarantee uniform heating. The significant temperature gradient in the battery pack has an irreversible negative impact on the overall long-term performance and cycle life of the battery pack. The cell provided with heating wire (such as nickel wire) internally belongs to non-standard special cell, which is not cost-effective and rarely used in the automotive-grade power-type battery pack. Heating low-temperature cells through current excitation, such as low-temperature DC preheating or AC preheating, is the mainstream internal heating method at present. The internal heating method can ensure uniform heating of the cell inside the battery pack and very small temperature gradient, which has no negative impact on the overall long-term performance and cycle life of the battery pack. However, the internal heating method will waste most of the electric energy because the equivalent internal resistance of the battery pack is far less than the load resistance of the external electric circuit, and the cell heating efficiency (the ratio of the energy of cell heating to the total power consumption) is far less than 50%.

The present disclosure further includes the following device and method of “intelligent pulse preheating” (iPH) technology for realizing uniform, efficient and accurate preheating for the internal cells of the battery packs 130a&b of the ACE HDT. The lithium-ion battery industry agrees that the low-temperature high-rate discharge does not permanently damage the cells (NMC, LFP and other mainstream automotive-grade cells), but the low-temperature high-rate charge permanently damages the cells. If the width of rectangular pulse of equivalent impulse current can be strictly controlled within 1.5 seconds at high-rate charge of low-temperature cells, and zero current or discharge pulse current of at least three times the above pulse width time can be combined, it can not only heat the cells uniformly by the bidirectional pulses current excitation inside the cells, but also avoid slow electrochemical reaction (with a reaction time of above 2 seconds) of lithium plating on the graphite anode of the cells, so as to eliminate the irreversible negative impact of low-temperature (below minus 10° C.) rapid charge (above 2C) on the performance and life of Li-ion cells. The specific technical measures are as follows: Before the engine is started in cold state for the first time after long-term (more than ten hours) parking outdoors (below minus 10° C.) of the ACE HDT in cold winter, all the motors (110, 140, 170) do not work, the VCU 201 can enable the automatic wake-up of the system and activate the iPH function of the battery packs 130a&b according to the driver's preset advance warm-up time, and the primary battery pack 130a plus chopper 132a and the auxiliary battery pack 130b plus chopper 132b will charge or discharge each other in an asymmetric bipolar PWM current time sequence mode; provided that the primary battery pack 130a is the high-pulse discharge side (referred to as the discharge side) and the auxiliary battery pack 130b is the high-pulse charge side (referred to as the charge side). The PWM pulse sequence consists of a high-amplitude narrow pulse and a low-amplitude wide pulse with opposite polarity. The amplitude of the high pulse is between 3C and 15C (a positive value of current represents discharge and a negative value represents charge), and the high-amplitude pulse width is between 0.5 seconds and 1.5 seconds; the amplitude of the low pulse is one N_{iPH} of the amplitude value of the high pulse, the current polarity is opposite, and the low pulse width is N_{iPH} times the high pulse width. The N_{iPH} is a positive integer between 3 and 10. Obviously, the impulse (i.e., the time integral of the current pulse) of one cycle of the current PWM pulse sequence is zero. The above current PWM pulse time sequence is generated by the choppers 132a and 132b cooperatively. The discharge side (130a) and charge side (130b) are mutual loads and can charge each other. The discharge side discharges quickly and charges slowly, while the charge side charges quickly and discharges slowly. In addition to a part of the electric energy preheating cells internally in the pulse current excitation mode, the remaining electric energy is basically recovered by the discharge side or charge side, and very little electric energy is wasted by other electric loads in the circuit. The heating efficiency (the ratio of the energy of cell heating to the total power consumption) is significantly larger than 50%. The iPH technology is suitable for both a hybrid battery pack system comprising the LTO primary battery pack (130a) and the LFP or NMC auxiliary battery pack (130b), and a uniform battery pack system comprising the main and auxiliary battery packs with the same cell (such as LTO, LFP and NMC).

The iPH technology defines and dynamically adjusts the amplitude, width and N_{iPH} (equivalent to PWM duty cycle) of the high pulse of the current PWM pulse sequence through software, so as to achieve the purpose of dynamically controlling the time-varying function (° C./minute) of the cell temperature and that of the heating rate, thereby optimizing the performance of battery pack, especially low temperature performance, and cycle life. The internal Li-ion cell is a complex and fragile electrochemical ecosystem. If the cell is heated too fast at low temperature, it will have an irreversible negative impact on cell cycle life. The preferred heating rate is less than 2.0° C./min. The iPH technology of the present disclosure provides an efficient, uniform, accurate and adjustable cell internal preheating function for the power-type battery packs (130a&b) of the ACE HDT without adding any new hardware, which is more cost-effective than various existing technologies for low-temperature heating of battery packs. Obviously, the iPH technology is not only applicable to the ACE HDT, but also to the electric hybrid technology of the light-duty vehicles, especially the hybrid light-duty vehicles with the electrical power split device ePSD 123.

In the next 20 years, the annual cost effectiveness improvement rate of power electronic (PE) power modules based on silicon IGBT or silicon carbide (SiC) MOSFET will be significantly higher than that of motors or battery packs. Continuously refer to FIG. 2, priority should be given during the design of the six 100-kW level PE power modules contained in the ePSD 123 (e.g., the port I is internally connected with the standard inverter 121, the port II is internally connected with the standard primary inverter 122a and the optional auxiliary inverter 122b, the port III is internally connected with the voltage-controlled switch 133, the standard primary chopper 132a and the optional auxiliary chopper 132b and the like) to leave over-design in the function and performance (especially the nominal power and peak power) of power electronic hardware, in order to continuously improve the existing performance and functions of each subsystem or add new functions through the OTA in the full life cycle of the ACE HDT. The peak power P_{igx} of the inverter 121 should be more than 15% higher than the peak power P_{gx} of the generator 110, the peak power Pᵢₘₓ of the main inverter 122a should be more than 15% higher than the peak power Pₚₘₓ of the primary driving motor 140, and the peak power of the auxiliary inverter 122b should be more than 10% higher than the peak power Pₛₘₓ of the secondary driving motor 170, Pₚₘₓ>Pₛₘₓ. The peak power of the primary chopper 132a and the auxiliary chopper 132b should be more than 15% higher than that of the primary battery pack 130a or the auxiliary battery pack 130b respectively, and the total peak power of the choppers 132a&b should be more than 20% higher than the peak power Pₚₘₓ of the primary driving motor 140. The nominal power of the voltage-controlled switch module 133 should be more than 15% higher than that of the primary driving motor 140.

Power semiconductor modules such as IGBT or SiC can improve the average cost effectiveness per year more quickly than the battery pack, motor and brake resistor. The continuous innovation and upgrading of the global power semiconductor industry can be fully utilized to achieve a cost-effective ePSD 123 by using a variety of power electronic circuit topologies. The ePSD 123 with hardware design margin is a software defined electrical power split device from the beginning, and can continuously improve and evolve the existing functions or add new functions through the OTA. With the above modular design strategy, the three ports of the ePSD and external electrical loads such as motors, battery packs or brake resistors can adopt standard mechanical and electrical interfaces in the industry, which are convenient and flexible for adapting to various motors and battery packs provided by many high-quality automotive suppliers that satisfy the performance requirements and target cost. The cost effectiveness of ACE HDTs can be continuously improved, and the quality and supply can be guaranteed for a long term.

The inverter is the core of the modern motor control unit (MCU). In the disclosure, the inverter should be understood as follows: there are a variety of mature circuit topologies that are achievable for the complete MCU with the inverter as the kernel module, so that there is no ambiguity for those skilled in the art. The inverters (121, 122a, 122b) can control the speed or torque of the three-phase AC motors (110, 140, 170) in a vector control mode dynamically and accurately, so that the amplitude and direction of 100-kW level motor power flow can be regulated continuously in real time (10-millisecond level). The chopper (132a, 132b) is a bidirectional buck boost DC-DC converter (Boost-Buck), the high-voltage side is bidirectionally and electrically connected with the DC bus of ePSD 123, preferably the nominal voltage range of the DC bus is 620 V˜750 V; the low-voltage side is bidirectionally and electrically connected with the battery packs 130a&b, preferably the nominal voltage range of the battery pack is 320 V˜450 V, and the low-voltage side should be close to the voltage platform of the mainstream new energy passenger vehicle as much as possible. Of course, a higher nominal voltage range (600V˜750V) of the battery pack is also optional, but the cost effectiveness of the battery pack is suboptimal. The choppers 132a&b can not only flexibly match the battery packs 130a&b with different nominal voltages (320V˜750V) through software definition, but also automatically customize and dynamically update the charge-discharge control solution for each battery pack through the HDT program for software definition and OTA of the choppers according to different charge-discharge technical requirements put forward by the power battery supplier for the cells at different internal temperature and SoC in order to ensure the performance, safety and cycle life of the cells in the full life cycle, thereby maximizing the dynamic compensation of weaknesses in high-low temperature operating performance, reliability and cycle life of the battery packs (130a&b).

The VCU 201 and the AIU 202 of ACE HDT can enable ePSD 123 to regulate three interdependent 100-kW level electric power time functions, including generator power P_{g}(t) as an independent variable, driving motor power Pₘ(t) as an independent variable, and battery pack charge/discharge power P_{b}(t) as a dependent variable, continuously in real time according to the fuel saving control strategy and fuel saving machine learning (ML) algorithm, to satisfy the electric power balance equation at the ePSD DC bus junction point X at any time:

$${P}_{m} ( t ) + {P}_{g} ( t ) - {P}_{b} ( t ) = 0 . \qquad ( 6 - 1 )$$

The electric power balance equation is equivalent to the previous equation (2-2) in the series-hybrid mode and the equation (3-2) in the parallel-hybrid mode.

Preferably, the standard primary driving motor (MG2) 140 is a low-speed high-torque large permanent magnet synchronous motor, with a nominal power range of 200 kW˜300 kW, a peak power range of 300 kW˜450 kW and a peak torque range of 1,800 NM˜2,500 NM. The driving motor 140 can also be a low-speed high-torque large AC induction motor or a reluctance motor meeting the power and torque requirements. The peak power of the main inverter 122a should be more than 15% higher than that of the primary driving motor, and a margin is reserved. Since the annual sales of the hybrid passenger vehicles is two orders of magnitude higher than the annual sales of the hybrid commercial vehicles, some core components shared with the passenger vehicles are selected as far as possible, so as to effectively reduce the cost of the hybrid commercial vehicles and guarantee supply in volume production. The nominal power of a single motor and inverter for the electric (hybrid) passenger vehicles is generally lower than 180 kW. An optional permanent magnet synchronous motor with a nominal power of 180 kW˜250 kW and a maximum torque of 350 NM˜500 NM for large new energy passenger vehicles can also be provided for the driving motor 140. The parallel-axis arrangement may be used, and the permanent magnet synchronous motor is connected with the input shaft of the transmission bidirectionally and mechanically through a heavy-duty reducer with a gear ratio ranging from 4 to 8.

For the 6×2 or 6×4 ACE HDT system block diagram in FIG. 1, a standard generator (MG1) 110 is connected bidirectionally and mechanically to the flywheel end of the engine 101 (the so-called hybrid P1 position) and to the driven end of the clutch 111. The specific mechanical connection structure can be divided into two types: Type I is the single-axis coaxial structure, in which the three (engine, generator and clutch) are connected to the same mechanical driving axle. At this time, the speed of the generator 110 is exactly the same as that of the engine 101 (speed ratio 1.0), and a low-speed high-torque large permanent magnet synchronous motor with a nominal power of 150 kW˜200 kW and a maximum torque of 1,200 NM˜2,000 NM can be preferred; Type II is the parallel axis structure (multi-axis), and the three are connected through the gear reducers bidirectional and mechanically. At this time, the generator 110 and the engine 101 are connected through heavy duty gear reducers, and the speed ratio is fixed. The speed of high efficiency zone of HDT engine is generally 1,000 RPM˜1,800 RPM, and the peak torque range is 2,000 NM˜2,500 NM. The engine has the lowest specific fuel consumption (BSFC, g/kWh) when working stably at low speed and high load. The power of the engine and motor is directly proportional to the product of their speed and torque, and the maximum torque of the engine and generator has highly positive correlation with their volume, weight and price. The use of Type II parallel axis structure can increase the speed ratio between the generator 110 and the engine 101 to 3.0˜8.0 through the constant speed ratio heavy duty reducer, so that it is possible to select a high-speed low-torque high-power permanent magnet synchronous motor in the mature supply chain system for new energy passenger vehicles, which greatly reduces the volume, weight and price of the generator 110 and realizes cost-effective quality and supply guarantee. The generator 110 can also be provided with a medium-to-high speed (maximum speed 12,000 RPM) automotive-grade permanent magnet synchronous motor with a nominal power of 150 kW˜250 kW and a peak torque less than 500 NM.

The standard primary driving motor (MG2) 140 is connected bidirectionally and mechanically to the driving end of the clutch 111 (the so-called hybrid P2 position), and to the input shaft of the automatic transmission 150 of the HDT through the large flexible coupler or a clutch-by-wire 152 of the HDT. The specific mechanical connection structure can be divided into two types: Type I is the single-axis coaxial structure, in which the three (clutch, driving motor and transmission) are connected to the same mechanical driving axle. At this time, the speed of the driving motor 140 is exactly the same as that of the input shaft of the transmission 150 (speed ratio 1:1); Type II is the parallel axis structure (multi-axis), and the three are connected through gear reducers bidirectional and mechanically. At this time, the speed ratio of the driving motor 140 and the input shaft of the transmission 150 is fixed, with a preferred range 4˜8. When the clutch 111 is engaged, the output shaft of the flywheel end of the engine 101 and the input shaft of the transmission 150 are bidirectionally and mechanically connected concentrically and coaxially. The speed of the two is the same, and the speed ratio is 1.0. The peak torque upper limit of the traditional HDT engine is 2,500 NM, so the maximum input torque upper limit of the current input shaft of the HDT transmission is also 2,500 NM. With the ACE HDT in the parallel-hybrid mode, the engine 101 and the duo-motors 110&140 can apply force together by torque superposition, and the total torque can exceed 4,000 NM. The heavy duty AMT subjected to enhanced design is preferred, its input peak torque should be higher than 3,500 NM, the total number of gears can be reduced to 6 gears, preferably including Direct Drive with a speed ratio of 1.0 and Overdrive with a speed ratio less than 1.0. The use of Type II parallel shaft structure can increase the speed ratio between the primary driving motor 140 and the input shaft of the transmission 150 to 3.0˜8.0 through the constant speed ratio heavy-duty reducer, so that it is possible to select a high-power permanent magnet synchronous motor in the new energy passenger vehicle system, which greatly reduces the volume, weight and price of the driving motor 140. The primary driving motor (MG2) 140 can be preferably a permanent magnet synchronous motor or AC asynchronous motor with a nominal power of 175 kW˜250 kW. Under Type I structure, the driving motor 140 is a permanent magnet synchronous motor or AC asynchronous motor with a low speed (maximum speed below 3,000 RPM) and a high torque (peak torque above 1,500 NM); under Type II structure, the driving motor 140 is a permanent magnet synchronous motor or AC asynchronous motor with a medium-to-high speed (maximum speed below 10,000 RPM) and a medium torque (peak torque below 500 NM). The latter is smaller in size and mass and cheaper than the former.

The optional secondary driving motor (MG3) 170 can be configured between the output shaft of the transmission 150 and the driving axle 160 (hybrid position P3) or in front of the second driving axle 180 (hybrid position P3); the motor and the driving axle are connected bidirectionally and mechanically. The peak torque at the input end of the driving axle of HDT can be up to more than 20,000 NM. A heavy-duty reducer should be installed between the driving motor (MG3) 170 and the driving axle (160 or 180), and the speed ratio range is 8.0˜16.0. The high-speed and low-torque automotive-grade permanent magnet synchronous motor or AC asynchronous motor with a nominal power of 100 kW˜150 kW and a peak torque less than 500 NM (Newton meter) are preferred.

In FIG. 1, the input shaft of the transmission 150 is connected with the output shaft of the primary driving motor 140 through the large flexible coupler 152 bidirectionally and mechanically, and the output shaft of the transmission is connected with the first driving axle 160 bidirectionally and mechanically. Preferably, the current mature volume production heavy duty 10-18-speed AMT (AMT-10˜AMT-18) with the maximum input torque of 2,500 NM is adopted, or the heavy-duty double-clutch transmission (DCT) or the automatic transmission (AT) with a hydraulic torque converter can also be selected; the emerging 5-gear or 6-gear heavy duty AMT (AMT-5 or AMT-6) with the maximum input torque of greater than 3,500 NM subjected to enhanced design can also be selected, preferably including Overdrive (speed ratio less than 1.0), in addition to Direct Drive (speed ratio 1.0). Different from the dynamic characteristic that the torque is smaller at low speed of the engine, the torque of the driving motor is the maximum at low speed, so the forward speed gears 5˜6 of the automatic transmission are sufficient, and excessive gears are not required. However, the driving drivetrain system of the ACE HDT in the present disclosure, including the transmission, is not the standard one-way mechanical power transfer of the traditional engine HDT but two-way mechanical power transfer, and the maximum reverse torque during regenerative braking is basically the same as the forward peak torque, so the design and manufacturing of the main bearings and gears in the transmission 150 should be specially strengthened, and then it can be ensured that the performance and life of the transmission can meet the standard reliably.

In the disclosure, the secondary driving motor (MG3) 170, the inverter 122b (MCU) and the second mechanical driving axle 180 can be combined to form an “integrated e-axle”. The traditional 6×2 HDT with diesel engine can also be equipped with an integrated e-axle to become a 6×4 hybrid HDT, but at this time, the pure mechanical powertrain of the engine and transmission and the integrated e-axle operate independently of each other, there is a lack of close coordination, and the fuel saving effect is not the best. Unlike prior art, for the ACE HDT in FIG. 1 of the disclosure, its integrated e-axle is dynamically strongly coupled and closely dynamically coordinated with more than one subsystem including engine 101, engine control unit 102, generator (MG1) 110, ePSD 123, primary driving motor 140, battery packs 130a&130b, clutch 111, transmission 150 and transmission control unit 151, and are jointly controlled by the VCU 201. Depending on specific vehicle conditions and the road conditions, through the dynamic adjustment of the path, amplitude and direction of mechanical power flow or electrical power flow of the vehicle powertrain, the ACE HDT are jointly driven to achieve the beneficial effect of optimizing energy saving and emission reduction of the vehicle, while also improving vehicle power and braking performances, and increasing the redundancy of the vehicle power system and brake system.

A large HDT diesel engine or natural gas engine with a displacement of 11 L˜15 L, a peak power of 280 kW˜450 kW and a peak torque of 2,000 NM˜2,500 NM can be a preferred choice for the engine 101; a medium and HDT diesel engine or natural gas engine with a displacement of 7 L˜10 L, a peak power of 250 kW˜320 kW and a peak torque of 1,500 NM˜2,100 NM can also be selected. The mixed hybrid ACE HDT is preferably provided with the mainstream diesel engine with a displacement of 11 L˜13 L in the world. For example, the ACE HDT is equipped with a 11 L diesel engine 101 (base model or advanced model) (with a peak torque of 2,200 NM@ 1,200 RPM and a peak power of 300 kW@ 1,800 RPM) with the largest current market take-rate; a permanent magnet synchronous generator 110 with a nominal power of 175 kW and a peak torque of 1,400 NM; a permanent magnet synchronous driving motor 140 with a nominal power of 200 kW and a peak torque of 1,600 NM; ultra-long cycle life power-type battery packs 130a&b with a continuous charge-discharge power (nominal power) of greater than 250 kW and an effective capacity of 30 kWh at the EOL; in the parallel-hybrid mode and in the high efficiency zone of the engine (1,100 RPM˜1,800 RPM), the engine and the duo-motors can apply torque together, the total driving torque at the input shaft of the vehicle transmission can be more than 4,000 NM, and the vehicle driving performance (high-speed climbing with full load, speed up to overtake, etc.) is significantly better than that of the traditional high-end HDT equipped with a top-of-the-line 16 L diesel engine. The RDE fuel consumption (L/100 km) of the ACE HDT in freight events with the same payload and freight route is more than 25% lower than that of any traditional diesel HDT, and the optimal fuel consumption that the ACE HDT can achieve completely depends on the fuel saving ML algorithm of the fuel-saving robot, independent of the driver's skill level and the RDE fuel consumption consistency is extremely high.

FIG. 4 is a universal characteristics curve graph (fuel map) of a 11 L diesel engine of a typical modern HDT. The engine has a peak torque of 2,000 NM, a peak power of 300 kW, and the lowest BSFC of 187 g/kWh. The figure is full of several complementary disjoint irregular curves, each of which is a contour line of constant BSFC. The complete and detailed universal characteristic curve of an engine is the trade secret of the engine manufacturer and will only be shared with the OEMs or related tier I suppliers after signing a confidentiality agreement. At present, the lowest BSFC of mainstream HDT diesel engines in volume commercial use in the world is 182 g/kWh, corresponding to the brake thermal efficiency (BTE) of 46%. The HDT diesel engine with BTE of 50%˜55% is still in the development stage in Europe and the USA, and they are still more than five years away from mass production and commercial use in Europe and the USA. If the high efficiency zone of the engine is defined as the operating range within the contour BSFC curve with 108% of the lowest BSFC, with reference to FIG. 4, the engine speed range corresponding to the high efficiency zone is 800 RPM to 1,800 RPM, and the torque range is 600 NM to 2,000 NM, i.e., the torque load rate of 30% to 100%. It is easy to digitize the universal characteristic curve of the high efficiency zone of the engine in FIG. 4 and transform it into a list (look-up table) convenient for computer processing. Preferably, a 140×100 matrix describing the high efficiency zone of the engine is generated with a speed step spacing of 10 RPM and a torque step spacing of 10 NM, each row of the matrix corresponds to constant torque and each column corresponds to constant speed, and each element (specific row/column number) in the matrix corresponds to the BSFC (g/kWh) of an engine operating point (specific speed/torque), called “original BSFC list” (referred to as “original list”), and the original list reflects the original design metrics of the engine. The engine control unit (ECU) 102 of the ACE HDT 010 can also generate a “corrected BSFC list” (referred to as “modified list”) every two days or 1,000 miles according to the actual operation of the engine 101, and the modified list reflects not only the original design performance metrics of the engine model, but also the current actual performance metrics of the specific engine, which can be used by the fuel-saving robot.

Example of series-hybrid iSS: Provided that the nominal power of the generator 110 of the ACE HDT is 175 kW, preferably the operating point of the engine 101 with speed 1,200 RPM and torque 1,400 NM in the modified list is the “best operating point” (BOP), therefore the engine power at this point is 176 kW, which can also be called “high-state operating point”; and preferably the engine runs at 600 RPM idle speed without combustion, the resistance torque of the engine at this time can be approximated as −250 NM, therefore the engine power at the non-combustion idle (NCI) point is −16 kW, which can also be called “low-state operating point”. The ECU 102 controls the operating point of the engine to dynamically switch between BOP and NCI to realize the bipolar asymmetric rectangular PWM of the instantaneous power function of the engine 101 in the series-hybrid mode. Preferably the cycle Tₛ of the PWM pulse sequence ranges from 10 seconds to 60 seconds, and the duty cycle kₛ (i.e., the ratio of the BOP operation time to the PWM pulse period Tₛ in the same cycle) is arbitrarily adjustable between 0.0 and 1.0. Obviously, the minute-level rolling time average power function (referred to as the average power function) value of the engine can be continuously and arbitrarily adjustable between −16 kW and 176 kW in the series-hybrid mode by dynamically adjusting the duty cycle kₛ. According to the series-hybrid power balance equation (2-4) and the vehicle dynamics equation (1-1), the instantaneous power PAM pulse sequence of the battery pack 130a&b synchronized with the instantaneous power PWM pulse sequence of the engine 101 can be generated by the ePSD 123 and the power-type battery pack 130a or 130b cooperatively. Preferably, the cycle of the PAM pulse sequence of the battery pack is one-tenth of the cycle Tₛ of the PWM pulse sequence of the engine, which can adopt both natural sampling (curve-top sampling) or equivalent flat-top sampling.

Example of parallel-hybrid iPS: The configuration parameters of the ACE HDT are the same as the above example. The gear shifting control strategy of the transmission 150 can always control the speed of the engine 101 in its high efficiency zone. With reference to FIG. 4, the engine speed range corresponding to the high efficiency zone is 900 RPM to 1,700 RPM, and the base speed (the speed of the peak torque center point) of the engine is 1,200 RPM. When the ACE HDT 010 enables the PACC function on non-congested expressways, the vehicle speed can be steadily maintained at about +−10% of the nominal cruising speed (e.g., 60 miles/hour); that is, the vehicle speed can fluctuate slowly and continuously within a narrow speed band; in the parallel-hybrid iPS control mode, the speed of the engine 101 is a dependent variable and fluctuates slowly and continuously within a narrow speed band (1,080 RPM to 1,320 RPM) with about +−10% variation rate around the base speed (1,200 RPM); mean-while the engine torque is an independent variable and can be changed rapidly and continuously below the peak torque. Corresponding to the dependent variable of every instantaneous speed of the engine in the modified table with a refreshing rate of no less than 10 Hz, select the high-state operating point with the minimum BSFC and the maximum torque in the high efficiency zone of the engine in real time and then connect all the different high-state operating points of the PWM pulse sequence in the high-state operation period to form a pre-defined high-state operating line. Obviously, the high-state operating line is a pre-defined irregular curve in the high efficiency zone of the engine that a high-state operating point can move slowly along. The instantaneous power of the engine corresponding to each high-state operating point on the high-state line is between 200 kW and 251 kW, and the high-state arithmetic average power is 225 kW. Corresponding to each low-state operating point, when the engine 101 runs without combustion and is driven by the generator 110, the resistance torque can be approximated as −300 NM. All different low-state operating points are connected to form a low-state operating line, which can be approximated as a constant torque operating line in the fourth quadrant (i.e., negative torque and positive speed) of the universal characteristic curve of the engine. The instantaneous power of each low-state operating point is between −41 kW and −34 kW, and the low-state arithmetic average power is −38 kW. Obviously, in the iPS mode, the ECU 102 controls the engine to dynamically switch between the high-state and low-state operating lines, and performs PWM on the instantaneous power function of the engine, generating a bipolar asymmetric non-rectangular PWM pulse sequence. The optimal cycle Tₚ of the PWM pulse sequence ranges from 10 seconds to 60 seconds, and the duty cycle kₚ (i.e., the ratio of the high-state operation time to the pulse cycle Tₚ in the same cycle) is continuously adjustable between 0 and 1, so that the minute-level rolling time average power function of the engine 101 can be continuously adjustable between −38 kW and 225 kW in the parallel-hybrid iPS mode. According to the parallel-hybrid power balance equation (3-3) and the vehicle dynamics equation (1-1), the instantaneous power PAM pulse sequence of the battery pack 130a&b synchronized with the instantaneous power PWM pulse sequence of the engine 101 can be generated by the ePSD 123 and the power-type battery pack 130a or 130b cooperatively. Preferably the cycle of the PAM pulse sequence of the battery pack is one-tenth of the cycle Tₛ of the PWM pulse sequence of the engine, which can adopt both natural sampling (curve-top sampling) and equivalent flat-top sampling. Although theoretically, the duty cycle (kₛ or kₚ) of the engine PWM pulse sequence is continuously and arbitrarily adjustable between 0 and 1, in reality from the perspective of NVH optimization of the engine 101 or the ACE HDT 010, too short transition time (sub-second level) of the engine 101 switching between the high-state and low-state conditions and insufficient operation time (less than 5 seconds) under the high-state pulse condition should be avoided as much as possible. The dynamic value range of duty cycle should be further restricted. In each PWM pulse cycle, preferably the high-state operation time of the engine 101 is either zero (i.e., the duty cycle is zero) or greater than 5 seconds; if the PWM pulse cycle is selected as 30 seconds, preferably the value range of the duty cycle is zero or greater than 17%; preferably the transition time of switching between the high-state and low-state conditions of the PWM pulse sequence is 1 second. If the speed of the engine 101 is 1,200 RPM, it means that each cylinder of the engine can have 10 combustion power strokes per second, and the engine can complete smooth switching between the high-state and low-state conditions rapidly with the power step spacing (less than 27 kW) of 10% of the high-low state average power difference of the PWM within the transition time of 1 second. The vehicle NVH performance can be optimized to avoid degradation due to the completion of rapid power change over 260 kW in one power stroke of the engine within too short transition time (such as 0.1 second). Obviously, both the cycle of the PWM pulse sequence and the high-low state transition time of the engine 101 are defined by software and dynamically adjustable, which can effectively avoid any mechanical resonance produced by the ACE HDT 010, and dynamically optimize the vehicle NVH performance in the series-hybrid iSS mode or parallel-hybrid iPS mode.

The above content describes the ACE HDT system of the disclosure, which is the hybrid powertrain architecture and hardware foundation to realize the simultaneous optimization of the ACE HDT fuel saving and emission reduction in the application of long-haul freight, and the specific technical measures to perform PWM or PAM control on the instantaneous power functions of the engine 101 and the battery packs 130a&b. Next, we will further describe how to use the vehicle-mounted 3D electronic map, vehicle-mounted navigation equipment and ACE HDT cluster structured big data stored on the cloud computing platform (such as the cloud server) in combination with the fuel saving ML algorithm and cloud platform computing power to train the cloud and vehicle-mounted fuel saving AI brain, perform PACC of the ACE HDT in the same lane on a highway, and achieve the beneficial effect of energy saving and emission reduction optimization.

In some embodiments of FIG. 1, the ACE HDT is equipped with a map unit (MU) 240 and a satellite navigation receiver (GNSS) 220. The map unit 240 stores a priori three-dimensional electronic map (or 3D map) covering countrywide expressways and other main semi-closed roads, while the 3D map information includes, but not limited to: the longitude and latitude of a whole journey expressway describing the absolute geographical position of the vehicle, especially the information indicating the longitudinal slope of the road (such as the uphill angle αᵤ and downhill angle α_{d} shown in FIG. 5). For example, a memory of the vehicle-mounted map unit 240 shown in FIG. 1 can include a 3D map with a meter level positional accuracy (longitude and latitude) of a road and 0.1-degree level accuracy of a longitudinal slope (or road grade). At present, various advanced driver assistance system (ADAS) maps including the above-mentioned three-dimensional information of the road have been commercialized in volume in all major automobile markets worldwide. High definition maps (HD Map) capable of supporting an SAE L3 or L4 autonomous driving system have already entered an initial commercializing stage. In description of the present disclosure, the ADAS maps should be generally construed as inclusion of HD maps.

The Global Navigation Satellite System (GNSS) 220 is used for measuring in real time information such as the longitude, latitude, altitude, longitudinal road slope, longitudinal linear speed, longitudinal linear acceleration and current absolute earth geographic position of the ACE HDT 010. In some embodiments, the satellite navigation receiver adopting a dual-antenna 221 and 222 input carrier phase real-time kinematic (RTK) differential technology (“RTK receiver” for short) 220 can be used for real-time accurate positioning and orientation determination of the HDT at the measuring speed of over five times per second (the measuring frequency is higher than 5 Hz). At present, GNSS has four independent systems, namely GPS of America, Glonass of Russia, Galileo of European Union and BeiDou (BD) of China. At present, the BeiDou Navigation Satellite System III can provide latest satellite navigation services for the Asian-Pacific region centered on China and for countries along “The Belt and Road”, and it is predicted that the global coverage can be finished in 2020. At the same time, BeiDou system of China has signed a compatible protocol with the other three satellite navigation systems. Preferably, the satellite navigation receiver (GNSS) 220 including the latest BDS-3 RTK chip is matched with the two satellite antennas 221 and 222 installed on the top of the HDT cab at the interval of at least 1 m, and the timing, speed, position (longitude/latitude), and longitudinal orientation (namely road longitudinal slope angle) of the vehicle are calculated in real time. The RTK chips can finish calculation of satellite navigation positioning and orientation determination according to the received independent signals of four navigation satellites combined in the four systems of the GNSS. The timing accuracy is 50 nanoseconds, the speed measurement accuracy is 0.2 m/s, the longitude and latitude positioning accuracy of a horizontal plane is smaller than 2.5 m, the longitudinal slope progress of the road is smaller than 0.15 degree, and the highest measurement frequency is 10 Hz; the RTK navigator cannot accurately measure the perpendicular altitude of a road surface under a vehicle wheel in real time. Meanwhile, many countries in the world strictly control surveying and mapping and issuing of accurate altitude information. Fortunately, the present disclosure imposes no strict requirement on measurement accuracy of the absolute altitude of the road surface of a vehicle, and a 10-meter level accuracy is acceptable. In some embodiments, the single-antenna GNSS plus inertial measurement unit (IMU) can also be used to full vehicle 3D positioning and navigation. The automotive-grade mass-produced IMU based on multiple MEMS acceleration sensors and Gyro plus dedicated processing chip can measure the longitudinal slope function of the road where the ACE HDT runs in real time with the measurement frequency higher than 10 Hz and the measurement accuracy of 0.1 degree. The GNSS 220 in the present disclosure should be construed as either a double-antenna RTK receiver or a single-antenna satellite navigator plus IMU. Real-time and accurate measurement of longitudinal slope distribution function along the expressway by the GNSS 220 is essential for the implementation of the present disclosure because the instantaneous small 0.1-degree-level change of the road longitudinal slope function is the secret source of substantial fuel saving and emission reduction when the ACE HDT is running at high speed. It needs to be emphasized that the measurement accuracy and the measurement refresh rate for the longitudinal slope of the road of the GNSS 220 both are obviously higher than those of a longitudinal slope sensor configured in an automatic transmission of the HDT in the prior art.

The RDE fuel consumption of each ACE HDT completing a freight event (from a freight transport starting point to a freight transport end point) is highly correlated with various parameters or variables of each important sub system of the HDT such as configuration parameter constants (including hybrid powertrain, vehicle air drag coefficient, friction coefficient and the like), a discrete variable of vehicle total mass (a power unit and a cargo trailer with payload), two continuous variables of longitudinal vehicle speed and acceleration and three other continuous variables of longitude, latitude and longitudinal slope distribution function (ego-vehicle geographical location) along a driving path, and is substantially independent of the macroscopic average fuel consumption of all ACE HDTs driving on all roads. Before an ACE HDT departs for freight transport, the driver of the ACE HDT inputs the starting point and finishing point of the freight event route to the system, the fuel-saving robot of the HDT can then automatically generate a driving path and request the cloud-based 001 artificial intelligence (AI) fuel saving brain to calculate and download the default optimal fuel saving control strategy customized for the vehicle and a specific path in real time with reference to all the cloud-stored fuel saving data sets about the operation of the ACE HDT running in this road section in history, and edge computing is carried out combined with the vehicle-end AIU 202 (AI inference chip) to modify and optimize the fuel saving strategy in real time. Every ACE HDT can consistently achieve the optimal fuel consumption each time relying on the collective intelligence and wisdom of all ACE HDTs regardless of whether the driver has driving experience of the particular freight path. The RDE (actual) fuel consumption is reduced by 30% compared with that of a modern internal combustion engine HDT. Moreover, the energy saving and emission reduction effects are decoupled with the skill of the driver and the performance of the engine, and are consistently better than those of any human driver.

The ACE HDT 010 can automatically collect, denote, vehicle-side-store and cloud-update the fuel saving data set of the entire freight event. The so called “fuel saving data set” includes the overall dynamic operation data of key subsystems such as ACE truck010, engine 101, transmission 150, generator 110, driving motor 140 or 170, battery pack 130a or 130b, clutch 111, GNSS 220 and ePSD 123 in the entire freight event. The data is both the dedicated structured big data about the energy management of the ACE HDT and the “data oil” of the machine learning (ML) algorithm for training and continuous autonomous evolution of the fuel-saving robot of the HDT. The structured big data is the “fuel saving data set” for short.

One of the core elements of the fuel saving data set of the ACE HDT is the operating big data of its ePSD 123 and can include the following contents: the sampling and recording frequency is at least 10.0 Hz; clocks of microprocessors of all other onboard subsystems are calibrated according to timing of the satellite navigation receiver 220 as the unique system clock of the whole vehicle system; at each sampling time point tᵢ, each microprocessor of the ACE HDT directs related sensors to locally collect and store at least the following variable values: current longitude L_{lg} (tᵢ), latitude Lₗₐₜ (tᵢ), longitudinal slope G (tᵢ), vehicle speed v(tᵢ), vehicle acceleration a (tᵢ), direct current I_{g} (tᵢ) of the generator 110, combined direct current Iₘ (tᵢ) of driving motors 140&170, combined direct current I_{bat} (t) of battery packs 130a&b, DC voltage V_{bus} (tᵢ) at the DC bus junction point X, state of charge C_{bat} (tᵢ) of battery packs 130a&b, direct current I_{bk} (tᵢ) of brake resistance, external environmental temperature T (tᵢ) and environmental wind speed and wind direction v_{xyz} (tᵢ) of the ACE HDT; it can further locally sample and store main time variable operation data of each motor (generator 110, primary driving motor 140 and secondary driving motor 170), engine 101 and automatic transmission 150 at the sampling time point (tᵢ), for example rotating speed, torque, gear, fuel delivery rate (g/s), specific fuel consumption (g/kilowatt-hour) and the like; it can further collect and store data such as period, amplitude and duty cycle of an instantaneous mechanical power time-varying function of the engine 101 in a series-hybrid iSS PWM impulse sequence or a parallel-hybrid iPS PWM impulse sequence, and data such as period and amplitude of an instantaneous electrical power function of the battery packs 130a&b in a corresponding PAM impulse sequence in a series-hybrid iSS control mode or a parallel-hybrid iPS control mode. It should be emphasized that the above-mentioned fuel saving data set of the ACE HDT must be collected and stored onboard and dynamically all at once in real time by using the parallel-series ACE HDT system shown in FIG. 1 of the disclosure. It is not possible to collect or simulate the data in a decentralized way (generally referring to different times, roads and subsystems on more than one HDT) through splicing and combining to form the desired data. To complete the initial training and subsequent continuous improvement of the AI brain of cloud-end or vehicle-end fuel-saving robots, a variety of open source or proprietary ML algorithms and networked cloud computer computing power (available when you need to buy it) can be used to complete training, modeling and optimization of a deep neural network (DNN) of the fuel saving algorithm in combination with the above-mentioned fuel saving data set. The fuel saving data set for operation of the ACE HDT is non-public proprietary data. The more you accumulate data, the greater value you get. Compared with the petroleum industry, the fuel-saving big data can continuously enhance and maintain the long-term competitive advantages for long-haul freight enterprises using the fuel-saving robot of the present disclosure. In some embodiments, the VCU 201 of the ACE HDT 010 can be configured for predictive power control over the at least one of the subsystems: the ePSD 123, the engine 101, the generator 110, the driving motor 140 or 170, the clutch 111, the transmission 150 and the battery packs 130a or 130b in an “independent” way based on the longitude and latitude (equivalent meter-level positioning accuracy) of the electronic horizon (meter-level interval density), the longitudinal road slope (“longitudinal slope” for short, accuracy 0.1 degree) along the full freight event based on the priori 3D map prestored in the map unit 240, and/or based on dynamic data such as the longitude, latitude, altitude and longitudinal slope measured by the GNSS 220 of the position where the vehicle is located, and/or the configuration parameters of the ACE HDT 010 and dynamic working conditions of key subsystems in pursuit of minimized actual fuel consumption of ACE HDT under the condition of ensuring vehicle driving performance and safety.

Optionally or additionally, under the condition that the deviation between the priori road information prestored in the 3D map in the map unit 240 and the road information actually measured by the GNSS 220 is beyond the range of allowable tolerance, especially when the deviation of the current longitudinal slope data (as key information of the fuel saving ML algorithm) of the vehicle is beyond the range of allowable tolerance, the VCU 201 can control the instantaneous electric power distribution among the three ports of the ePSD 123 preferably subject to the longitudinal slope data actually measured by the GNSS 220 to satisfy the vehicle dynamics equation (1-1) in real time. If the speed or acceleration of the vehicle obviously deviates from the desired control value at this time, it indicates that the fact is that the GNSS 220 measurement data is wrong and the 3D map priori data is correct, the VCU 201 can make a judgment after vehicle-in-the-loop simulation calculation according to the instantaneous power distribution parameters of the three ports of the ePSD 123 of the ACE HDT, the longitudinal linear speed and acceleration of the vehicle 010 and in combination with the vehicle dynamics equation, reelection shall be subject to the onboard 3D electronic map, so as to achieve the automatic error detection or correction function.

The double-antenna RTK receiver solution used by the GNSS has a complex system and superior performance, but the cost is high. Of course, to reduce the system cost, a normal satellite navigation receiver 220 with only a single antenna 221 can be selected without antenna 222; then, an inertial measurement unit (IMU) with single-axis or multi-axis dynamic tilt sensor (the measuring accuracy is superior to 0.15 degree, the measuring range is greater than +/−15 degrees, and the horizontal direction is 0 degree) can be selected to measure the running vehicle's absolute positioning (longitude/latitude) and road longitudinal slope in real time. There are many implementation methods for the dynamic tilt sensor. One of the cost-effective embodiments is the Accelerometer of the automotive-grade micro-electro-mechanical system (MEMS), the Gyroscope and the special-purpose chip integration. In several embodiments below, the following is the exemplary description on how to achieve the automatic predictive fuel saving control through the VCU 201 using the vehicle dynamic 3D positioning and orientation-determining navigation information (especially the road longitudinal slope distribution function). It is indicated that the following specific examples should not be interpreted as restrictions on the protective range of the invention, but for those in the art to understand the invention properly.

In some embodiments, when there are only short slope of the expressway within 100 kilometers ahead of the vehicle, short slope refers to the road section whose slope is less than the predefined second slope threshold (e.g., less than 3.0°) and the length of slope section is less than the predefined second length threshold (e.g., less than 10 km, or even less than 2 km), and the average output power of the engine 101 can be regulated by the VCU 201 by means of the series-hybrid iSS or the parallel-hybrid iPS to realize a predicative SoC control function (PSC), so that the battery packs (130a&b) operate stably or are switched dynamically between a charge depleting (CD) working mode and a charge sustaining (CS) working mode. It is particularly suitable for a scene with a “short slope” (also referred as to “a small slope”) of the road section ahead. As the slope length is shorter (e.g., less than 2 km), before the battery packs 130a&b completely release stored electric energy, the vehicle has climbed to the top of slope. In the subsequent down-slope stage, the battery packs 130a&b can be further re-charged by means of hundred kW-level regenerative braking power of the driving motor 140 so as to recycle kW level energy. In this way, the power throughput turnover rate of the power-type battery pack (10 kW level) with a limited capacity can be increased, especially, the maximum value of the regenerative charge turnover rate pursuing quasi-zero cost and the minimum value of the charge turnover rate of the engine are increased, and the cost effectiveness is higher than that of the solution using a high-capacity battery pack (large volume/weight, high price) of hundreds of kilowatt hours. In an expressway of a relatively flat terrain or hilly area without long slopes or high mountains (referring to a scene where the absolute value of the longitude slope is greater than 2.0 degrees and the slope length is beyond 10 km), an intelligent mode switching control mode (iMS) can be further used to dynamically switch between iSS and iPS, and the fuel saving machine learning algorithm automatically explores and finds the optimum fuel saving control strategy for the appointed path.

With reference to FIG. 1, for the sake of driving safety in some embodiments, the ACE HDT can further include a vehicle-level millimeter wave radar module (mWR) 230 and a radar antenna 231 installed at the front end of the HDT to real time measure the absolute distance between the HDT and the leading vehicle right ahead in the same lane and the relative speeds between the two vehicles. The front maximum detection range of the long distance millimeter wave radar (LRR) is beyond 250 m, with a horizontal view (FOV) range of +/−10 degrees. The millimeter wave radar 230 can further include automotive-grade short distance large view radar (SRR), with the maximum detection range of 70 m and the view range of +/−65 degrees. An automotive-grade forward monocular or binocular camera and a processing chip with the maximum detection distance of more than 250 meters can also be used for integrating with the forward-looking millimeter wave radars (LRR&SRR) to enhance the front-end speed and distance measurement properties of the vehicle and the system robustness. If it needs to ensure redundancy and robustness of the front speed and distance sensor of the vehicle, low cost laser radar (LiDAR) with over 16 lines in front view at small horizontal view (FOV+/−10 degrees) can be further installed, with the farthest detection range exceeding 200 m). The millimeter wave radar mWR 230 in FIG. 1 of the disclosure should be construed as any combination of the above three types of the plurality of sensors (millimeter wave radar, laser radar and camera) for measuring, tracking or identifying the periphery of the vehicle, in particular relative speed and absolute distance of a front object or event.

In some embodiments, the HDT further includes an onboard wireless communication gateway (T-Box) 210 and an external antenna 211, used for connecting the HDT 010 with a cloud computing platform 001 in a wide area through the 3^{rd}/4^{th}/5^{th} (3G/4G/5G) generation cellular mobile network 002 (referring to FIG. 4) while supporting V2X (vehicle-road, vehicle-vehicle, vehicle-network, vehicle-human, etc.) real-time communication.

The VCU 201 can be in unidirectional or bidirectional real time communication with numerous vehicle sensors including the GNSS 220 and the millimeter wave radar 230 for real-time control of modules or subsystems including the engine 101 and its ECU 102, the generator 110, the ePSD 123 (including the inverters 121, 122a&b, the high power soft switch 133 and the choppers 132a&b), the battery packs 130a&b, the driving motors 140 and 170, the automatic transmission 150 plus the TCU 151 and the map unit 240, thus achieving the PACC function of the vehicle in the same expressway lane through the “symphony orchestra type” multi-module real time dynamic coordination, i.e., SAE L1 or L2 level autonomous driving, liberating the driver's feet, alleviating the driving labor intensity, and optimizing the vehicle's power and fuel saving property as well, and ensuring that the actual vehicle exhaust pollutant emission meets the emission standards (China-6, Euro-VI, US EPA-2010) stably within the warranty period of 700,000 km. Under the premise of ensuring the vehicle dynamic performance, the VCU 201 can minimize comprehensive fuel consumption for the whole journey by making use of electronic horizon 3D road information within 50 km and even 500 km effectively through the PACC of the ACE HDT of an accumulated sequential km-level granularity road section.

In addition, the driver can manually turn on or off the Predicative-Adaptive-Cruise-Control (PACC) function when the ACE HDT is running on a closed expressway to realize the SAE L1 or L2 autonomous driving function combined with the mass-produced commercial ADAS, which basically frees up the driver's feet and reduces the driver's driving labor intensity; the PACC function can be started within an expressway ODD and various vehicles and speeds in non-extreme weather (without heavy rain, heavy snow, hail, flood and the like).

In some embodiments, the above-mentioned PACC can include the following three subdivided working modes: 1) Normal mode N, 2) fuel saving mode Eco (Eco Mode), and 3) high-performance mode P (Power Mode), collectively known as PACC sub modes.

For example, for a passenger vehicle with a gross weight not greater than 3.0 tons, its maximum driving power exceeds 125 kW; but for a fully loaded HDT with a gross mass (or weight) up to 40 tons, its maximum driving power is not greater than 400 kW. The driving power per unit weight (kW/ton) of the HDT is far less than that of the passenger vehicle; in other words, the acceleration performance of the HDT is much less than that of the passenger vehicle, and the emergency braking distance of the HDT is much longer than that of the passenger vehicle, and the dynamic driving characteristics of the two vehicles are quite different. It is difficult for a fully loaded HDT to maintain a constant speed on the highway with more than 2.0 degrees up and down the longitudinal slope and follow the passenger vehicle straight ahead with a constant distance when running on an uncrowded expressway. Every time the HDT is accelerated uphill or braked downhill, the fuel consumption and emission will increase. When the ACE HDT enters PACC cruise control, it needs to set an upper limit and a lower limit of a cruise speed zone reasonably according to the rated cruise speed Vc and sub modes selected by the driver. The three PACC sub-modes have different focuses, where the normal mode (N) gives consideration to fuel saving and freight transport timeliness; the fuel-saving mode (Eco) emphasizes fuel consumption but relaxes the requirement on freight transport timeliness (it can be slow but must save fuel); the high-performance mode (P) emphasizes freight transport timeliness but relaxes the fuel-saving requirement (it can consume fuel but must be fast). Preferably, the upper and lower limits of the cruise speed zones of the following sub-modes can be selected:

In the normal mode (N), the cruise speed (1.0−0.08)Vc<V<(1.0+0.05)Vc and cannot exceed 103% of the legal maximum speed in this road section; in the Eco mode, the cruise speed (1.0−0.12)Vc<V<(1.0+0.05)Vc and cannot exceed the legal maximum speed; in the high-performance mode (P), the cruise speed (1.0−0.04)Vc<V<(1.0+0.05)Vc and cannot exceed 105% of the legal maximum speed.

The VCU 201 calculates and adjusts the safe following distance time-varying function Lₛ (t) (safe following function for short) of adaptive cruise control in real time according to the vehicle configuration parameters (particularly the gross weight of the whole vehicle) and dynamic operation data (particularly longitudinal speed) of the ACE HDT 010 in combination with the current 3D road information (longitude, latitude and longitudinal slope) of the vehicle as well as the longitudinal slope distribution function, bend curvature and other 3D information of roads within the vehicle electronic horizon (km-level) stored in the map unit 240. Different from fast-moving passenger vehicles, the longitudinal slope data (positive and negative/size) of the road ahead has a greater influence on the acceleration (i.e., driving performance) and the deceleration performance (i.e., braking effectiveness) of loaded ACE HDTs running at high speed. It is unnecessary to dynamically adjust the safe following distance Lₛ of the passenger vehicle according to the longitudinal slope distribution function of the road because both the driving power (kW/t) and braking power per unit mass are several times as much as those of a HDT; however dynamic adjustment of Lₛ is very important for the driving active safety of the ACE HDT in above-mentioned PACC sub modes. The safe following distance Lₛ can be then subdivided into three specific distances: L1 is the early warning distance, L2 is the warning distance, L3 is the emergency braking distance, where L1>L2>L3. The VCU 201 can dynamically calculate the above three following distance functions L1, L2 and L3 at a refreshing frequency of higher than 10 Hz according to the vehicle configuration parameters and driving operating condition data (e.g., vehicle gross weight and vehicle speed, etc.), real-time weather conditions (wind, rain, snow, ice, temperature, etc.) and the 3D road data (longitude, latitude and longitudinal slope, etc.) within a kilometer-level range ahead of the vehicle in combination with the vehicle dynamics equation (1-1). It is apparent that the safe distance functions are highly correlated with known data such as the instantaneous vehicle speed of the ACE HDT, the longitudinal slope function within a hundred meter-level range ahead of the vehicle, the weight of the whole vehicle and the like. In a road section without long slopes or high mountains, for a fully loaded HDT driving at the vehicle speed of 60 mile/h, the early warning distance L1 is longer than or equal to 250 m, the warning distance L2 is longer than or equal to 150 m, and the emergency braking distance L3 is longer than or equal to 50 m.

When the safe distance function Lₛ of the ACE HDT 010 is equal to the early warning distance L1 and the relative speed v is greater than 0 (the following distance between two vehicles is shortened continuously), the VCU 201 gives an early warning prompt according to at least one of various physical signals such as sound, light, and tactile sense in the vehicle and reduces (0.1 s time delay) the duty cycle of the PWM impulse sequence of the engine 101 to be smaller than 0.5 immediately as well to reduce the average power function value of the engine. The vehicle is driven based primarily on the battery packs and secondarily on the engine. The battery packs 130a&b work in the CS mode or the CD mode, so as to make preparation for fast (10 ms level time delay) regenerative braking; when the safe distance function Lₛ is equal to the warning distance L2 and the relative speed v is greater than 0, the VCU 201 gives a higher strength warning prompt according to at least two of various physical signals such as sound, light and tactile sense in the vehicle, and reduces (ms-level time delay) the duty cycle of the PWM impulse sequence of the engine 101 to be zero immediately as well. The engine then enters into a non-combustion and dragged state, and the minute-level average power function value of the engine is a negative number and the engine becomes a mechanical load. The battery packs 130a&b work in the CS mode or the CD mode and provide all driving electric power of the vehicle. The following distance Lₛ can be maintained between the warning distance L2 and the emergency braking distance L3 as best as one can by means of an ability of the motor and the battery packs to be switched quickly between hundred kW level driving power and the regenerative braking power within a 10-ms response time, and is ready for emergency braking; when the safe distance function Lₛ is equal to the emergency braking distance L3 and the relative speed v is greater than 0, the VCU 201 gives the highest strength emergency braking alert simultaneously according to various physical signals such as sound, light, and tactile sense in the vehicle, and maintains the duty cycle of the PWM impulse sequence of the engine 101 to be zero, and starts the braking function of the engine and the vehicle immediately. At this time, the minute-level averagebpower function value of the engine is a negative number. After second-level time delay, the braking power of the engine can reach hundred kW-level, and regenerative braking emergency brake assistance with a peak value of five hundred kW (10 ms time delay) can be implemented immediately, and meanwhile, a one megawatt-level mechanical braking emergency brake (sub-second-level time delay) is started immediately; regenerative braking and engine braking both are emergency braking assistant functions. The combined braking power is not enough for emergency stop of the HDT driving at a high speed, but out-of-control of the vehicle due to the locking of driving wheels can be avoided; for the fully loaded HDT driving at the high speed, the maximum regenerative braking power of the driving motor (140 or 170): 500 kW can only meet the auxiliary braking deceleration requirement when the acceleration is about −0.1 G (gravitational acceleration); in emergency, emergency braking with the acceleration exceeding −0.2 G can be realized by starting the frictional mechanical braking system (megawatt-level) of the HDT by means of stepping on a braking pedal by a driver or a wire control signal of the ADAS system. The combined time delay of the response time of the driver braking plus the response time of the mechanical braking (pneumatic brake) system of the HDT exceeds 500 ms; however, the system response time of the VCU 201 from hundred kW-level driving mode to hundred kW-level regenerative braking mode can be completed in 25.0 ms, an order of magnitudes faster than the response speed of the traditional HDT driver+mechanical braking system, and the power regenerative braking system and the mechanical braking system are completely independent of each other; the regenerative braking function of the driving motor of the ACE HDT not only improves the comprehensive braking performance of the vehicle, but also provides safety redundancy. Above-mentioned various technical measure sets for dynamically controlling the vehicle cruising speed zone or the safe following distance are collectively called an intelligent cruise control (iCC) technology or function. Apparently, compared with ACC for vehicle or conventional diesel HDT in the set in the prior art, the iCC of the present disclosure has an essential difference in either specific technical measure or technical effect. Compared with modern European and US 15 L diesel HDTs with top configuration, the ACE HDT of the present disclosure has obvious advantages in whole vehicle driving performance, braking effectiveness, system redundancy and the like. The iCC function is an important sub-function in the PACC function of the ACE HDT.

The working scenario of PACC of the ACE HDT can be divided into two categories. The first category: when there are no vehicles within a distance of 200 m in the same lane ahead, the ACE HDT is controlled to drive in an appointed vehicle speed zone according to the fuel saving ML algorithm. The second category: when there are vehicles within a distance of 200 m in the same lane ahead, first, it needs to control the ACE HDT within the above-mentioned three safe following distances Lₛ and then consider the fuel saving ML algorithm. In other words, the control algorithm involving driving safety of the vehicle has higher priority or weight of the wire control signal than the control algorithm involving energy saving and emission reduction.

Heavy duty trucks for long-haul freight will encounter congested roads due to rush hour traffic, road repairing or traffic accidents and other factors from time to time (the average speed is less than 40 km/h; frequent active acceleration and deceleration); at the moment, both the driver's driving labor intensity and the fuel consumption of the HDT are increased sharply. Congested expressways are one of the long-term “pain points” in the road freight industry in the world, and the average congestion degree of expressways in China is higher than that in America, and the average vehicle speed is lower. At the moment, the ACE HDT can enable the “intelligent following” function, which can only be used when driving at low speed on a closed road (e.g. expressways or urban elevated expressways) (the average speed is less than 30 km/h), not suitable for use on open urban or suburban roads. By using the SRR and the camera 230, a set safety following distance L0 is kept with the lead vehicle right ahead in the same lane in a closed and congested highway section, the ACE HDT is commanded by the VCU 201 to disengage the clutch 111, so that the ACE HDT operates in the series-hybrid mode. The iSS is performed on the engine 101, the vehicle mainly operates in the CS mode, and the frequent active acceleration or braking of the vehicle is completely realized by the driving motor. The driving motors 140 and 170 can maintain the maximum torque output from zero speed to rated speed. Both the starting acceleration and braking deceleration of the ACE HDT are significantly higher than those of the conventional HDT with an engine and even comparable with the acceleration and deceleration performances of a light duty trucks with a conventional engine. At the moment, the HDT brakes frequently, which is quite favorable for recycling energy by hundred kW-level regenerative braking. The ACE HDT is more fuel efficient in the “Intelligent following” mode compared with the conventional HDT with an engine. The actual fuel saving rate can be higher than 30%. Meanwhile, the driving labor intensity of the driver can be reduced greatly.

When a loaded HDT runs along a long-downhill path of a highway, the risk of performance degradation (Brake Fade) in the mechanical brake system due to long-time braking friction and heating, or even complete failure, cannot be overlooked. In March 2018, 17 people were killed and 34 injured in a traffic accident at a toll station of Lanzhou, China's Lanhai expressway, when a HDT's braking system overheated and failed as it was driving along a long downhill section. European regulations mandatorily require that frictionless retarders must be installed on HDTs for long-haul freight. Although there are no mandatory regulation requirements for retarders of HDTs in USA and China, more and more fleets start to choose HDT retarders. The existing mass-produced commercial retarders, such as eddy current retarder, hydraulic retarder and engine brake retarder, have their own advantages and disadvantages. Both the eddy current retarder and the hydraulic retarder have only one retarding function without any contribution to vehicle driving, increases the vehicle weight and cost by more than ten thousand yuan (RMB), and leads to poor retarding effect when the vehicle is running at low speed. The engine in-cylinder or out-cylinder brake retarder has the advantage of one machine serving several purposes, but the in-cylinder retarder working brings loud noise, the braking power is mostly below the peak power of the engine, and the retarding effect decreases significantly when the vehicle is running at low speed. In addition to the beneficial effects of fuel saving and emission reduction, the ACE HDT powertrain of the disclosure can also realize the long-downhill retarder function of the ACE HDT through regenerative braking of the motors (110, 140, 170) and in-cylinder and out-cylinder braking of the engine 101 without adding any extra hardware. It can completely replace the eddy current retarder or hydraulic retarder, and the performance to price ratio is higher than that of several commercial HDT retarders.

When the ACE HDT 010 drives downwards along a long slope road section (the absolute value of the longitudinal slope is greater than 2 degrees and the slope length is greater than 5 km), the grade power alone is enough to overcome rolling resistance power and air drag power to drive the vehicle downward at a constant speed. Surplus grade power is recovered through regenerative braking of the motors (110, 140 and 170), to avoid downward acceleration of the truck or using the mechanical brake to waste the surplus grade power into heat. The clutch 111 commanded by the VCU 201 can be closed and locked (on), and the vehicle works in the parallel-hybrid mode. At this time, the engine 101 can work in the iPS control mode in a particular case, namely, the duty cycle of the PWM impulse sequence is set to zero and enter the zero fuel consumption and zero emission working condition of non-combustion low load idling (the engine braking function is not activated) or non-combustion high load idling (the engine braking function is activated). The generator 110 and the driving motor 140 or 170 can cooperate to generate electrical power through regenerative braking to recover the mechanical energy of the vehicle going downhill, and the battery packs 130a&b are charged via the ePSD 123. When the battery packs 130a&b are fully charged (the SoC reaches URL), the choppers 132 a&b cut off the battery packs 130a&b, and meanwhile, the voltage-controlled switch 133 is switched from off state to on state and is unidirectionally and electrically connected to the braking resistor 131 so as to convert surplus electric energy into thermal energy as an effective load of the regenerative braking. In the parallel-hybrid mode, the braking power of the engine and the regenerative braking power of the motor can be combined, which can not only greatly improve the total power of the frictionless retarder, but also provide two sets of mutually independent redundant retarding systems to improve the active safety of the HDT running downhill. In addition to energy recovery for fuel saving and emission reduction at near zero cost, the regenerative braking can also significantly prolong the service life of mechanical brake pads and reduce the total operation and maintenance costs of the mechanical braking system within the whole life cycle of the ACE HDT 010. For the sake of active safety, when going down a long slope, regardless of high and low vehicle speeds, the ACE HDT should operate in the parallel-hybrid mode first and avoid the series-hybrid mode.

The ACE HDT hybrid powertrain system of the disclosure is a fully digital software-defined powertrain system, including the 1D longitudinal L1 autonomous driving function and various upgradable items of 2D lateral L2, L3, or L4 autonomous driving functions. The volume commercialization of ACE HDT will have a profound impact on the HDT industry for global long-haul freight, analogous to the industrial upgrading of the global mobile communications industry from feature phones to smart phones. The ACE HDT can be easily upgraded from L1 to L3 or L4 by installing a variety of environment sensors, wire-controlled automatic steering device, autonomous driving AI chips and other hardware and software upgrades. Industry experts agree that it will be difficult for L5 driverless HDT to enter volume commercialization in major global markets by 2030. All autonomous driving HDTs of L1 to L4 must comply with the functional safety standard ISO 26262 for road vehicles to achieve a specific automotive safety integrity level (ASIL level). The higher the level is, the higher the requirements on system reliability and redundancy are. The ACE HDT is based on system integration including drive motors 140 and 170, battery packs 130a&b, and ePSD 123 to achieve the high-performance pure electric driving, the regenerative braking, energy recovery, the automatic emergency braking assistance (AEBA), and the long-downhill retarder function. Besides the conventional engine and mechanical brake systems of the vehicle, a separate set of completely independent and redundant active safety system of power regenerative braking is installed, as well as a redundant vehicle electric driving system (engine with multiple electric motors) and a redundant electrical power supply. Compared with the traditional HDT with an engine based on the prior art, the ACE HDT of this disclosure can improve the three ultimate goals of the automobile industry simultaneously with high performance-to-cost ratio: safety, energy saving and environmental protection.

It is predicted that the preliminary small-scale business of “Truck Platooning” of HDT can be implemented in relatively open closed highway areas in Europe and US from 2020. The “Truck Platooning” of HDT means reducing the safe following distance between two HDTs running at a high speed from the regulatory requirement of over 45 m to under 15 m below through a complete set of advanced driving assistant system (ADAS)+a real-time reliable wireless mobile communication (V2V, V2X) between vehicles as well as between the vehicle and cloud, which helps to reduce the air drag power of the two HDTs ahead and behind significantly, saving 4% fuel of the leading HDT and saving 10% fuel of the following HDT. In view of safety, the emergency braking performance of the following HDT should be superior to the leading HDT, so as to avoid rear-end collisions. The high speed emergency braking performance of the ACE HDT is significantly superior to traditional fuel HDT with the same gross weight, therefore the ACE HDT should be following HDT in the truck platooning of HDT, which may further save fuel. In view of fuel saving, smaller following distance in truck platooning is not necessarily better. When the following distance is less than 7 m, the effective air speed of the front radiator of the following HDT will be reduced, and the heat dissipation effect will be lowered; and at the moment, it is required to start the mechanical fan of the radiator with a power dissipation of tens of kilowatts to provide the dynamic heat dissipation power required for the HDT diesel engine, which may result in no reduction and even a rise of comprehensive fuel consumption of the following HDT. The engine displacement of the ACE HDT is reduced by nearly 20% than the engine displacement of the conventional HDT, which means both cross section area and heat dissipation power of its radiator may be reduced by about 20%, and therefore, an efficiently wire-controlled electric fan of the water tank can be used; meanwhile, compared with the conventional HDT, the ACE HDT has faster emergency braking response, and shorter braking distance. Serving as a following vehicle, the ACE HDT can shorten the safe following distance of a truck array of the ACE HDT to 6 m, or even 5 m, in an expressway section without long slope (the absolute value of longitudinal slope is less than 2.0 degrees and the slope length exceeds 5 km), and may achieve more than 10% additional fuel saving by further reducing the air drag power. When the HDT platoon goes down a long slope, for the sake of safety, spacing among HDTs shall be increased properly, which not only guarantees the safety, but also keeps the fuel consumption in check. After the HDT array arrives at the slope bottom, normal spacing is then recovered.

In North US or European markets, there are mandatory regulatory requirements on daily hours of service (HOS) on long-haul freight HDT drivers like airline pilots. They work for 14 hrs. at most every day, the driving time is 11 h at most, and then the drivers must rest for 10 h. In China, HDT drivers (single or double drivers) also need to stop for several hours in route. Different from the situation that Chinese HDT team drivers are very common, European and US double drivers (Team Drivers) are rare. When parked to rest, the HDT is the hotel of the driver. The engine needs to idle (low speed and low load) to provide mechanical energy or electric energy needed by normal operation of various hotel loads. For example, various electric appliances need to be powered in the cab, and particularly, a mechanical or electrical air conditioner which cools in summer and heats in winter. Apparently, long-time idling of the engine of the HDT not only wastes fuel, but also increases pollutant emissions. For energy saving and emission reduction, Europe has strict anti-idling regulation, while China and the USA currently do not have any national anti-idling regulation. Several states in the USA have local regulations specifying that the engine idling of the HDT during parking shall not exceed 5 minutes. In order to meet the EU Anti Idling regulations and/or improve the quality of life for HDT drivers during long haul, each European HDT is equipped with a battery pack or pocket diesel engine based APU costing tens of thousands of yuan (i.e., thousands of dollars), and some US and Chinese HDTs are gradually equipped with the above-mentioned system. For the ACE HDT of the present disclosure, the battery packs 130a&b can be fully charged (SoC reaches URL). At the moment, the battery packs 130a&b and the ePSD 123 can completely replace the above-mentioned independent APU, major advantages of the APU in the prior art are maintained, and major defects thereof are overcome. Under the condition of not increasing the hardware cost, it can support all the Hotel Load power demands of HDT drivers when they park and stop their engines for ten hours, for example household or office electric appliances such as A/C heating or refrigeration, electric lamp, TV, refrigerator, microwave oven, induction cooker, computer and printer. It not only optimizes energy saving and emission reduction, but also improves the living quality of the HDT driver in long haul freight transport obviously.

In a special or emergency situation, the ACE HDT 010 can further increase a brand new “Intelligent Mobile Micro Grid” (iMMG) function only through software definition without adding any extra hardware. The ACE HDT is parked to generate electrical power by fuel to become a mobile three-phase alternating current micro grid (Micro Grid) temporarily with 250 kW nominal power. There are two specific implementation methods: first, the truck is parked to generate power in the series-hybrid iSS mode, and at the moment, the driving motors (140 and 170), the transmission 150 and the like are not in operation, and a three-phase alternating current suitable for all regions in the world is outputted outwards from a port I or a port II of the ePSD 123 by utilizing the inverters 121, 122a&b; the battery packs 130a&b serve as the energy storage units of the micro grid for dynamic peak-load shifting on its electric power, thereby guaranteeing that the engine 101 operates in an efficient area all the time and optimizing energy saving and emission reduction. Apparently, in the series-hybrid iSS mode, the nominal power of the mobile micro grid is limited to nominal power of the generator 110 and is smaller than 200 kW. Second, the parallel-hybrid iPS mode is used, and at the moment, the clutch 111 is closed, and the generator 110 and the driving motor 140 can operate synchronously to generate power, and a three-phase alternating current suitable for all regions in the world is outputted outwards from a port I or a port II of the ePSD 123 by utilizing the inverters 121, 122a&b; the sum of the nominal powers of the duo-motors (110&140) is greater than the peak power of the engine 101, and the upper limit of the nominal power of the micro grid is increased to the peak power of the engine 101 (i.e., the maximum continuous mechanical power) and is greater than 300 kW; the battery packs 130a&b also serve as the energy storage units of the micro grid for dynamic peak-load shifting on its electric power, thereby guaranteeing that the engine 101 operates in an efficient area all the time and optimizing energy saving and emission reduction. Apparently, at the moment, the transmission 150 must operate in Neutral gear. Provided that the fuel (diesel or natural gas) of the engine is sufficiently supplied, the ACE HDT can operate for several days or a longer time in the iMMG mode so as to provide the high quality three-phase alternating current with nominal power exceeding 250 kW for emergency use continuously.

It is needed to emphasize that the I fuel-saving robot configured for the ACE HDT realizes the 1D longitudinal SEA L1 autonomous driving function through the technical measures of the PACC in the expressway ODD, thereby achieving a beneficial effect that the comprehensive fuel consumption (liter/100 km) is reduced by nearly 30% compared with that of the conventional diesel HDT. It is mainly dependent on a electric hybrid powertrain technology, particularly the ePSD, and makes full use of priori data of the 3D map of the electronic horizon, vehicle dynamic working condition data and the onboard-cloud cooperated fuel saving data set and the fuel saving machine learning (ML) algorithm. Even if the human driver drives the ACE HDT manually, nearly 25% of fuel saving rate can be also realized (compared with that of the conventional diesel HDT), namely, about 80% of energy saving and emission reduction optimizing potential. Commanded by the “fuel-saving robot”, the longitudinal L1 autonomous driving (i.e., PACC) in the expressway ODD is realized, so that it is ensured that the comprehensive fuel consumption (liter/100 km) of each ACE HDT is highly decoupled with the technical sophistication and performance of the engine of the vehicle and the personal driving skills of the driver (referring to ability, road experience, working altitude and the like). It is obviously superior to the human driver in both fuel saving rate and consistency. The ACE HDT of the present disclosure adopts the mature and volume production key components and system integration technology, which has obvious fuel-saving effect and high cost effectiveness. Not dependent on government subsidies, payback can be realized within 2.5 years (i.e., the price difference between the ACE HDT and the conventional diesel HDT is made up) simply relying on saving of fuel charge. The accumulated profit of the trucking company is doubled in 5 years. The retrofit ACE HDT can be commercialized at volume in North America within three years. Other commercialized fuel saving technologies of HDTs for long-haul freight, such as low rolling friction tires, lightweight and low drag coefficient (tractor and trailer) and the like, can be directly applied to ACE HDTs. It is expected that the ACE HDT that will be commercialized at volume around 2022 will reduce the overall fuel consumption (L/100 km) of the baseline for 2018 version of the traditional heavy duty diesel truck by more than 25%.

Unlike prior art, the ACE HDT 010 of the embodiments shown in FIG. 1 to 5 in the present disclosure depends on the full digital software defined mixed hybrid powertrain, the VCU 201 gives command in cooperation with the AIU 202 according to vehicle parameters and dynamic operational data and using the prior 3D road map data in the electronic horizon stored in the MU 240 and the fuel saving ML algorithm, the average power function value (i.e., minute-level rolling time average power) of the engine is controlled dynamically and continuously by implementing Pulse Modulation control (PM), particularly bipolar pulse width modulation control (PWM), including iSS, iPS, iMS, and CGS on the instantaneous power function of the engine 101; in addition, the flow direction, path, and amplitude of the 100 kW-level electric power are regulated dynamically among numerous power sources or loads (e.g. generator 110, driving motor 140 or 170, battery pack 130a or 130b, brake resistor 131 and the like) externally connected to a power electrical network with three ports through the ePSD 123; Pulse amplitude modulation control (PAM) can be implemented on the instantaneous powers of the battery packs 130a&b according to a series-hybrid power balance equation (2-4) or a parallel-hybrid power balance equation (3-3), so that the battery packs (130a&b) work steadily in one of the CS, CD, or CI modes or are switched smoothly among these three modes, thereby achieving predictive control on the average SoC function (i.e., minute-level rolling time average function of the instantaneous SoC function) of the battery packs, and meanwhile pursuing the maximum regenerative braking charge turnover rate and the minimum engine charge turnover rate; so that the vehicle dynamics equation (1-1) is satisfied in real time; further, in combination with the iCC function, the PACC function of the whole vehicle is realized; and multiple beneficial effects of more than 25% of fuel consumption reducing (liter/100 km) compared with that of a modern diesel HDT, greatly enhancing the driving performance and the braking effectiveness of the vehicle, ensuring that the RDE (actual) exhaust emissions reliably meet the current emission standard for a long time, reducing the driving labor intensity of the driver, improving the rest experience of the driver with the vehicle parked in an anti-idling state and the like are achieved. The fuel-saving robot of the present disclosure converts the power management problem or the energy management problem of the ACE heady duty truck in the expressway ODD into an equivalent narrow artificial intelligence problem of computer playing the game of Go through the technical measures of PACC, which is quite suitable for storing and uploading to the cloud the fuel saving data set by utilizing the ML fuel saving algorithm and the computer readable medium of the present disclosure, and automatically masters the optimum fuel saving strategy and evolves continuously and independently through using (training or inferring) fuel saving AI chips at the cloud and on the vehicle. The fuel-saving robot of the ACE HDT is much better than the human driver in the simultaneous optimization of RDE energy saving and emission reduction with extremely high consistency, and can become a reliable copilot of the human driver.

As discussed above, when driving on a loaded expressway, the ACE HDT can harvest 100 Wh level or kWh level “zero-cost electric energy” (regenerative braking charge) from each downslope between one hundred meter and several kilometers by skillfully using the downhill grade power between tens of kilowatts and hundreds of kilowatts generated from subtle changes in the accuracy along the longitudinal slope 0.1° along the road that frequently occurs and by charging the battery packs 130a&b through the regenerative braking power generation of the driving motors 140&170 after the ePSD 123 performs rectification. Many small savings accumulated to become a large one. In addition, the comprehensive energy conversion efficiency from the battery to the driving wheel in ACE HDT is two times larger than that from the fuel tank to the driving wheel. In other words, compared with chemical energy of a fuel in the fuel tank, electric energy in the battery packs of the ACE HDT is one against three of the fuel energy when driving the vehicle to apply work. The secret of the ACE HDT saving fuel under the working condition of expressways is to maximize the zero cost “regenerative braking charge” accumulated in the battery packs 130a&b, supply a portion of the driving powers of the vehicles, to increase the accumulated throughput electric energy turnover rate of the 130a&b in the whole transport event, particularly, the regenerative braking charge turnover rate, and to reduce the engine charge turnover rate, thereby achieving the optimum fuel saving effect.

The VCU 201 evaluates the situation and makes decisions in real time according to the priori 3D road data in the electronic horizon of the MU 240, so as to ensure that there is sufficient time to command the clutch 111 to engage and lock before it encounters a long slope with a length of more than 10 km and a longitudinal slope of more than 2.0%. When switched to the parallel-hybrid mode, the iPS is implemented on the engine 101 and the generator (MG1) 110, and when the vehicle arrives at the foot of the long slope, the battery packs 130a &b are fully charged in time (JIT) (SoC reaches URL) and the vehicle speed is safely increased to the legal upper speed limit, so as to delay and reduce the undesirable condition that on the way uphill, the ACE HDT 010 only has to switch to low gear to run uphill at lower speed because the peak power of the engine is insufficient to independently support the vehicle to run uphill at constant high speed after the battery pack is used up in the vehicle climbing process to the maximum extent, which affects the vehicle driving performance and transportation timeliness of the vehicle. According to the 3D map stored by the onboard MU 240, particularly the high accuracy longitudinal slope spatial distribution function in the electronic horizon, configuration parameters, dynamic working conditions and positioning data of the vehicle, the VCU 201 can dynamically predict the grade power time-varying function and a road-load instantaneous power time-varying function of the vehicle in the electronic horizon (hour level or hundred km-level) at a kw-level accuracy at a refreshing frequency over 1 Hz through the vehicle dynamics equation (1-1) so as to achieve predictive control of the average SoC function of the battery packs 130a&b through PM control (series-hybrid iSS or parallel-hybrid iPS) on the instantaneous power function of the engine 101 and PAM control on the instantaneous power function of the battery packs 130a&b. According to different sub modes of the PACC of the vehicle selected by the driver, under the precondition that the driving safety and the real emission (RDE) meet regulation all the time, the optimum dynamic balance between the fuel saving performance and the driving performance of the ACE HDT is sought to meet the vehicle dynamics equation (1-1) and the power balance equation (2-4) or (3-3) in real time, thereby achieving a beneficial effect of energy saving and emission reduction of the vehicle. It needs to be emphasized that the minimum value of the comprehensive fuel consumption (liter/100 km) of a certain ACE HDT that completes a special freight event is highly correlated with the configuration parameters and load of this vehicle, the longitudinal slope spatial function along the way of the specific journey (or route), weather conditions along the way on that day, dynamic working condition data of the vehicle among the way, etc., but is weakly associated with the macroscopic large number average fuel consumption value of the HDTs with similar configurations and loads throughout the country. The minimum average fuel consumption is realized when the ACE HDT operates per minute or drives per km. By means of accumulation and linear superposition, it can ensure the cumulative comprehensive fuel consumption of this ACE HDT is optimal daily, monthly, annually and throughout its full life cycle. For all ACE HDTs with different configurations and loads, the fuel saving data set of running in a specific freight route that are formed from month to month is precious “data petroleum” that trains machine learning fuel saving algorithm. A default fuel saving control strategy recommended by the cloud fuel saving algorithm has common reference and guiding significance for each ACE HDT that is operated in this journey.

How to timely (minute or hour-level time delay) upload the fuel saving data set that is collected and locally stored in the above-mentioned ACE HDT 010 during the driving period to the cloud computing platform 001 for storage via a mobile Internet 002 through an onboard wireless gateway 210 after desensitization and encryption for subsequent analysis and processing is described below. The cloud platform 001 assembles enough computing power of a public cloud or a private cloud and uses the preferred ML fuel saving algorithm, trains the AI brain of the cloud “fuel-saving robot” by means of the accumulated fuel saving data set of the ACE HDT stored at cloud, automatically establishes and continuously improves a DNN model, and seeks for the optimal control strategy for fuel saving; the cloud platform downloads a fuel consumption benchmark value and a default fuel saving control strategy for the specific route to each ACE HDT through the wireless mobile communication network, so that each ACE HDT can be benefited from collective intelligence; each ACE HDT can perform vehicle-end “edge computing”, i.e., AI inference operation as its VCU 201 cooperates with the AIU 202, and dynamically modifies the default fuel saving control strategy of this vehicle in real time according to the environment, road conditions, and dynamic data of vehicle operation of the ACE HDT at this moment and this place, so as to minimize the RDE fuel consumption of the transport event (i.e., a truck with cargoes from the starting point to the finishing point) for this vehicle.

In some embodiments, in the driving process of the ACE HDT 010, various configuration parameters or dynamic operating data from every major powertrain subsystem such as the generator set (including the engine 101, the ECU 102, the generator 110 and the inverter 121), the ePSD 123, the clutch 111, the driving motor 140 or 170, the automatic transmission 150, TCU 151, the braking resistor 131, and the battery packs 130a or 130b all can be measured and collected (the refresh frequency for measurement and record is above 5 Hz) by “Internet of Things” formed by the onboard multi-sensor on the ACE HDT 010 in real time, and stored in the format of structured big data commonly used in the industry in a concentrated way, such as the onboard VCU 201 memory or other onboard memories. Of course, the above-mentioned measured data is dispersedly stored in memories of microprocessors corresponding to several subsystems. The so called “fuel saving structured big data” (the “fuel saving data set” for short) refers to a multi-dimensional time sequence set “associatively” recorded with a certain “mapping relation” about operating dynamic data of every subsystem in the driving process of the ACE HDT.

For example, it can timely (minute-level time day) and repeatedly calibrate clocks of microprocessors of onboard subsystems including the VCU 201 clock by taking 10-nanosecond level ultrahigh precision timing of the GNSS 220 as the sole reference clock of the whole vehicle system, annotate and synchronize dynamic operating data of each subsystem of the ACE HDT automatically with an ordered and unique operating time sequence of the vehicle system for the convenience of splicing and synthesizing a multi-dimensional time sequence subsequently so as to generate the fuel saving data set for the specific ACE HDT and the specific freight event. As shown in FIG. 1-5, important subsystems on the vehicle 010, including the VCU 201, the AIU 202, the engine 101, the engine control module 102, the generator 110, the electrical power split device (ePSD) 123 (including the inverters 121, 122a&b; the voltage-controlled switch 133; the choppers 132a& b and the like), the clutch 111, the driving motors 140&170, the battery packs 130a&b, the brake resistor 131, the AC switchboard 135, the transmission 150, the transmission control unit 151, the millimeter wave radar 230, the mobile communication gateway 210, the map unit 240, the GNSS 220 and the like have corresponding dedicated microprocessors, memories and sensors. All these subsystems can measure, calculate and record or store the time sequence of main operating data uniquely annotated with vehicle operation time in real time at the local vehicle end within a measurement frequency (fₘ) range of 1.0 Hz<fₘ<50.0 Hz. For example, the engine control module 102 can calculate and record the dynamic operating data such as the longitudinal vehicle speed, the rotating speed, the torque and the brake specific fuel consumption (BSFC) of the engine 101 at a measuring frequency over 10 Hz; the generator control unit (inverter) 121 can record the dynamic data such as the rotating speed and torque of the generator 110, the internal temperature of the motor or the output DC voltage, current and internal temperature of the generator control unit 121 at a measuring frequency over 10 Hz; the ePSD 123 can record the dynamic data such as a unique DC voltage function at the DC bus junction point X and DC current functions of all branch circuits at a measurement frequency over 10 Hz; the battery management module (BMS) configured on the battery packs 130a&b can record dynamic data such as its output DC voltage and current, and current, voltage, temperature and SoC of its internal cell and battery module levels at a measuring frequency of 10.0 Hz; the inverters 122a&b can record the dynamic data such as the rotating speed and torque of the mechanical shaft of the driving motors 140 and 170, internal temperature of the motors, current and voltage at the DC end of the inverters at a measuring frequency over 10 Hz; the choppers 132a&b can calculate and record dynamic data such as DC voltage and current at its high voltage end or low voltage end at a measuring frequency over 10 Hz; the transmission controller 151 can record the dynamic data such as the transmission gear, the input end rotating speed and the output end rotating speed at a measuring frequency over 2.0 Hz; the satellite navigator 220 can calculate and record the dynamic data such as the longitudinal vehicle speed and acceleration, the longitude and latitude, the longitudinal slope and timing of the vehicle at a measuring frequency over 5 Hz; the millimeter wave radar 230 can calculate and record the dynamic data such as the absolute distance and the relative speed between the vehicle and the front vehicle at a measuring frequency over 10 Hz; and the voltage-controlled switch 133 can record the dynamic data such as its DC voltage and current at a measuring frequency over 10 Hz. The sensor measurement data of subsystems may overlap each other, and data overlapping redundancy helps to improve the fault tolerance and error correction of the whole system.

Next, as shown in FIG. 1-5, the VCU 201 generates the dedicated structured big data (“fuel saving data set” for short) highly correlated with the whole vehicle energy saving and emission reduction strategy of the ACE HDT generated in the operating process of the ACE HDT 010 through automatic splicing, integration, desensitization and encryption by taking a unidirectional unique annotation of the vehicle operation reference time sequence as the reference of the measurement data time sequence of all subsystems. Later, the “fuel saving data set” will be “instantaneously” (sub-second-level delay) or “timely” (hour-level delay) uploaded to the cloud computing platform 001 for centralized or distributed storage via a mobile Internet 002 or wired Internet, for subsequent data analysis and processing.

For example, as shown in FIG. 1 and FIG. 5, the fuel saving data set of the ACE HDT can be timely (minute-level or hour-level time delay) uploaded to, e.g., the cloud computing platform 001 on the mobile Internet to be dispersedly or centrally stored via the wireless communication gateway 210 and the cellular mobile network 002 for subsequent data processing. Optionally, the data packet can be desensitized and encrypted before being uploaded to ensure data security and protect privacy and trade secrets of customers (driver or company). The cloud platform 001 will collect fuel saving data sets of numerous ACE HDTs using the invention. AI chips at cloud and vehicle end of the “fuel-saving robot” are trained by utilizing the operating structured big data (i.e., the fuel saving sets) accumulated by a cluster of these ACE HDTs and deploying the computing abilities of corresponding cloud computers by focusing the fuel saving machine learning algorithm, where the cloud has the AI training chip and the vehicle end has the AI inference chip. A DNN model is automatically established and continuously improved, and the optimum control strategy for each ACE HDT and each freight event are sought for, and therefore, beneficial effects that the actual fuel consumption of the ACE HDT for long-haul freight is reduced by over 25% compared with that of the modern diesel engine HDT, the fuel consumption is basically decoupled with the skill of the driver and the performance of the engine. The commercially available AI training chip is preferably used by the cloud end 001, which has the characteristics of high universality, high performance, high power consumption and high cost; while the AI inference chip is preferably used by the vehicle-end AIU 202, which has the characteristics of specificity, moderate performance, low power consumption and low cost. The real-time linkage of the vehicle-end fuel saving AI inference chip 202 and the cloud-end fuel saving AI training chip can enable tens of millions of calculations per second (TOPS level) at the vehicle end according to the constantly changing driving conditions of the ACE HDT, seek for a dynamically optimal fuel saving control strategy in each second and minute of time frame (corresponding to 20 m to two km of driving distance); combustion to work of the engine 101 is free of hysteresis effect or memory effect, thereby finally achieving the macroscopically optimal fuel saving effect of the whole journey for the ACE HDT 010 through the microcosmically lowest fuel consumption (liter/100 km) in each time frame by means of constant accumulation and linear superposition. The AI brain of the fuel-saving robot (referring to VCU 201 plus the AIU 202) commanding the ACE HDT 010 to drive on expressway ODD achieves the 1D longitudinal autonomous driving function through the PACC, and converts the optimizing problem of energy saving and emission reduction of the HDT into an equivalent narrow artificial intelligence problem (also known as a narrow AI problem) of playing the game of go. Like AlphaGo playing the game of go can far surpass human being. The “fuel-saving robot” of the ACE HDT of the present disclosure can surpass human driver in actual fuel consumption and emission metrics of the long-haul freight HDT. It should also be emphasized that the “fuel-saving robot” of the present disclosure will be a good assistant of the HDT driver in long-haul freight rather than completely replacing the human driver.

The starting point and finishing point of each freight event of the HDT for long-haul freight are known in advance, the total vehicle weight (including the payload) is also known and fixed, and there are very few temporary and random changes; the mileages of freight events can range from hundreds of kilometers to thousands of kilometers, and the duration can range from several hours to several days. Before start of a freight event, the fuel-saving robot (VCU 201) or driver of the ACE HDT 010 can automatically require the AI “fuel-saving brain” on the cloud platform 001 through the wireless mobile gateway 210 or the mobile phone to download the optimal fuel saving control default program and current optimal fuel consumption metric (liter/100 km) for the freight event to serve as a reference for local real-time operation (edge computing) and the dynamic control for the fuel saving machine learning algorithm of the VCU 201 and AIU 202 of the vehicle. Thus, each ACE HDT can use the collective intelligence of all the ACE HDTs operating on the same road sections, thereby achieving the optimal fuel saving effect of the long-haul freight industry. After driving the ACE HDT onto a controlled-access expressway, the driver can select the sub mode (normal mode N/economy mode Eco/high-performance mode P) with the PACC function, activate the PACC function, and replace partial DDTs of the drivers with the VCU 201 in cooperation with the AIU 202, so as to achieve continuous automatic control (i.e., L1 autonomous driving) of 1D longitudinal movement (acceleration/cruise/slide/deceleration) of the ACE HDT, free up driver's feet for a long time, reduce the labor intensity in driver, and achieve the beneficial effects that the actual fuel consumption is optimum (i.e., the minimum value) and it is decoupled with the driving skill level of the driver and the like. It needs to be emphasized that hands, eyes, ears, and brain of the driver still work to take charge of Object and Event Detection and Response (OEDR) around the vehicle, control steering or emergency braking of the vehicle in real time, are fully responsible for safe driving of the HDT. The other beneficial effect of the present disclosure is that the fuel-saving robot realizes simultaneous optimization of energy saving and emission reduction of the vehicle with extremely high consistency, can effectively solve the well-known long-term problem in the long-haul freight industry that the RDE comprehensive fuel consumption spread can be up to +−20% due to human factors (road familiarity, driving skill, working attitude, fatigue and the like), guarantees that every ACE HDT can reliably and uniformly achieve the optimal fuel saving result when operating on the same road section, which is very important for trucking fleets in terms of reducing cost and increasing efficiency.

In summary, the essential difference between the ACE HDT 010 with PACC function in the present disclosure and any hybrid truck or conventional heavy duty diesel truck with similar functions available on the market today is that the former highly focuses on simultaneous optimization of RDE energy saving and emission reduction of the HDTs of long-haul freight, effectively solves the worldwide hard technical problem in global transportation industry, i.e., the fuel-saving result of any hybrid HDT in long-haul freight is not significant (the fuel saving rate is always less than 10%) compared with that of the conventional fuel HDT, and can achieve multiple beneficial effects that the RDE fuel consumption in long-haul freight can be reduced by more than 25%, and the driving performance and the braking effectiveness of the vehicle can be further enhanced greatly, and it can ensure that the ACE HDT can reliably meet the pollutant emission and carbon emission regulations for a long useful life (700,000 km emission standard warranty period) under the actual driving environment (RDE) of the three major HDT markets of China/US/EU. In other words, when the ACE HDT 010 is driven on a non-congested controlled-access expressway, the driver may only be responsible for the perception of objects or events (OEDR) around the vehicle and lateral vehicle control in a dynamic driving task (DDT), and the fuel-saving robot of the HDT will realize the 1D longitudinal L1 autonomous driving function of the vehicle through the technical measures of the PACC, thereby achieving simultaneous optimization of energy saving and emission reduction of the vehicle. The 1D longitudinal L1 autonomous driving function based on the PACC technology in the expressway ODD is a foundational function prerequisite from the basic Level I fuel-saving robot to the advanced Level IV fuel-saving robot, and specifically focuses on optimizing energy saving and emission reduction of the ACE HDT by AI, which is the “economic foundation” of the more advanced autonomous driving system. The Level IV fuel-saving robot further has a 2D horizontal L4 autonomous driving system compared with the Level I fuel-saving robot, which is a “superstructure building”.

In the driver preset sub mode (one out of three among common mode N/fuel saving mode Eco/high-performance mode P) of PACC, the fuel-saving robot of the HDT performs AI inference operation by using the vehicle energy management control strategy based on the ML fuel saving algorithm and the onboard real-time computing power according to performance characteristics and configuration parameters of key subsystems of the vehicle, dynamic data of the driving working condition of the vehicle and the priori data of the 3D road within the electronic horizon, performs iSS or iPS or iMS on the instantaneous output power of the engine 101, and performs PAM on the instantaneous power function of the battery packs 130a&b, so that the battery packs 130a&b work steadily in one of the three modes or switch smoothly among the three modes of CS, CD and CI, so as to meet the vehicle dynamics equation (1-1) and the power balance equation (2-4) or (3-3) in real time while meeting the constraints of vehicle driving performance, active safety, long-term compliance of RDE exhaust emissions and the like, and realize the minimization of the RDE fuel consumption in the entire freight event. Compared with the conventional diesel HDT, the RDE fuel saving rate can be as high as 30%. The “adaptive cruise control (ACC)” function of passenger vehicles or commercial vehicles in the prior art mainly provides the driving convenience and improves the active safety, with a negligible impact (less than 2%) on the RDE fuel saving rate of vehicles; the “predictive cruise control” of the conventional HDT with an internal combustion engine focuses on the vehicle energy management control strategy, but the actual fuel saving effect is only about 3% as energy cannot be recovered effectively. Different from the prior art, the technical solution of PACC of the ACE HDT of the present disclosure includes a set of any combination of various technical measures such as iSS, iPS, iMS, CGS, predicative SoC control (PSC), predicative energy management (PEM) based on ML fuel saving algorithm and iCC, and focuses on the simultaneous optimization of energy saving and emission reduction of the vehicle in the long-haul freight. Compared with the conventional diesel HDT, the RDE fuel saving rate of an ACE truck can reach up to 30%. This RDE fuel saving rate is extremely high in consistency and is basically independent of the skill of the driver and the performance characteristics of the engine 101. Furthermore, the technical solution also provides driving convenience, reduces the labor intensity of the driver and improves the driving performance and the active safety of the vehicle.

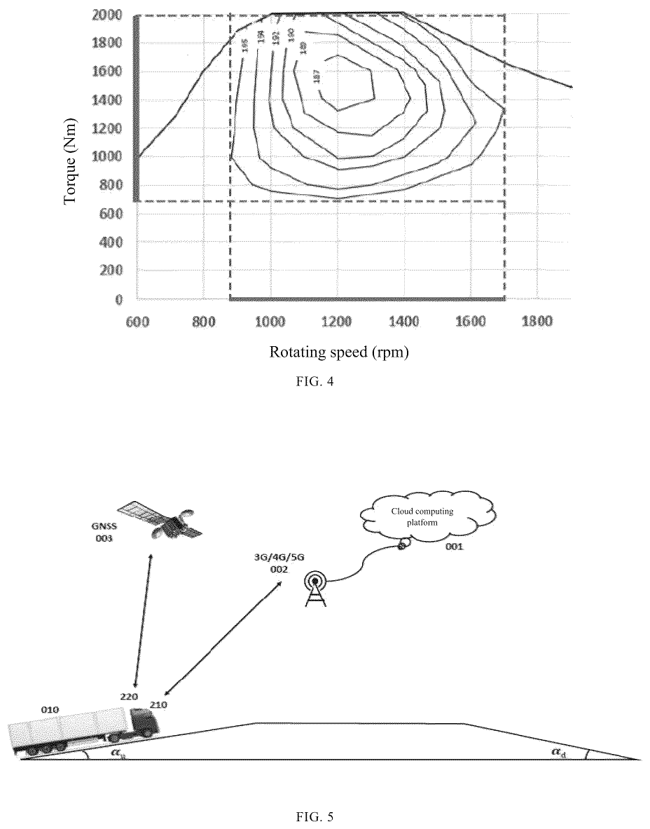

The comparator (CSB) 203 in FIG. 3 is an ASIL-D level high reliability electronic module including at least six input channels and at least two output channels. The module can be in bidirectional communication with the vehicle control unit (VCU) 201 or the onboard AI unit (AIU) 202 through a data bus of the ACE HDT 010 (for example, a CAN bus, referring to the dotted line in FIG. 1). To upgrade from the Level I fuel-saving robot of the ACE1 HDT to the Level IV fuel-saving robot of the ACE4 HDT, the main changes are to upgrade the hardware and software of the onboard AI unit (AIU) 202 and hardware and software of an onboard sensor suite, which enhances the perceiving and decision-making ability of the AI driver. The parts such as serial-parallel hybrid powertrain, steering and braking subsystems responsible for vehicle driving control are essentially unchanged. The millimeter wave radar (mWR) 230 in FIG. 1 should be construed as a sensor suite including a plurality of automotive-grade mass-produced millimeter wave radar, a camera, laser radar (LiDAR) combined, which sufficiently supports any one of L1 to L4 autonomous driving systems. The L4 sensor suite 230 and the L4 AI unit 202 are combined to form the perceiving and decision-making module (also called OEDR module) of the L4 system of the ACE4 HDT, i.e., the core part (including hardware and software) of the to-be-validated L4 system; the vehicle wire control signals W₁₃ and W₂₃ of the AI driver of the L4 system are generated in real time by the AI unit 202 according to an OEDR software stack of the L4 system responsible for Object and Event Detection and Response and are in bidirectional real-time communication with the vehicle control unit (VCU) 201 and the comparator (CSB) 203 through the vehicle data bus. The comparator (CSB) 203 dynamically determines the final lateral or longitudinal wire control signals of the vehicle according to a preselected comparing and switching strategy.

The comparator (CSB) 230 can define and dynamically adjust kᵢⱼ values of six weighting factors (the value of i can be 1 or 2, and the value of j can be 1 or 2 or 3) to stably operate one of L2 shadow mode, L3 disengagement mode or L4 AI driving mode or dynamically switch among these three modes via software according to the wire control signal equation (5-1). i=1 refers to the longitudinal wire control signal, i=2 refers to the lateral wire control signal, j=1 refers to the wire control signal of the driver, j=2 refers to the wire control signal of the mass-produced commercialized L1 or L2 ADAS system, and j=3 refers to the wire control signal of the to-be-validated L4 system. In the L2 shadow mode, for the sake of driving safety, the most stable and conservative comparing and switching strategy can be preferably set as follows: the value of kᵢ₁ is 0.6-0.9, the value of kᵢ₂ is 0.1-0.4 and kᵢ₃=0; the constraining condition: kᵢ₁+kᵢ₂+kᵢ₃=1.0. In other words, in the shadow mode, the comparator 203 fully shields actual impact of the lateral or longitudinal wire control signal of the to-be-validated L4 system on driving control of the whole vehicle by setting kᵢ₃ to be zero and only compares the wire control signal Wᵢ₁ of the driver with the wire control signal Wᵢ₃ of the L4 system in real time, with the comparison refresh frequency not less than 20 Hz. If the absolute value of the difference value between Wᵢ₁ and Wᵢ₃ is greater than a preset threshold, the comparator 203 cooperates with the VCU 201 to automatically generate an electronic record (i.e., an original script of a discrepancy report) of a “discrepancy report” with system time as the unique annotation, and uploads the report after desensitization and encryption to protect the privacy and trade secret of the drivers and the fleet to the cloud computing platform 001 timely (hour-level time delay) through the wireless gateway 210 to be stored for subsequent analysis and processing. It is apparent that in the L2 shadow mode, the to-be-validated L4 system will not affect the actual driving safety of the mass-produced and commercialized ACE2 HDT, and equivalently, when the ACE2 HDT is driven by the driver to operate normally, the to-be-validated L4 system is a copilot or an apprentice on the truck and it is effectively carrying a mobile advertising board for the to-be-validated L4 system. By taking the human driver as the role model, the OEDR performance of the L4 system is compared and validated in real time.

As mentioned above, in the expressway ODD and in terms of RDE energy saving and emission reduction of the vehicle, the weight of the 1D longitudinal wire control signal is 98%, and the weight of the 2D lateral wire control signal is 2%, which is negligible. The weight of the 1D longitudinal wire control signal is 65% and the weight of the 2D lateral wire control signal is 35%, both are important in driving safety of the vehicle. The comparator 203 can set different weighting factors kᵢⱼ, make a difference between the longitudinal wire control signal W₁ⱼ and the lateral wire control signal W₂ⱼ. The to-be-validated L4 system learns and masters 1D longitudinal control (i.e., PACC function) first, and then learn and master the 2D lateral control which is more important and complicated for driving safety. In the shadow mode, a weighting factor 3×2 matrix k can be further preferably set as:

| | | |
|---|---|---|
| 0.3 | 0.35 | 0.35 |
| 0.7 | 0.20 | 0.10 |

The to-be-validated L4 system is dimensionality-reduced to the L2 system under the L2 shadow mode, shoulders more responsibilities in 1D longitudinal control, and learns to optimize energy saving and emission reduction of the vehicle first; and shoulders fewer responsibilities in 2D lateral control, so as to ensure the safety of a 3R test.

The key to operate the ACE HDT, to assure its active driving safety, and to optimize its energy saving and emission reduction lies in that the driver and the fuel-saving robot not only perform their duties individually, but also cooperate with each other dynamically. In the expressway ODD, 1D longitudinal control shall treat the Level II fuel-saving robot as a teacher, the driver as an assistant and the to-be-validated L4 system as a student. 2D lateral control shall take the driver as a teacher, the Level II fuel-saving robot as an assistant, and the to-be-validated L4 system as a student. In the L2 shadow mode, the driver must be prepared to take charge of all dynamic driving tasks (DDT) within 1 second anytime, and is fully in charge of the vehicle driving safety all the time. In the L3 disengagement mode, the L3 system is responsible for the DDTs, the driver is the fallback of these DDTs and must be prepared to take charge of all DDTs within fifteen seconds, the L3 system is in full charge of the driving safety of the vehicle before the disengagement event and the driver is in full charge of the driving safety of the vehicle after the disengagement event. In the L4 operating mode, the L4 system itself has the DDT fallback capability, can assure autonomous (driverless) driving for a long time (tens of hours-level) in the ODD, and is in full charge of the driving safety of the vehicle. The driver can leave the driver's seat and go to the rear cabin of the vehicle to rest in L4 mode. The single driver and the Level IV fuel-saving robot can drive the ACE4 HDT alternately to achieve 24-h day and night continuous operation of the vehicle, thereby greatly improving the labor productivity of the human driver, significantly shortening the freight time of an ultra-long transportation event (single trip is over 1000 miles) and lowering the total cost.

In the L3 disengagement mode, a weighting factor 3×2 matrix k can be further preferably set as:

| | | |
|---|---|---|
| 0.2 | 0.20 | 0.60 |
| 0.3 | 0.20 | 0.50 |

In the L3 disengagement mode, the to-be-validated L4 system is dimensionality-reduced to the L3 system to operate. Longitudinal and lateral movements of the vehicle are continuously controlled primarily by the L3 system and secondarily by the human driver.

In the L2 shadow mode, although the mass-produced commercialized L2 ADAS system is mainly responsible for longitudinal or lateral continuous control of the vehicle, the driver is still in full charge of the vehicle driving safety all the time, the driver wire control signal Wᵢ₁ shall be construed as an active control signal of the driver or a default control signal (i.e., the control signal Wᵢ₂ of the ADAS system, and at the moment, it can be considered that Wᵢ₁ is equivalent to Wᵢ₂), and the driver has the supreme authority and can intervene and take charge of longitudinal or lateral continuous control of the vehicle anytime. In the L3 disengagement mode, the L3 system is responsible for DDTs, and the driver is the DDT fallback and must be prepared to take charge of all DDT within fifteen seconds anytime. The comparator 203 compares the wire control signal Wᵢ₁ of the driver with the wire control signal Wᵢ₃ of the to-be-validated L4 system in real time. If the absolute value of the difference between Wᵢ₁ and Wᵢ₃ is greater than the preset threshold, the comparator 203 cooperates with the VCU 201 to automatically generate an electronic record (i.e., an original script of a disengagement report) of the disengagement event with system time as a unique annotation and uploads the electronic record after desensitization and encryption to the cloud computing platform 001 timely (hour-level time delay) through the wireless gateway 210 to be stored for subsequent analysis and processing. It needs to emphasize that in the L3 disengagement mode, all DDTs are completed by the L3 system most time, and in this case, the wire control signal of the human driver can be regarded as being equivalent to that of the L3 system, i.e., the driver defaults that the L3 system controls the vehicle in real time. As soon as the driver actively or passively takes charge of the DDTs of the vehicle, the comparator (CSB) 203 can find out immediately (in millisecond-level time delay) that the absolute value of the difference of Wᵢ₁ and Wᵢ₃ is greater than the preset threshold, generates a digital disengagement report automatically and sends out various alert signals such as sound, light, and vibration. The human driver has the supreme authority and can activate or de-activate the L3 or L4 system anytime.

In the expressway ODD, the secret of the ACE2 HDT fuel saving lies in that the driver is responsible for OEDR of the vehicle and is in full charge of the driving safety, while the long-term 1D longitudinal control and short-term 2D lateral control of the vehicle are handled by the Level II fuel-saving robot, and particularly, the fuel-saving robot performs 1D longitudinal PACC control on the vehicle according to the fuel saving ML algorithm, the parameters and dynamic working condition data of the vehicle, and the priori 3D road information of the electronic horizon, so as to realize simultaneous optimization of energy saving and emission reduction of the vehicle, where the fuel saving effect and consistency are thoroughly superior to those of the human driver. In other words, when the ACE2 HDT is driven normally, the driver can be feet-off for a long time (Feet-Off; the driver does not step on the accelerator or the brake pedal in hour level time), hands-off temporarily (Hands-Off; the driver does not hold the steering wheel in sub-minute level), but the driver shall keep eyes-on (Eyes-on; the driver is observant and alert with eyes and ears wide open) and shall never be brain-off. The driver intervenes accelerator or brake temporarily only at emergency moment involving driving safety. With respect to 2D lateral control such as temporary lane changing or vehicle pass-over, the driver shall be the master while the L2 ADAS system is the assistant. With respect to the Level I to IV fuel-saving robots of the ACE HDT operating in the expressway ODD, the AI driver is mainly responsible for 1D longitudinal control, so as to realize simultaneous optimization of energy saving and emission reduction of the vehicle, and the fuel saving effect and consistency are much better than those of any human driver. The Level I-IV fuel-saving robots have no difference in terms of energy saving and emission reduction function, performance and actual results and all can reach the same upper limits (i.e., the limit of fuel saving rate) and are substantially decoupled from the 2D lateral control level of the vehicle. However, in terms of autonomous driving safety, the 1D longitudinal control is equivalent to 2D lateral control in significance. The advanced fuel-saving robots have higher requirements on function, performance, safety redundancy and the like than the lower-level fuel-saving robots and are compatible downwards in terms of all functions and performance. The L4 system to be validated can easily learn and master the 1D longitudinal control PACC function of the L2 system with the mass-produced commercialized Level II fuel-saving robot, rapidly learns well and finishes its apprenticeship, and gradually replaces the L2 system. With respect to 2D lateral control, the L4 system cannot reach upper ceilings of functions and performance (particularly driving safety and reliability) of the L4 system by fully using experience of the Level II fuel-saving robot for reference and can only statistically verify that the L3 system is not unsafe through billion-mile level 3R batch validations in the time-consuming and costly L3 disengagement mode. It is further needed to accumulate L3 system 3R operating data of the ten-billion-mile level to verify with high degree of confidence statistically that the L3 AI driver is indeed safer and more reliable than the human driver. To accumulate the ten-billion mile level 3R operating data, a large fleet of about 50 thousand ACE4 HDTs needs to be approved by government to commercially operate in the L3 system disengagement mode nation-wide (the trucks are equipped with safety drivers), and the annual accumulated mileage of each ACE4 HDT is 100 thousand miles to finish within two years. Then, government, public and other road traffic safety related parties may agree to modify related laws and regulations under the precondition of guaranteeing the traffic safety of all current road users according to sufficient statistical data and open the L4 autonomous driving commercial operation at scale. The commercialization of ACE4 HDT can be compared with issuing a doctorate to each of the batch validated Level IV fuel-saving robot by the government, allowing it to pair with a human driver to start commercial operation in HDT long-haul freight applications. The Level IV fuel-saving robot of the ACE HDT of the present disclosure can finish 3R batch validations (disengagement mode) of the billion mile-level L3 system initiatively with higher performance-to-cost ratio and within shorter time compared with those of integration of the prior art in the world in the expressway ODD, thereby statistically verifying that the L3 disengagement mode commercialized operation is not unsafe; then obtains public understanding and special law and regulation exemption of the government to complete the L3 system large scale commercial operation of the ten-billion mile level, and concurrently finishes the ten-billion mile level batch validations of the to-be-validated L4 system in the L3 disengagement mode with lower actual marginal cost, thereby statistically verifying with high degree of confidence that commercialized operation of the AI driver in the L3 disengagement mode is safer than that of the L2 ADAS system led by the human driver; and enables the government to modify the current whole set of laws and regulations that supervise the countrywide operation range of the HDTs for long-haul freight, so that the industry of the HDTs for long-haul freight can enter the era of volume commercialization of the L4 autonomous driving system timely.

Drivers, companies or representatives of scientific and technical corporations and the like can command the comparator (CSB) 203 to dynamically adjust six parameters of the 2×3 weighting factor matrix k through software specification or remote update (OTA), so as to meet the wire control signal equation (5-1) and related boundary conditions or system constraints in real time; the Level IV fuel saving root of the ACE HDT is dimensionality-reduced to stably operate in either the L2 shadow model or the L3 disengagement mode or switches smoothly between them, and gains government approval and public understanding under the precondition of guaranteeing that there are no adverse effects to the traffic safety of current expressways, 3R batch validations and commercial operation of the L3 system are conducted gradually and prudently to finally enter volume commercialization of the L4 system, thereby achieving beneficial effects of optimizing energy saving and emission reduction of the ACE HDT, improving the driving active safety and reducing the traffic accidents. The above-mentioned set of many technical measures focusing on the driving active safety of the ACE HDT is defined as the intelligent compare & switch (iCS) technology. It is apparent that the PACC technology focusing on simultaneous optimization of energy saving and emission reduction of the ACE HDT is the economic foundation, and the iCS technology is the superstructure.

The Level I˜IV fuel-saving robots of the HDT of the present disclosure will not replace the human driver and are always a loyal and reliable assistant or copilot of the human driver. The operational design domain (ODD) is the controlled-access expressway. The Level I fuel-saving robot can dynamically predict the road-load power time-varying function of the vehicle by integrating the priori 3D road data of the electronic horizon, the real-time positioning and orientation dynamic data of the vehicle, the vehicle configurations or driver set information such as constant parameters and dynamic operating data according to the longitudinal power equation (1-1) of the vehicle; and performs iSS or iPS or iMs on the vehicle, namely, meets the requirement on road-load instantaneous power of the vehicle according to the ML algorithm of the fuel-saving robot, and further performs PSC on the battery packs (the battery packs stably work in one of the CS mode or the CD mode or the CI mode or switches dynamically among them), so as to realize the PACC function (i.e., 1D longitudinal L1 ADAS function) of the ACE HDT, thereby achieving multiple beneficial effects of optimizing energy saving and emission reduction of the vehicle, improving the driving performance of the vehicle, alleviating the long distance driving labor intensity of the HDT driver, improving the active driving performance of the vehicle and the like. Different from a condition that the current L1 technology ACC used by the conventional HDT with the internal combustion engine focuses on driving convenience in the expressway ODD, the technical measure of the L1 PACC used by the Level I fuel-saving robot in the present disclosure first focuses on simultaneous optimization of energy saving and emission reduction of the vehicle, converts the energy and emission management optimization problem of the ACE heady duty truck into an equivalent narrow AI problem: playing the game of go by a computer, and realizes the beneficial technical benefit that the RDE comprehensive fuel consumption of the ACE HDT is reduced by 30% compared with that of the conventional diesel HDT and is substantially decoupled with the skill of the driver in long-haul freight. Furthermore, it also provides driving convenience and frees up the driver's feet.

In addition, all advanced fuel-saving robots (i.e., Level II/III/IV fuel-saving robots), particularly the Level IV fuel-saving robot, have the 1D longitudinal L1 autonomous driving foundational core function of PACC in the expressway ODD, and further has the 2D lateral control function by taking the function as the “economic foundation” to establish the “superstructure” of the L4 autonomous driving function. The IV fuel-saving robot configured for the ACE4 HDT first operates in the L2 “shadow mode” to generate a digital discrepancy report automatically, and then conducts operation in the L3 “disengagement mode” to generate a digital disengagement report automatically. The high variable cost for “3R” (Real Vehicle/Real Road/Real Load) batch validations of the ACE4 HDT can be turned into the low marginal cost for daily operation of the ACE1 HDT, and the ten-billion mile level 3R batch validations on L4 DDT safety and reliability executed by the Level IV fuel-saving robot can be completed with the actual comprehensive validation cost that is over 80% lower than that of the conventional L4 HDT with the internal combustion engine, thereby effectively solving the global technical hard problem of how to finish ten-billion mile level 3R batch validation of the L4 system having high degree of statistical confidence by means of a technical solution that is both economically and technically feasible in the expressway ODD under the precondition of guaranteeing the traffic safety of the current road users, and opening up a shortcut for the ACE4 HDT to earn approval by the government and recognition by the public worldwide timely, and to enter volume commercialization of the L4 system of the HDTs for long-haul freight.

Although the language specific to structural features and/or method logical actions has been used to describe the subject matter in the present disclosure, it should be understood that the topic in the claims may not be restricted to the above specific characteristics or actions described. To the contrary, the above specific characteristics and actions described are only example forms of achieving the claims.

While example embodiments have been particularly shown and described, it will be understood by those skilled in the art that various changes in form and details may be made therein without departing from the scope of the embodiments encompassed by the appended claims.

What is claimed is:

1. An intelligent Start-Stop (iSS) control method for a series-hybrid vehicle, which can achieve any sub-second level transient power management strategy for the series-hybrid vehicle, the series-hybrid vehicle including a driving motor (MG2), a generator set, a transmission, a battery pack, and a vehicle controller, wherein the driving motor is bidirectionally mechanically connected to the driving wheels of the hybrid vehicle through the transmission; the generator set includes an engine and a generator (MG1) that are bidirectionally mechanically connected, the generator set and the battery pack can cooperatively bidirectionally provide electrical power to the driving motor, in the series-hybrid vehicle, there is no mechanical connection between the engine and the driving motor or the driving wheels of the vehicle, the control method includes:
i) using, by the vehicle controller, bipolar rectangular pulse width modulation (PWM) digital control upon the transient power analog time-varying function of the engine, by independently and dynamically regulating the duty cycle of the PWM digital control, the vehicle controller enables the engine to stably operate on at least one predefined high-state operating point or one predefined low-state operating point within its high-efficiency zone, or bidirectionally and dynamically switches between the high-state and low-state operating points, generating a PWM time series function of the engine's transient power,
at the high-state operating point, the engine outputs a predetermined positive torque at a predetermined positive rotational speed,
at the low-state operating point, the engine outputs a predetermined negative torque at a predetermined positive rotational speed;
ii) within each PWM cycle, configuring the duty cycle to be equal to the ratio of the time duration when the engine stably operates at the high-state operating point to the PWM period;
iii) by the vehicle controller, continuously calculating, in real time, the time-varying difference function between the vehicle road-load transient power analog time-varying function and the engine transient power PWM time series function, based on the hybrid vehicle static configuration parameters, dynamic operating condition data, and real-time control signals reflecting the driver's driving intention, combined with the vehicle dynamics equation, in order to actively control the transient power time-varying function of the battery pack in real time to satisfy the vehicle dynamics equation and the series-hybrid power balance equation at all times.

2. The control method for a series-hybrid vehicle of claim 1, further comprising:
the vehicle controller, independently and in real time, selecting the duty cycle to continuously and dynamically regulate the rolling time average engine power function between the low-state equivalent power and the high-state equivalent power; wherein, regardless of the vehicle operating condition, the PWM digital control engine can either stably operate at the high-state operating point or the low-state operating point within its high-efficiency zone with at least 95% probability, or dynamically switch between the high-state operating point and the low-state operating point with a probability of less than 5%, and the PWM period is at sub-minute level.

3. The control method for a series-hybrid vehicle of claim 1, wherein the vehicle is a series-hybrid heavy truck suitable for long-haul freight transportation, and the engine displacement is within the range of 7 liters to 16 liters.

4. An intelligent Power-Switching (iPS) control method for a parallel-hybrid vehicle, which can achieve any sub-second level transient power management strategy for the parallel-hybrid vehicle, the parallel-hybrid vehicle including at least one driving motor (MG2), an engine, a transmission, a battery pack, and a vehicle controller, where the driving motor can be bidirectionally mechanically connected to the vehicle's driving wheels through the transmission; the engine can be mechanically connected to the vehicle's driving wheels through the transmission; the battery pack bidirectionally provides electrical power to the driving motor; the parallel-hybrid vehicle also includes at least one by-wire clutch, set between the engine and the transmission; the control method for the parallel-hybrid vehicle includes:
i) using, by the vehicle controller, bipolar non-rectangular pulse width modulation (PWM) digital control for the transient power analog time-varying function of the engine, by independently and dynamically regulating the duty cycle of the PWM digital control, the vehicle controller enables the engine to stably operate on at least one predefined high-state operating line or one predefined low-state operating line within its high-efficiency zone, or bidirectionally and dynamically switches between the high-state operating line and the low-state operating line, generating a PWM time series function of the engine's transient power,
on the high-state operating line, the engine's torque value varies within a predetermined positive value range over time, and the rotational speed varies within a predetermined positive value range over time, at any given moment, one rotational speed value unidirectionally and uniquely corresponds to a predetermined torque value, and this one-to-one mapping is defined by the high-state operating line,
on the low-state operating line, the engine's torque varies within a predetermined negative value range over time, and the rotational speed varies within a predetermined positive value range over time, at any given moment, one rotational speed value unidirectionally and uniquely corresponds to a predetermined torque value, and this one-to-one mapping is defined by the low-state operating line;
ii) within each PWM cycle, configuring the duty cycle to be equal to the ratio of the time duration when the engine stably operates on the high-state operating line to the PWM period;
iii) by the vehicle controller, continuously calculating, in real time, the time-varying difference function between the vehicle's road-load transient power analog time-varying function and the engine's transient power PWM time series function, based on the hybrid vehicle static configuration parameters, dynamic operating condition data, and real-time control signals reflecting the driver's driving intention, combined with the vehicle dynamics equation, in order to actively control the battery pack's transient power time-varying function in real time to satisfy the vehicle's dynamics.

5. The vehicle control method of claim 4, further comprising:
by the vehicle controller, dynamically and continuously regulating the rolling time average engine power function between the low-state equivalent power and the high-state equivalent power by independently selecting the duty cycle in real-time; wherein, regardless of the vehicle operating condition, the PWM digital control engine can either stably operate within its high-efficiency zone on the high-state operating line or the low-state operating line with at least 95% probability, or dynamically switch between the high-state operating line and the low-state operating line with less than 5% probability, and the PWM period is at sub-minute level.

6. The vehicle control method of claim 4, for realizing the clutch-less gear shifting function of the parallel-hybrid vehicle, further comprising:
i) before the gear shifting of the vehicle's transmission in the parallel-hybrid mode, first switching the engine to the low-state operating line to operate stably, then the driving motor independently completing the torque interruption and speed synchronization between the engine and the transmission with the clutch remaining closed, allowing the transmission to shift gears smoothly; and
ii) after the gear shifting of the transmission is completed, allowing the engine to switch from the low-state operating line to the high-state operating line.

7. The vehicle control method of claim 4, wherein the vehicle is a parallel-hybrid heavy truck suitable for long-haul freight transportation and the engine displacement is within the range of 7 liters to 16 liters.

8. An intelligent Mode-Switching (iMS) control method for a mixed-hybrid vehicle, the hybrid vehicle comprising at least one driving motor (MG2), a generator set, a transmission, a battery pack, and a vehicle controller, wherein the driving motor is bidirectionally mechanically connected to the driving wheels of the vehicle through the transmission; the generator set includes an engine and a generator (MG1) that are bidirectionally mechanically connected; the generator set and the battery pack can cooperatively bidirectionally provide electrical power to the driving motor; the hybrid vehicle further includes a by-wire clutch disposed between the generator set and the transmission and operable to enable the vehicle to stably operate in either series-parallel mode or parallel-hybrid mode and to dynamically switch between the series-parallel mode and the parallel-hybrid mode, comprising:
when the vehicle stably operates in the series-hybrid mode, disengaging the clutch so that there is no mechanical connection between the generator set and the driving motor or the driving wheels of the vehicle, and executing, by the vehicle controller, a series-hybrid iSS control procedure;
when the vehicle stably operates in the parallel mode, engaging the clutch so that there is a direct mechanical connection between the generator set and the driving motor or the driving wheels of the vehicle, and executing, by the vehicle controller, a parallel-hybrid iPS control procedure;
the control method further comprises:
continuously calculating in real time, by the vehicle controller, the time trajectories of the road-load transient power function and the road-load rolling time average power function within the electronic horizon, based on the static configuration parameters and dynamic operating condition data of the hybrid vehicle, the prior 3D road data and the predicted time trajectory of the vehicle speed function in the electronic horizon, in combination with the vehicle dynamics equation, wherein:
when the absolute value of the road-load average power function of a certain road section in the electronic horizon is less than or equal to a preset positive threshold value, operating the hybrid vehicle stably in the series-hybrid mode on that section; and
when the absolute value of the road-load average power function of a certain road section in the electronic horizon is greater than a preset positive threshold value, operating the hybrid vehicle stably in the parallel-hybrid mode on that section;
dynamically switching the hybrid vehicle i between the series-hybrid mode and the parallel-hybrid mode according to the absolute value changes of the road-load average power function around the preset threshold value.

9. An adaptive control method for the safe following distance of a hybrid vehicle, which can realize the intelligent Cruise Control function (iCC) of the vehicle, the control method includes:
method steps of a serial-hybrid iSS control method, or
method steps of the parallel-hybrid iPS control method,
wherein the adaptive control method further includes: the vehicle controller continuously calculates in real time the time trajectories of the vehicle's road-load transient power function and the time-varying function of the safe following distance (Ls) based on the static configuration parameters and the dynamic working condition data of the hybrid vehicle, prior 3D road data and the predicted vehicle speed function time trajectory in the electronic horizon, combined with the vehicle dynamics equation, and continuously and dynamically determines the three threshold values of the vehicle's prewarning distance (L1), warning distance (L2), and emergency braking distance (L3), and
when the safe following distance (Ls) reaches the prewarning distance (L1) and the relative speed with the preceding vehicle is greater than zero, the vehicle controller dynamically adjusts the duty cycle of the engine PWM control to be less than 50%,
when the safe following distance (Ls) reaches the warning distance (L2) and the relative speed with the preceding vehicle is greater than zero, the vehicle controller dynamically adjusts and maintains the duty cycle of the engine PWM control at zero, so that the engine operates stably at a low-state operating point or low-state operating line,
when the safe following distance (Ls) reaches the emergency braking distance (L3) and the relative speed with the preceding vehicle is greater than zero, the vehicle controller dynamically adjusts and maintains the duty cycle of the engine PWM control at zero, and immediately activates the regenerative braking function of the driving motor or the retarder braking function of the engine, and may also activate the mechanical braking function of the vehicle,
wherein the prewarning distance (L1)>the warning distance (L2)>the emergency braking distance (L3).

10. A predictive control method for the rolling time average state of charge (SoC) of a battery pack in a hybrid vehicle, which is a key part of realizing the minute-level rolling time average power management strategy of the hybrid vehicle, the hybrid vehicle includes: an engine, a generator, a driving motor, a clutch, a transmission, a battery pack and a vehicle controller, wherein the vehicle controller is configured to perform at least one of:
steps of a series-hybrid iSS control procedure; or
steps of a parallel-hybrid iPS control procedure;
wherein the predictive control method further includes
continuously calculating, in real time, by the vehicle controller, a time trajectory of a difference function between a vehicle road-load average power function and an engine average power function within the electronic horizon based on the static configuration parameters and dynamic operating condition data of the hybrid vehicle, prior 3D road data and a predicted vehicle speed function time trajectory in the electronic horizon, and in combination with a vehicle dynamics equation, and actively regulating the time trajectory of the difference function by independently and dynamically selecting a PWM duty cycle in order to achieve predicative adaptive control of the average SoC function time trajectory in the electronic horizon, including:
making the battery pack stably operate in one of the following three operation modes or dynamically switch among the three modes:
when an absolute value of the difference function remains less than or equal to a predetermined positive threshold for a period of time, the battery pack stably operates in the charge sustaining (CS) mode;
when the difference function remains greater than a predetermined positive threshold for a period of time, the battery pack stably operates in the charge depletion (CD) mode;
when the difference function remains less than a predetermined negative threshold for a period of time, the battery pack stably operates in the charge increasing (CI) mode;
by actively adjusting the time trajectory of the difference function around the predetermined threshold, the battery pack can be bidirectionally and dynamically switched between the CD and CS modes or the CS and CI modes;
wherein the predictive control of the average SoC of the battery pack is decoupled from the transient power management strategy of the hybrid vehicle.

11. A method for generating a discrepancy report of an autonomous driving hybrid vehicle, wherein the hybrid vehicle further includes a comparator and an advanced autonomous driving system to be validated, the method for generating a driving discrepancy report of the hybrid vehicle comprises:
i) the hybrid vehicle operating simultaneously in two different control modes, namely, by a human driver or an AI driver of the advanced autonomous driving system to be validated operating in a reduced dimension as a SAE L2 advanced driver assistance system, and being real-time controlled according to a control method, to achieve the predictive adaptive cruise control (PACC) function of the vehicle, and the PACC control is basically decoupled from the transient operating conditions of the vehicle;
ii) continuously calculating in real time, through the comparator, a time-varying difference function between the vehicle control signals of the human driver and that of the AI driver of the advanced autonomous driving system to be validated, the vehicle control signals at least including the real-time longitudinal or lateral control signals of the vehicle's operation;
iii) when the absolute value of the difference function is greater than a preset threshold, immediately triggering a discrepancy event; the comparator, in collaboration with the vehicle controller, creates an electronic record of the vehicle driving discrepancy event, using the vehicle control system's clock as the unique identifier;
iv) under the command of the vehicle controller, combining the raw data of road traffic conditions and vehicle dynamic operation data collected by the vehicle-mounted sensors within a predetermined time range before and after the triggering time of the discrepancy event, automatically generating and locally storing an electronic discrepancy report for the discrepancy event, and the discrepancy report can also be uploaded to a cloud computing platform in a timely manner,
wherein, step (i) is independent and decoupled from steps (ii) to (iv).

12. A method for generating a disengagement report of an autonomous driving hybrid vehicle, wherein the hybrid vehicle also includes a comparator and an advanced autonomous driving system to be validated, the method for generating a disengagement report of the hybrid vehicle comprises:
i) the hybrid vehicle operating in two different control modes simultaneously, namely, by a human driver or an AI driver of the advanced autonomous driving system to be validated operating in a reduced dimension as a SAE L3 conditional autonomous driving system, and being real-time controlled according to a control procedure, to achieve the predictive adaptive cruise control function (PACC) of the vehicle, and the PACC control is basically decoupled from the transient operating conditions of the vehicle;
ii) the comparator continuously calculating, in real time, a time-varying difference function between the vehicle control signals of the human driver and that of the AI driver of the advanced autonomous driving system to be validated, and the vehicle control signals at least include the real-time longitudinal or lateral control signals of the vehicle's operation;
iii) when the absolute value of the difference function is greater than a preset threshold, immediately triggering a disengagement event, the comparator cooperating with the vehicle controller to create an electronic record of the disengagement event, using the vehicle control system's clock as a unique identifier;
iv) under the command of the vehicle controller, combining the raw data of the road traffic conditions and the dynamic operation data of the vehicle collected by the vehicle-mounted sensors within a predetermined time range before and after the triggering time of the disengagement event, an electronic disengagement report for the disengagement event is automatically generated and locally stored, and the disengagement report can also be uploaded to a cloud computing platform in a timely manner,
wherein, step (i) is independent and decoupled from steps (ii) to (iv).

13. A hybrid vehicle, comprising: an engine, a driving motor, a clutch, a transmission, a battery pack and a vehicle controller, wherein the vehicle controller is configured to perform at least one of:
a series-hybrid intelligent start-stop (iSS) control procedure;
a parallel-hybrid intelligent power switching (iPS) control procedure;
a intelligent mode switching (iMS) control procedure;
a adaptive control procedure for safe following distance of a hybrid vehicle;
a predictive control procedure for hybrid vehicle battery pack average state of charge (SoC);
a procedure for generating a discrepancy report of a L2 autonomous driving hybrid vehicle;
a procedure for generating a disengagement report of a L3 autonomous driving hybrid vehicle.

14. The hybrid vehicle of claim 13, wherein the vehicle is a hybrid heavy-duty truck suitable for long-haul freight transportation, and the engine displacement is within the range of 7 liters to 16 liters.

15. An internal combustion engine of a hybrid heavy-duty truck suitable for long-haul freight transportation, wherein the engine is configured to perform at least one of the following methods:
a series-hybrid intelligent start-stop (iSS) control procedure;
a parallel-hybrid intelligent power switching (iPS) control procedure;
an intelligent mode switching (iMS) control procedure for a mixed-hybrid vehicle;
an adaptive control procedure for safe following distance of a hybrid vehicle;
a predictive control procedure for hybrid vehicle battery pack average state of charge (SoC);
a procedure for generating a discrepancy report of a L2 autonomous driving hybrid vehicle;
a procedure for generating a disengagement report of a L3 autonomous driving hybrid vehicle.

16. A vehicle controller of a hybrid heavy-duty truck suitable for long-haul freight transportation, wherein the controller is configured to perform at least one of the following methods:
a series-hybrid intelligent start-stop (iSS) control procedure;
a parallel-hybrid intelligent power switching (iPS) control procedure;
an intelligent mode switching (iMS) control procedure for a mixed-hybrid vehicle;
an adaptive control procedure for safe following distance of a hybrid vehicle;
a predictive control procedure for hybrid vehicle battery pack average state of charge (SoC);
a procedure for generating a discrepancy report of a L2 autonomous driving hybrid vehicle;
a method for generating a disengagement report of a L3 autonomous driving hybrid vehicle.
